(19) United States
(12) Patent Application Publication
(10) Pub. No.: US 2015/0361324 A1
(43) Pub. Date: Dec. 17, 2015

(54) Transport of Heavy Oil

(71) Applicant: Board of Regents, The University of Texas System, Austin, TX (US)

(72) Inventors: Gary A. Pope, Cedar Park, TX (US); Upali P. Weerasooriya, Austin, TX (US); Nabijan Nizamidin, Rome, GA (US)

(21) Appl. No.: 14/836,381

(22) Filed: Aug. 26, 2015

Related U.S. Application Data
(63) Continuation of application No. 14/194,477, filed on Feb. 28, 2014, now abandoned.
(60) Provisional application No. 61/770,962, filed on Feb. 28, 2013.

(51) Int. Cl. C09K 8/52; C10G 71/00

(52) U.S. Cl. CPC C09K 8/52; C10G 71/00

(57) ABSTRACT

Provided herein are, inter alia, heavy crude oil emulsion compositions and methods of making the same. The compositions and methods provided herein are particularly useful for the transport of heavy crude oils.

### CROSS-REFERENCE TO RELATED APPLICATIONS

This application claims the benefit of U.S. Provisional Application No. 61/770,962 filed Feb. 28, 2013, which is hereby incorporated in its entirety and for all purposes.

### BACKGROUND OF THE INVENTION

Heavy crude oils are defined as oils having an API (American Petroleum Industry) gravity of less than 20, and are viscous at lower temperatures when produced from a reservoir. The viscous heavy crude oils are difficult to transport in pipelines especially at low temperature. The viscosity of heavy crude oils at low temperature can be millions of cp. Methods used to lower the viscosity of heavy crude oils to facilitate their transport include, for example, expensive procedures involving heating the oil to a high temperature (e.g. 100° C.) before, and perhaps during the transport in a vessel (e.g. pipeline). Prior attempts to form low viscosity emulsions of heavy crude oils have had limited success in part due to difficulties in maintaining and controlling such emulsion, especially at ambient temperatures and during transport.

Therefore there is a need in the art for cost effective compositions and methods of transporting heavy crude oils at lower temperatures after they have been extracted from a reservoir or storage. Provided herein are methods and compositions addressing these and other needs in the art.

### BRIEF SUMMARY OF THE INVENTION

Provided herein, inter alia, are heavy crude oil emulsion compositions including a heavy crude oil, a co-solvent, a basic agent and water and having surprisingly low viscosities at low water content. Due to their low viscosity, the emulsion compositions provided herein are particularly useful as a means for transporting heavy crude oils at ambient temperatures. Compared to existing transport techniques used in the art, the present emulsion compositions are highly versatile, stable and cost effective.

In a first aspect, provided herein is a heavy crude oil emulsion including a heavy crude oil, a co-solvent, a basic agent and water, wherein the viscosity of the emulsion is lower than the viscosity of the heavy crude oil.

In another aspect, a method of forming a heavy crude oil emulsion is provided. The method includes contacting a heavy crude oil extracted from an oil reservoir, with a co-solvent, a basic agent and water at an emulsion forming temperature, thereby forming a high temperature heavy crude oil emulsion. The high temperature heavy crude oil emulsion is allowed to cool to a transport temperature, thereby forming a heavy crude oil emulsion.

In another aspect, a method of optimizing a heavy crude oil emulsion is provided. The method includes contacting a plurality of heavy crude oil samples with an amount of a co-solvent, an amount of a basic agent, an amount of a salt and an amount of water at an emulsion forming temperature. The amount of a co-solvent, the amount of a basic agent, the amount of a salt and the amount of water is different for each of the plurality of heavy crude oil samples, thereby forming a plurality of different high temperature heavy crude oil emulsion samples. The plurality of different high temperature heavy crude oil emulsion samples is allowed to cool to an ambient temperature, thereby forming a plurality of different low temperature heavy crude oil emulsion samples. A low temperature heavy crude oil emulsion sample is identified amongst the plurality of different low temperature heavy crude oil emulsion samples having a viscosity at least 100 times lower than the viscosity of the heavy crude oil, thereby optimizing a heavy crude oil emulsion.

In another aspect, a method of transporting a heavy crude oil is provided. The method includes extracting a heavy crude oil from an oil reservoir, thereby forming an extracted heavy crude oil. The extracted heavy crude oil is contacted with a co-solvent, a basic agent and water at an emulsion forming temperature, thereby forming a high temperature heavy crude oil emulsion. The high temperature heavy crude oil emulsion is allowed to cool to a transport temperature, thereby forming a heavy crude oil emulsion. The heavy crude oil emulsion is transported from a first location to a second location, thereby transporting the heavy crude oil.

In another aspect, a method of forming a heavy crude oil emulsion in a production well is provided. The method includes contacting an extracted heavy crude oil in a production well with a co-solvent, a basic agent and water, thereby forming a heavy crude oil emulsion in the production well.

In another aspect, a method of transporting an extracted heavy crude oil from a production well is provided. The method includes contacting an extracted heavy crude oil in a production well with a co-solvent, a basic agent and water at an emulsion forming temperature, thereby forming a heavy crude oil emulsion in a production well. The heavy crude oil emulsion is transported from the production well to the surface, thereby transporting the extracted heavy crude oil from the production well.

In another aspect, a heavy crude oil emulsion is provided. The heavy crude oil emulsion includes a first phase and a second phase, wherein the first phase includes an oil-immiscible compound and a basic agent and the second phase includes a heavy crude oil.

In another aspect, a method of forming a heavy crude oil emulsion is provided. The method includes contacting a heavy crude oil extracted from an oil reservoir with a an oil-immiscible compound, an amphiphilic co-solvent and a basic agent at an emulsion forming temperature, thereby forming a high temperature heavy crude oil emulsion. The high temperature heavy crude oil emulsion is allowed to cool to a transport temperature, thereby forming a heavy crude oil emulsion.

In another aspect, a method of forming a heavy crude oil emulsion in a production well is provided. The method includes contacting an extracted heavy crude oil in a production well with an oil-immiscible compound, an amphiphilic co-solvent and a basic agent, thereby forming a heavy crude oil emulsion in a production well.

In another aspect, a method of transporting an extracted heavy crude oil from a production well is provided. The method includes contacting an extracted heavy crude oil in a production well with an oil-immiscible compound, an amphiphilic co-solvent and a basic agent at an emulsion forming temperature, thereby forming a heavy crude oil emulsion in a production well. The heavy crude oil emulsion is transported from the production well to the surface, thereby transporting the extracted heavy crude oil from the production well.

In another aspect, a non-aqueous composition including an oil-immiscible compound, an amphiphilic co-solvent and a basic agent is provided.

### BRIEF DESCRIPTION OF THE DRAWINGS

FIG. 1: shows the effect of temperature on the viscosity of four heavy crude oils mentioned in table 3. Power law model was found to best describe the relationship of heavy oil viscosity vs. temperature. The measurements were taken using an ARES rheometer.

FIG. 2: Apparent viscosity of oil A & emulsions vs. shear rate at 25° C. (Oil A (% w/v) Ph-16EO (1.6% aq.) NaCl (0.8% aq.) NaOH (0.2% aq.)).

FIG. 3: Apparent viscosity of oil B & emulsions vs. shear rate at 25° C. (Oil B (% w/v) Ph-16EO (1.6% aq.) NaCl (0.8% aq.) NaOH (0.2% aq.)).

FIG. 4: Apparent viscosity of oil C & emulsions vs. shear rate at 25° C. (Oil C (% w/v) Ph-16EO (1.6% aq.) NaCl (0.8% aq.) NaOH (0.2% aq.)).

FIG. 5: Apparent viscosity of oil D & emulsions vs. shear rate at 25° C. (Oil D (% w/v) Ph-16EO (1.6% aq.) NaCl (0.8% aq.) NaOH (0.2% aq.)).

FIG. 6: Apparent viscosity of oil A emulsions vs. shear rate with various co-solvents at 25° C. (Oil A (40% w/v) co-solvent (0.8% aq.) NaCl (0.1% aq.) NaOH (0.2% aq.)).

FIG. 7: Apparent viscosity of 40% oil A emulsions vs. shear rate with varying Ph-16EO concentration at 25° C. (Oil A (40% w/v) NaCl (0.8% aq.) NaOH (0.2% aq.)).

FIG. 8: Apparent viscosity of 80% oil A emulsions vs. shear rate with varying Ph-16EO concentration (% aq.) at 25° C. (Oil A (80% w/v) NaCl (0.8% aq.) NaOH (0.2% aq.)).

FIG. 9: Apparent viscosity of 60% oil A emulsions vs. shear rate with varying 1.6% (aq.) phenol-xEO at 25° C. (Oil A (60% w/v) NaCl (0.8% aq.) NaOH (0.2% aq.)). When the co-solvent is Ph-12EO the emulsion results to be of high viscosity.

FIG. 10: Apparent viscosity of 40% oil A emulsions vs. shear rate with varying NaOH concentrations at 25° C. (Oil A (40% w/v) Phenol-16EO (0.8% aq.) NaCl (0.8% aq.)).

FIG. 11: Apparent viscosity of 60% oil A emulsions vs. shear rate with varying NaOH concentrations (aq.) at 25° C. (Oil A (60% w/v) Phenol-16EO (0.8% aq.) NaCl (0.8% aq.). 0.05% NaOH was not sufficient to emulsify all oil.

FIG. 12: Apparent viscosity of 40% oil A emulsions vs. shear rate with varying Na₂CO₃ concentrations (aq.) at 25° C. (Oil A (40% w/v) Phenol-16EO (0.8% aq.) NaCl (0.1% aq.)). 0.05% Na₂CO₃ was not sufficient to emulsify all oil.

FIG. 13: Apparent viscosity of oil 60% A emulsions vs. shear rate with varying NaCl concentrations (aq.) at 25° C. (Oil A (60% w/v) Ph-16EO (1.6% aq.) NaOH (0.2% aq.)).

FIG. 14: Apparent viscosity of 60% oil D emulsions with different emulsification mechanisms at 25° C. (Oil D (60% w/v) NaCl (0.8% aq.)).

FIG. 15: Apparent viscosity of 80% oil B emulsions with different emulsification mechanisms at 25° C. (Oil B (80% w/v) NaCl (0.8% aq.)).

FIG. 16: Right vessel contains 60% oil D emulsions and 1.6% Ph-16EO (1 week). Left vessel contains 60% oil D emulsions and 2.5% NPE-12EO (3 days)

FIG. 17: Emulsion vessels as shown in FIG. 16 after tilting upside down.

### DETAILED DESCRIPTION OF THE INVENTION

### I. Definitions

The abbreviations used herein have their conventional meaning within the chemical and biological arts.

Where substituent groups are specified by their conventional chemical formulae, written from left to right, they equally encompass the chemically identical substituents that would result from writing the structure from right to left, e.g., —CH₂O— is equivalent to —OCH₂—.

The term “alkyl,” by itself or as part of another substituent, means, unless otherwise stated, a straight (i.e. unbranched) or branched chain which may be fully saturated, mono- or polyunsaturated and can include di- and multivalent radicals, having the number of carbon atoms designated (i.e. C₁-C₁₀ means one to ten carbons). Examples of saturated hydrocarbon radicals include, but are not limited to, groups such as methyl, ethyl, n-propyl, isopropyl, n-butyl, t-butyl, isobutyl, sec-butyl, homologs and isomers of, for example, n-pentyl, n-hexyl, n-heptyl, n-octyl, and the like. An unsaturated alkyl group is one having one or more double bonds or triple bonds. Examples of unsaturated alkyl groups include, but are not limited to, vinyl, 2-propenyl, crotyl, 2-isopentenyl, 2-(butadienyl), 2,4-pentadienyl, 3-(1,4-pentadienyl), ethynyl, 1- and 3-propynyl, 3-butynyl, and the higher homologs and isomers. Alkyl groups which are limited to hydrocarbon groups are termed “homoalkyl”. An alkoxy is an alkyl attached to the remainder of the molecule via an oxygen linker (—O—).

The term “alkylene” by itself or as part of another substituent means a divalent radical derived from an alkyl, as exemplified, but not limited, by —CH₂CH₂CH₂CH₂—, and further includes those groups described below as “heteroalkylene.” Typically, an alkyl (or alkylene) group will have from 1 to 24 carbon atoms, with those groups having 10 or fewer carbon atoms being preferred in the present invention. A “lower alkyl” or “lower alkylene” is a shorter chain alkyl or alkylene group, generally having eight or fewer carbon atoms.

The term “heteroalkyl,” by itself or in combination with another term, means, unless otherwise stated, a stable straight or branched chain or combinations thereof, consisting of at least one carbon atom and at least one heteroatom selected from the group consisting of O, N, P, Si and S. The heteroatom(s) O, N, P and S and Si may be placed at any interior position of the heteroalkyl group or at the position at which the alkyl group is attached to the remainder of the molecule. Examples include, but are not limited to, —CH₂—CH₂—O—CH₃, —CH₂—CH₂—NH—CH₃, —CH₂—CH₂—N(CH₃)—CH₃, —CH₂—S—CH₂—CH₃, —CH₂—CH₂, —S(O)—CH₃, —CH₂—CH₂—S(O)₂—CH₃, —CH═CH—O—CH₃, —Si(CH₃)₃, —CH₂—CH═N—OCH₃, —CH═CH—N(CH₃)—CH₃, O—CH₃, —O—CH₂—CH₃, and —CN. Up to two heteroatoms may be consecutive, such as, for example, —CH₂—NH—OCH₃.

Similarly, the term “heteroalkylene” by itself or as part of another substituent means a divalent radical derived from heteroalkyl, as exemplified, but not limited by, —CH₂—CH₂—S—CH₂—CH₂— and —CH₂—S—CH₂—CH₂—NH—CH₂—. For heteroalkylene groups, heteroatoms can also occupy either or both of the chain termini (e.g., alkyleneoxy, alkylenedioxy, alkyleneamino, alkylenediamino, and the like). Still further, for alkylene and heteroalkylene linking groups, no orientation of the linking group is implied by the direction in which the formula of the linking group is written. For example, the formula —C(O)₂R′— represents both —C(O)₂R′— and —R′C(O)₂—.

The terms “cycloalkyl” and “heterocycloalkyl,” by themselves or in combination with other terms, represent, unless otherwise stated, cyclic versions of “alkyl” and “heteroalkyl,” respectively. Additionally, for heterocycloalkyl, a heteroatom can occupy the position at which the heterocycle is attached to the remainder of the molecule. Examples of cycloalkyl include, but are not limited to, cyclopropyl, cyclobutyl, cyclopentyl, cyclohexyl, 1-cyclohexenyl, 3-cyclohexenyl, cycloheptyl, and the like. Examples of heterocycloalkyl include, but are not limited to, 1-(1,2,5,6-tetrahydropyridyl), 1-piperidinyl, 2-piperidinyl, 3-piperidinyl, 4-morpholinyl, 3-morpholinyl, tetrahydrofuran-2-yl, tetrahydrofuran-3-yl, tetrahydrothien-2-yl, tetrahydrothien-3-yl, 1-piperazinyl, 2-piperazinyl, and the like. A “cycloalkylene” and a “heterocycloalkylene,” alone or as part of another substituent means a divalent radical derived from a cycloalkyl and heterocycloalkyl, respectively.

The term “aryl” means, unless otherwise stated, a polyunsaturated, aromatic, hydrocarbon substituent which can be a single ring or multiple rings (preferably from 1 to 3 rings) which are fused together (i.e. a fused ring aryl) or linked covalently. A fused ring aryl refers to multiple rings fused together wherein at least one of the fused rings is an aryl ring. The term “heteroaryl” refers to aryl groups (or rings) that contain from one to four heteroatoms selected from N, O, and S, wherein the nitrogen and sulfur atoms are optionally oxidized, and the nitrogen atom(s) are optionally quaternized. Thus, the term “heteroaryl” includes fused ring heteroaryl groups (i.e. multiple rings fused together wherein at least one of the fused rings is a heteroaromatic ring). A 5,6-fused ring heteroarylene refers to two rings fused together, wherein one ring has 5 members and the other ring has 6 members, and wherein at least one ring is a heteroaryl ring. Likewise, a 6,6-fused ring heteroarylene refers to two rings fused together, wherein one ring has 6 members and the other ring has 6 members, and wherein at least one ring is a heteroaryl ring. And a 6,5-fused ring heteroarylene refers to two rings fused together, wherein one ring has 6 members and the other ring has 5 members, and wherein at least one ring is a heteroaryl ring. A heteroaryl group can be attached to the remainder of the molecule through a carbon or heteroatom. Non-limiting examples of aryl and heteroaryl groups include phenyl, 1-naphthyl, 2-naphthyl, 4-biphenyl, 1-pyrrolyl, 2-pyrrolyl, 3-pyrrolyl, 3-pyrazolyl, 2-imidazolyl, 4-imidazolyl, pyrazinyl, 2-oxazolyl, 4-oxazolyl, 2-phenyl-4-oxazolyl, 5-oxazolyl, 3-isoxazolyl, 4-isoxazolyl, 5-isoxazolyl, 2-thiazolyl, 4-thiazolyl, 5-thiazolyl, 2-furyl, 3-furyl, 2-thienyl, 3-thienyl, 2-pyridyl, 3-pyridyl, 4-pyridyl, 2-pyrimidyl, 4-pyrimidyl, 5-benzothiazolyl, purinyl, 2-benzimidazolyl, 5-indolyl, 1-isoquinolyl, 5-isoquinolyl, 2-quinoxalinyl, 5-quinoxalinyl, 3-quinolyl, and 6-quinolyl. Substituents for each of the above noted aryl and heteroaryl ring systems are selected from the group of acceptable substituents described below. An “arylene” and a “heteroarylene,” alone or as part of another substituent means a divalent radical derived from an aryl and heteroaryl, respectively.

The term “oxo” as used herein means an oxygen that is double bonded to a carbon atom.

Each R-group as provided in the formulae provided herein can appear more than once.

Where a R-group appears more than once each R group can be optionally different.

The term “contacting” as used herein, refers to materials or compounds being sufficiently close in proximity to react or interact. For example, in methods of contacting a hydrocarbon material bearing formation and/or a wellbore, the term “contacting” includes placing an aqueous composition (e. g. chemical, surfactant or polymer) within a hydrocarbon material bearing formation using any suitable manner known in the art (e.g., pumping, injecting, pouring, releasing, displacing, spotting or circulating the chemical into a well, wellbore or hydrocarbon bearing formation).

The terms “unrefined petroleum” and “crude oil” are used interchangeably and in keeping with the plain ordinary usage of those terms. “Unrefined petroleum” and “crude oil” may be found in a variety of petroleum reservoirs (also referred to herein as a “reservoir,” “oil field deposit” “deposit” and the like) and in a variety of forms including oleaginous materials, oil shales (i.e. organic-rich fine-grained sedimentary rock), tar sands, light oil deposits, heavy oil deposits, and the like. “Crude oils” or “unrefined petroleums” generally refer to a mixture of naturally occurring hydrocarbons that may be refined into diesel, gasoline, heating oil, jet fuel, kerosene, and other products called fuels or petrochemicals. Crude oils or unrefined petroleums are named according to their contents and origins, and are classified according to their per unit weight (specific gravity). Heavier crudes generally yield more heat upon burning, but have lower gravity as defined by the American Petroleum Institute (API) and market price in comparison to light (or sweet) crude oils. Crude oil may also be characterized by its Equivalent Alkane Carbon Number (EACN).

Crude oils vary widely in appearance and viscosity from field to field. They range in color, odor, and in the properties they contain. While all crude oils are mostly hydrocarbons, the differences in properties, especially the variation in molecular structure, determine whether a crude oil is more or less easy to produce, pipeline, and refine. The variations may even influence its suitability for certain products and the quality of those products. Crude oils are roughly classified into three groups, according to the nature of the hydrocarbons they contain. (i) Paraffin based crude oils contain higher molecular weight paraffins, which are solid at room temperature, but little or no asphaltic (bituminous) matter. They can produce high-grade lubricating oils. (ii) Asphaltene based crude oils contain large proportions of asphaltic matter, and little or no paraffin. Some are predominantly naphthenes and so yield lubricating oils that are more sensitive to temperature changes than the paraffin-based crudes. (iii) Mixed based crude oils contain both paraffins and naphthenes, as well as aromatic hydrocarbons. Most crude oils fit this latter category.

“Heavy crude oils” as provided herein are crude oils, with an API gravity of less than 20, or a viscosity of at least 100 cp. The heavy crude oils may have a viscosity greater than 100 cP. In some embodiments, the heavy crude oil has a viscosity of at least 100 cP. In other embodiments, the heavy crude oil has a viscosity of at least 1,000 cP. In other embodiments, the heavy crude oil has a viscosity of at least 10,000 cP. In other embodiments, the heavy crude oil has a viscosity of at least 100,000 cP. In other embodiments, the heavy crude oil has a viscosity of at least 1,000,000 cP.

“Reactive” heavy crude oil as referred to herein is heavy crude oil containing natural organic acidic components (also referred to herein as unrefined petroleum acid) or their precursors such as esters or lactones. These reactive heavy crude oils can generate soaps (carboxylates, surfactants) when reacted with alkali or an organic base. More terms used interchangeably for heavy crude oil throughout this disclosure are active hydrocarbon material or active petroleum material. An “oil bank” or “oil cut” as referred to herein, is the heavy crude oil that does not contain the injected chemicals and is pushed by the injected fluid during an enhanced oil recovery process.

“Unrefined petroleum acids” as referred to herein are carboxylic acids contained in active petroleum material (reactive heavy crude oil). The unrefined petroleum acids contain C₁₁ to C₂₀ alkyl chains, including napthenic acid mixtures. The recovery of such “reactive” oils may be performed using alkali (e.g. NaOH or Na₂CO₃) in a surfactant composition. The alkali reacts with the acid in the reactive oil to form soap in situ. These in situ generated soaps serve as a source of surfactants causing a reduction of the interfacial tension between oil and water, resulting in the formation of a low viscosity emulsion.

The term “bonded” refers to having at least one of covalent bonding, hydrogen bonding, ionic bonding, Van Der Waals interactions, pi interactions, London forces or electrostatic interactions.

The term “productivity” as applied to a petroleum or oil well refers to the capacity of a well to produce hydrocarbons (e.g. unrefined petroleum); that is, the ratio of the hydrocarbon flow rate to the pressure drop, where the pressure drop is the difference between the average reservoir pressure and the flowing bottom hole well pressure (i.e., flow per unit of driving force).

The term “solubility” or “solubilization” in general refers to the property of a solute, which can be a solid, liquid or gas, to dissolve in a solid, liquid or gaseous solvent thereby forming a homogenous solution of the solute in the solvent. Solubility occurs under dynamic equilibrium, which means that solubility results from the simultaneous and opposing processes of dissolution and phase joining (e.g. precipitation of solids). The solubility equilibrium occurs when the two processes proceed at a constant rate. The solubility of a given solute in a given solvent typically depends on temperature. For many solids dissolved in liquid water, the solubility increases with temperature. In liquid water at high temperatures, the solubility of ionic solutes tends to decrease due to the change of properties and structure of liquid water. In more particular, solubility and solubilization as referred to herein are the properties of oil to dissolve in water and vice versa.

“Viscosity” refers to a fluid's internal resistance to flow or being deformed by shear or tensile stress. In other words, viscosity may be defined as thickness or internal friction of a liquid. Thus, water is “thin”, having a lower viscosity, while oil is “thick,” having a higher viscosity. More generally, the less viscous a fluid is, the greater its ease of fluidity.

The term “salinity” as used herein, refers to concentration of salt dissolved in a aqueous phases. Examples for such salts are without limitation, sodium chloride, magnesium and calcium sulfates, and bicarbonates. In more particular, the term salinity as it pertains to the present invention refers to the concentration of salts in brine and emulsions.

A “basic agent” as provided herein is used according to its conventional meaning and refers to an alkali or an organic base. Where the basic agent is an alkali, the basic agent includes any basic, ionic salts of alkali metals or alkaline earth metals. Examples of alkalis useful for the present invention include, but are not limited to, sodium hydroxide, sodium carbonate, sodium silicate, sodium metaborate, and EDTA tetrasodium salt. An “organic base” as provided herein refers to an organic compound, which acts as a base. Organic bases useful for the compositions and methods provided herein including embodiments thereof include amines and nitrogen-containing heterocyclic compounds. Alkalis and organic bases as provided herein are typically capable of reacting with an unrefined petroleum acid (e.g. the acid in crude oil (reactive oil)) or its precursor to form soap (a surfactant which is a salt of a fatty acid) in situ. These in situ generated soaps serve as a source of surfactants causing a reduction of the interfacial tension of the oil in water emulsion, thereby reducing the viscosity of the emulsion.

A “co-solvent” refers to a compound having the ability to increase the solubility of a solute in the presence of an unrefined petroleum acid. In some embodiments, the co-solvents provided herein have a hydrophobic portion (short alkyl or aryl chain), a hydrophilic portion (e.g. an alcohol) and optionally an alkoxy portion. Co-solvents as provided herein include alcohols (e.g. C₁-C₆ alcohols, C₁-C₆ diols), alkoxy alcohols (e.g. C₁-C₆ alkoxy alcohols, C₁-C₆ alkoxy diols, phenyl alkoxy alcohols), glycol ether, glycol and glycerol.

A “microemulsion” as referred to herein is a thermodynamically stable mixture of oil, water, and a stabilizing agents such as a surfactant or a co-solvent that may also include additional components such as alkali agents, polymers (e.g. water-soluble polymers) and a salt. In contrast, a “macroemulsion” as referred to herein is a thermodynamically unstable mixture of oil and water that may also include additional components. An “emulsion” as referred to herein may be a microemulsion or a macroemulsion.

A “catalyst” as referred to herein is an agent used to convert unrefined petroleum, typically heaving low octane ratings, into high-octane liquid reformates, which are components of high-octane gasoline. During the process of conversion, the hydrocarbon molecules in the unrefined petroleum may be restructured and broken up into smaller molecules. The reformate produced by the conversion process may contain hydrocarbons with more complex molecular shapes having higher octane values than the hydrocarbons in the unrefined petroleum. Examples of catalysts useful for the conversion of unrefined petroleum into lighter high-octane reformates are without limitation, nanoparticles, platinum, palladium, rhodium, nickel, chromium oxide, Pt/Al₂O₃, zinc titanium oxide, aluminum oxide, and zeolites.

### II. Compositions

While the making and using of various embodiments of the present invention are discussed in detail below, it should be appreciated that the present invention provides many applicable inventive concepts that can be embodied in a wide variety of specific contexts. The specific embodiments discussed herein are merely illustrative of specific ways to make and use the invention and do not limit the scope of the invention.

Provided herein are, inter alia, heavy crude oil emulsion compositions to be used for a variety of applications including transport of heavy crude oils. The heavy crude oil emulsions provided herein may be used with a wide variety of heavy crude oil concentrations and at a wide range of salinity, including hard brine and soft brine. In embodiments, the viscosity of the heavy crude oil emulsion compositions provided herein is surprisingly lower than the viscosity of the heavy crude oil. Further, the viscosity of the heavy crude oil emulsions provided herein may remain low at ambient temperatures (i.e. temperatures below 80° C.) over extended periods of time, making them particularly useful for heavy crude oil transport.

In a first aspect, provided herein is a heavy crude oil emulsion including a heavy crude oil, a co-solvent, a basic agent and water, wherein the viscosity of the emulsion is lower than the viscosity of the heavy crude oil. In some embodiments, the emulsion is within a transport vessel. In embodiments, the heavy crude oil is an asphaltene.

In another aspect, provided herein is a transport vessel including a heavy crude oil in combination with a catalyst. The transport vessel may further include one or more of the following in combination with the heavy crude oil and the catalyst: a surfactant, a co-solvent, a basic agent and/or water. As described herein, the heavy crude oil may form part of an emulsion.

In some embodiments, the emulsion further includes a surfactant. Where the emulsion further includes a surfactant, the emulsion may include a surfactant or a surfactant blend (e.g. a plurality of surfactant types). The surfactant provided herein may be any appropriate surfactant useful in the field of enhanced oil recovery or transport of heavy crude oil. In some embodiments, the surfactant is a single surfactant type in the emulsion. In other embodiments, the surfactant is a surfactant blend. A “surfactant blend” as provided herein is a mixture of a plurality of surfactant types. In some embodiments, the surfactant blend includes a first surfactant type, a second surfactant type or a third surfactant type. The first, second and third surfactant type may be independently different (e.g. anionic or cationic surfactants; or two anionic surfactants having a different hydrocarbon chain length but are otherwise the same). Therefore, a person having ordinary skill in the art will immediately recognize that the terms “surfactant” and “surfactant type(s)” have the same meaning and can be used interchangeably. In some embodiments, the surfactant is an anionic surfactant, a non-ionic surfactant, a zwitterionic surfactant or a cationic surfactant. In some embodiments, the surfactant is an anionic surfactant, a non-ionic surfactant, or a cationic surfactant. In other embodiments, the surfactant is a zwitterionic surfactant. “Zwitterionic” or “zwitterion” as used herein refers to a neutral molecule with a positive (or cationic) and a negative (or anionic) electrical charge at different locations within the same molecule. Examples for zwitterionics are without limitation betains and sultains.

The surfactant provided herein may be any appropriate anionic surfactant. In some embodiments, the surfactant is an anionic surfactant. In some embodiments, the anionic surfactant is an anionic surfactant blend. Where the anionic surfactant is an anionic surfactant blend the emulsion includes a plurality (i.e. more than one) of anionic surfactant types. In some embodiments, the anionic surfactant is an alkoxy carboxylate surfactant, an alkoxy sulfate surfactant, an alkoxy sulfonate surfactant, an alkyl sulfonate surfactant, an aryl sulfonate surfactant or an olefin sulfonate surfactant. An “alkoxy carboxylate surfactant” as provided herein is a compound having an alkyl or aryl attached to one or more alkoxylene groups (typically —CH₂—CH(ethyl)-O—, —CH₂—CH(methyl)-O—, or —CH₂—CH₂—O—) which, in turn is attached to —COO⁻ or acid or salt thereof including metal cations such as sodium. In some embodiments, the alkoxy carboxylate surfactant has the formula:

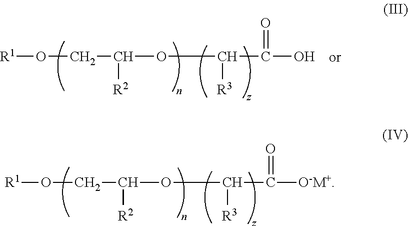

In formula (III) or (IV) R¹ is substituted or unsubstituted C₈-C₁₅₀ alkyl or substituted or unsubstituted aryl, R² is independently hydrogen or unsubstituted C₁-C₆ alkyl, R³ is independently hydrogen or unsubstituted C₁-C₆ alkyl, n is an integer from 2 to 210, z is an integer from 1 to 6 and M⁺ is a monovalent, divalent or trivalent cation. In some embodiments, R¹ is unsubstituted linear or branched C₈-C₃₆ alkyl. In some embodiments, R¹ is (C₆H₅—CH₂CH₂)₃C₆H₂-(TSP), (C₆H₅—CH₂CH₂)₂C₆H₃-(DSP), (C₆H₅—CH₂CH₂)₁C₆H₄-(MSP), or substituted or unsubstituted naphthyl. In some embodiments, the alkoxy carboxylate is C₂₈-25PO-25EO-carboxylate (i.e. unsubstituted C₂₈ alkyl attached to 25 —CH₂—CH(methyl)-O-linkers, attached in turn to 25 —CH₂—CH₂—O— linkers, attached in turn to —COO⁻ or acid or salt thereof including metal cations such as sodium).

In some embodiments, the surfactant is an alkoxy sulfate surfactant. An alkoxy sulfate surfactant as provided herein is a surfactant having an alkyl or aryl attached to one or more alkoxylene groups (typically —CH₂—CH(ethyl)-O—, —CH₂—CH(methyl)-O—, or —CH₂—CH₂—O—) which, in turn is attached to —SO₃⁻ or acid or salt thereof including metal cations such as sodium.

In some embodiment, the alkoxy sulfate surfactant has the formula R^{A}—(BO)ₑ—(PO)_{f}-(EO)_{g}—SO₃⁻ or acid or salt (including metal cations such as sodium) thereof, wherein R^{A} is C₈-C₃₀ alkyl, BO is —CH₂—CH(ethyl)-O—, PO is —CH₂—CH(methyl)-O—, and EO is —CH₂—CH₂—O—. The symbols e, f and g are integers from 0 to 25 wherein at least one is not zero. In some embodiment, the alkoxy sulfate surfactant is C₁₅-13PO-sulfate (i.e. an unsubstituted C₁₅ alkyl attached to 13 —CH₂—CH(methyl)-O— linkers, in turn attached to —SO₃⁻ or acid or salt thereof including metal cations such as sodium).

In other embodiments, the alkoxy sulfate surfactant has the formula

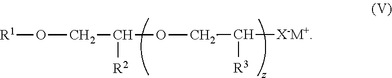

In formula (V) R¹ and R² are independently substituted or unsubstituted C₈-C₁₅₀ alkyl or substituted or unsubstituted aryl. R³ is independently hydrogen or unsubstituted C₁-C₆ alkyl. z is an integer from 2 to 210. X⁻ is

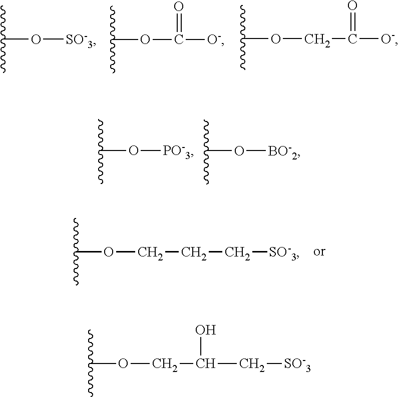

and M⁺ is a monovalent, divalent or trivalent cation. In some embodiments, R¹ is branched unsubstituted C₈-C₁₅₀. In other embodiments, R¹ is branched or linear unsubstituted C₁₂-C₁₀₀ alkyl, (C₆H₅—CH₂CH₂)₃C₆H₂-(TSP), (C₆H₅—CH₂CH₂)₂C₆H₃-(DSP), (C₆H₅—CH₂CH₂)₁C₆H₄-(MSP), or substituted or unsubstituted naphthyl. In some embodiments, the alkoxy sulfate is C₁₆-C₁₆-epoxide-15PO-10EO-sulfate (i.e. a linear unsubstituted C₁₆ alkyl attached to an oxygen, which in turn is attached to a branched unsubstituted C₁₆ alkyl, which in turn is attached to 15 —CH₂—CH(methyl)-O— linkers, in turn attached to 10 —CH₂—CH₂—O— linkers, in turn attached to —SO₃⁻ or acid or salt thereof including metal cations such as sodium.

The alkoxy sulfate surfactant provided herein may be an aryl alkoxy sulfate surfactant. An aryl alkoxy surfactant as provided herein is an alkoxy surfactant having an aryl attached to one or more alkoxylene groups (typically —CH₂—CH(ethyl)-O—, —CH₂—CH(methyl)-O—, or —CH₂—CH₂—O—) which, in turn is attached to —SO₃⁻ or acid or salt thereof including metal cations such as sodium. In some embodiments, the aryl alkoxy sulfate surfactant is (C₆H₅—CH₂CH₂)₃C₆H₂-7PO-10EO-sulfate (i.e. tri-styrylphenol attached to 7 —CH₂—CH(methyl)-O— linkers, in turn attached to 10 —CH₂—CH₂—O— linkers, in turn attached to —SO₃⁻ or acid or salt thereof including metal cations such as sodium).

In some embodiments, the surfactant is an unsubstituted alkyl sulfate or an unsubstituted alkyl sulfonate surfactant. An alkyl sulfate surfactant as provided herein is a surfactant having an alkyl group attached to —O—SO₃⁻ or acid or salt thereof including metal cations such as sodium. An alkyl sulfonate surfactant as provided herein is a surfactant having an alkyl group attached to —SO₃⁻ or acid or salt thereof including metal cations such as sodium. In some embodiments, the surfactant is an unsubstituted aryl sulfate surfactant or an unsubstituted aryl sulfonate surfactant. An aryl sulfate surfactant as provided herein is a surfactant having an aryl group attached to —O—SO₃⁻ or acid or salt thereof including metal cations such as sodium. An aryl sulfonate surfactant as provided herein is a surfactant having an aryl group attached to —SO₃⁻ or acid or salt thereof including metal cations such as sodium. In some embodiments, the surfactant is an alkyl aryl sulfonate. Non-limiting examples of alkyl sulfate surfactants, aryl sulfate surfactants, alkyl sulfonate surfactants, aryl sulfonate surfactants and alkyl aryl sulfonate surfactants useful in the embodiments provided herein are alkyl aryl sulfonates (ARS) (e.g. alkyl benzene sulfonate (ABS)), alkane sulfonates, petroleum sulfonates, and alkyl diphenyl oxide (di)sulfonates. Additional surfactants useful in the embodiments provided herein are alcohol sulfates, alcohol phosphates, alkoxy phosphate, sulfosuccinate esters, alcohol ethoxylates, alkyl phenol ethoxylates, quaternary ammonium salts, betains and sultains.

The surfactant as provided herein may be an olefin sulfonate surfactant. In some embodiments, the olefin sulfonate surfactant is an internal olefin sulfonate (IOS) or an alfa olefin sulfonate (AOS). In some embodiments, the olefin sulfonate surfactant is a C₁₀-C₃₀ (IOS). In some further embodiments, the olefin sulfonate surfactant is C₁₅-C₁₈ IOS. In other embodiments, the olefin sulfonate surfactant is C₁₉-C₂₈ IOS. Where the olefin sulfonate surfactant is C₁₅-C₁₈ IOS, the olefin sulfonate surfactant is a mixture (combination) of C₁₅, C₁₆, C₁₇ and C₁₅ alkene, wherein each alkene is attached to a —SO₃⁻ or acid or salt thereof including metal cations such as sodium. Likewise, where the olefin sulfonate surfactant is C₁₉-C₂₈ IOS, the olefin sulfonate surfactant is a mixture (combination) of C₁₉, C₂₀, C₂₁ C₂₂, C₂₃, C₂₄, C₂₅, C₂₆, C₂₇ and C₂₈ alkene, wherein each alkene is attached to a —SO₃⁻ or acid or salt thereof including metal cations such as sodium. As mentioned above, the emulsion provided herein may include a plurality of surfactants (i.e. a surfactant blend). In some embodiments, the surfactant blend includes a first olefin sulfonate surfactant and a second olefin sulfonate surfactant. In some further embodiments, the first olefin sulfonate surfactant is C₁₅-C₁₈ IOS and the second olefin sulfonate surfactant is C₁₉-C₂₈ IOS.

Useful surfactants are disclosed, for example, in U.S. Pat. Nos. 3,811,504, 3,811,505, 3,811,507, 3,890,239, 4,463,806, 6,022,843, 6,225,267, 7,629,299; WIPO Patent Application WO/2008/079855, WO/2012/027757 and WO/2011/094442; as well as U.S. Patent Application Nos. 2005/0199395, 2006/0185845, 2006/018486, 2009/0270281, 2011/0046024, 2011/0100402, 2011/0190175, 2007/0191633, 2010/004843. 2011/0201531, 2011/0190174, 2011/0071057, 2011/0059873, 2011/0059872, 2011/0048721, 2010/0319920, and 2010/0292110. Additional useful surfactants are surfactants known to be used in enhanced oil recovery methods, including those discussed in D. B. Levitt, A. C. Jackson, L. Britton and G. A. Pope, “Identification and Evaluation of High-Performance EOR Surfactants,” SPE 100089, conference contribution for the SPE Symposium on Improved Oil Recovery Annual Meeting, Tulsa, Okla., Apr. 24-26, 2006.

A person having ordinary skill in the art will immediately recognize that many surfactants are commercially available as blends of related molecules (e.g. IOS and ABS surfactants). Thus, where a surfactant is present within a composition provided herein, a person of ordinary skill would understand that the surfactant may be a blend of a plurality of related surfactant molecules (as described herein and as generally known in the art).

In some embodiment, the total surfactant concentration (i.e. the total amount of all surfactant types within the emulsions and emulsion compositions provided herein) in is from about 0.05% w/w to about 10% w/w. In other embodiments, the total surfactant concentration in the emulsion is from about 0.25% w/w to about 10% w/w. In other embodiments, the total surfactant concentration in the emulsion is about 0.5% w/w. In other embodiments, the total surfactant concentration in the emulsion is about 1.0% w/w. In other embodiments, the total surfactant concentration in the emulsion is about 1.25% w/w. In other embodiments, the total surfactant concentration in the emulsion is about 1.5% w/w. In other embodiments, the total surfactant concentration in the emulsion is about 1.75% w/w. In other embodiments, the total surfactant concentration in the emulsion is about 2.0% w/w. In other embodiments, the total surfactant concentration in the emulsion is about 2.5% w/w. In other embodiments, the total surfactant concentration in the emulsion is about 3.0% w/w. In other embodiments, the total surfactant concentration in the emulsion is about 3.5% w/w. In other embodiments, the total surfactant concentration in the emulsion is about 4.0% w/w. In other embodiments, the total surfactant concentration in the emulsion is about 4.5% w/w. In other embodiments, the total surfactant concentration in the emulsion is about 5.0% w/w. In other embodiments, the total surfactant concentration in the emulsion is about 5.5% w/w. In other embodiments, the total surfactant concentration in the emulsion is about 6.0% w/w. In other embodiments, the total surfactant concentration in the emulsion is about 6.5% w/w. In other embodiments, the total surfactant concentration in the emulsion is about 7.0% w/w. In other embodiments, the total surfactant concentration in the emulsion is about 7.5% w/w. In other embodiments, the total surfactant concentration in the emulsion is about 8.0% w/w. In other embodiments, the total surfactant concentration in the emulsion is about 9.0% w/w. In other embodiments, the total surfactant concentration in the emulsion is about 10% w/w.

In other embodiments, the emulsion further includes a catalyst. The catalyst provided herein may be any appropriate catalyst useful in the field of enhanced oil recovery or transport of heavy crude oil. In some embodiments, the catalyst is a single catalyst type in the emulsion. In other embodiments, the catalyst t is a catalyst blend. A “catalyst blend” as provided herein is a mixture of a plurality of catalyst types. In some embodiments, the catalyst blend includes a first catalyst type, a second catalyst type or a third catalyst type. The first, second and third catalyst type may be independently different (e.g. anionic or cationic catalysts; or two cationic catalyst having a different hydrocarbon chain length but are otherwise the same). Therefore, a person having ordinary skill in the art will immediately recognize that the terms “catalyst” and “catalyst type(s)” have the same meaning and can be used interchangeably. In some embodiments, the catalyst is a nanoparticle. In other embodiments, the catalyst is platinum, palladium, rhodium, or nickel. In some embodiments, the catalyst is chromium oxide, Pt/Al₂O₃, or zinc titanium oxide. In other embodiments, the catalyst is aluminum oxide or zeolites.

In some embodiments, the emulsion is at a transport temperature. A transport temperature as provided herein refers to a temperature at which a heavy crude oil emulsion is transported in a transport vessel (e.g. an oil pipeline). A “transport vessel” as used herein, refers to a container used for transporting oil, typically large amounts of oil (e.g. at least hundreds of gallons, at least thousands of gallons, at least millions of gallons or at least billions of gallons). A transport vessel includes a storage vessel contained within a petroleum tanker (oil tankers), barge, truck or a train. A transport vessel also includes a petroleum pipeline (oil pipeline). In embodiments, the transport vessel is a production well. The transport temperature of a heavy crude oil emulsion may be less than the temperature of the heavy crude oil in the reservoir or less than the temperature of the heavy crude oil after extraction from the reservoir. In some embodiments, the transport temperature is less than 100° C. In some embodiments, the transport temperature is less than 70° C. In some embodiments, the transport temperature is less than 70° C. In some embodiments, the transport temperature is less than 60° C. In other embodiments, the transport temperature is less than 55° C. In some embodiments, the transport temperature is less than 50° C. In other embodiments, the transport temperature is less than 45° C. In some embodiments, the transport temperature is less than 40° C. In other embodiments, the transport temperature is less than 35° C. In some embodiments, the transport temperature is less than 30° C. In other embodiments, the transport temperature is less than 25° C. In some embodiments, the transport temperature is less than 20° C. In other embodiments, the transport temperature is less than 15° C. In some embodiments, the transport temperature is from about 0° C. to about 70° C. In some embodiments, the transport temperature is from about 10° C. to about 70° C. In some embodiments, the transport temperature is from about 15° C. to about 70° C. In other embodiments, the transport temperature is from about 20° C. to about 70° C. In other embodiments, the transport temperature is from about 25° C. to about 70° C. In other embodiments, the transport temperature is from about 30° C. to about 70° C. In other embodiments, the transport temperature is from about 35° C. to about 70° C. In other embodiments, the transport temperature is from about 40° C. to about 70° C. In other embodiments, the transport temperature is from about 45° C. to about 70° C. In other embodiments, the transport temperature is from about 50° C. to about 70° C. In other embodiments, the transport temperature is from about 55° C. to about 70° C. In some embodiments, the transport temperature is from about 0° C. to about 60° C. In some embodiments, the transport temperature is from about 10° C. to about 60° C. In some embodiments, the transport temperature is from about 15° C. to about 60° C. In other embodiments, the transport temperature is from about 20° C. to about 60° C. In other embodiments, the transport temperature is from about 25° C. to about 60° C. In other embodiments, the transport temperature is from about 30° C. to about 60° C. In other embodiments, the transport temperature is from about 35° C. to about 60° C. In other embodiments, the transport temperature is from about 40° C. to about 60° C. In other embodiments, the transport temperature is from about 45° C. to about 60° C. In other embodiments, the transport temperature is from about 50° C. to about 60° C. In other embodiments, the transport temperature is from about 55° C. to about 60° C. In some embodiments, the transport temperature is about 0° C., 5° C., 10° C., 15° C., 20° C., 25° C., 30° C., 35° C., 40° C., 45° C., 50° C., 55° C., 60° C., 65° C. or 70° C. In some embodiments, the transport temperature is an ambient temperature. An ambient temperature as provided herein may be a temperature of less than 80° C. Thus, in embodiments, the ambient temperature is less than 80° C. In embodiments, the ambient temperature is less than 60° C. In embodiments, the ambient temperature is less than 40° C. In embodiments, the ambient temperature is 20° C.

The heavy crude oil emulsion compositions provided herein include a broad concentration of heavy crude oil. In some embodiments, the heavy crude oil is present from about 10% to about 95% (v/v). In other embodiments, the heavy crude oil is present from about 15% to about 95% (v/v), from about 20% to about 95% (v/v), from about 25% to about 95% (v/v), from about 30% to about 95% (v/v), from about 35% to about 95% (v/v), from about 40% to about 95% (v/v), from about 45% to about 95% (v/v), from about 50% to about 95% (v/v), from about 55% to about 95% (v/v), from about 60% to about 95% (v/v), from about 65% to about 95% (v/v), from about 70% to about 95% (v/v), from about 75% to about 95% (v/v), from about 80% to about 95% (v/v), from about 85% to about 95% (v/v) or from about 90% to about 95% (v/v). In some embodiments, the heavy crude oil is present at about 10%, 15%, 20%, 25%, 30%, 35%, 40%, 45%, 50%, 55%, 60%, 65%, 70%, 75%, 80%, 85%, 90% or 95% (v/v). In some embodiments, the heavy crude oil is present at about 20% (v/v). In other embodiments, the heavy crude oil is present at about 40% (v/v). In other embodiments, the heavy crude oil is present at about 60% (v/v). In other embodiments, the heavy crude oil is present at about 80% (v/v). A person of ordinary skill in the art will immediately recognize that the above referenced values refer to volume percent of oil per volume of emulsion.

The emulsion composition provided herein may include a co-solvent, a basic agent and water in addition to the heavy crude oil. Where the emulsion further includes a co-solvent, the emulsion may include a co-solvent or a co-solvent blend (e.g. a plurality of co-solvent types). In some embodiments, the co-solvent is a single co-solvent type in the emulsion. In embodiments, the co-solvent is a co-solvent blend. A “co-solvent blend” as provided herein is a mixture of a plurality of co-solvent types. Thus, in one embodiment, the emulsion composition includes a plurality of different co-solvents. Where the emulsion composition includes a plurality of different co-solvents, the different co-solvents can be distinguished by their chemical (structural) properties (e.g., a compound of formula (I), (IA), (IB), (IC), (ID), (II), (IIA) or (IIB)). For example, the emulsion composition may include a first co-solvent, a second co-solvent and a third co-solvent, wherein the first co-solvent is chemically different from the second and the third co-solvent, and the second co-solvent is chemically different from the third co-solvent. In one embodiment, the plurality of different co-solvents includes at least two different alcohols (e.g. a C₁-C₆ alcohol and a C₁-C₄ alcohol). In one embodiment, the emulsion composition includes a C₁-C₆ alcohol and a C₁-C₄ alcohol. In other embodiments, the plurality of different co-solvents includes at least two different alkoxy alcohols (e.g. a C₁-C₆ alkoxy alcohol and a C₁-C₄ alkoxy alcohol). In other embodiments, the emulsion composition includes a C₁-C₆ alkoxy alcohol and a C₁-C₄ alkoxy alcohol. In one embodiment, the plurality of different co-solvents includes at least two co-solvents selected from the group consisting of alcohols, alkyl alkoxy alcohols and phenyl alkoxy alcohols. For example, the plurality of different co-solvents may include an alcohol and an alkyl alkoxy alcohol, an alcohol and a phenyl alkoxy alcohol, or an alcohol, an alkyl alkoxy alcohol and a phenyl alkoxy alcohol. The alkyl alkoxy alcohols or phenyl alkoxy alcohols provided herein have a hydrophobic portion (alkyl or aryl chain), a hydrophilic portion (e.g. an alcohol) and optionally an alkoxy (ethoxylate or propoxylate) portion. Thus, in some embodiments, the co-solvent is an alcohol, alkoxy alcohol, glycol ether, glycol or glycerol. In embodiments, the co-solvent is an alcohol, alkoxy alcohol or glycol ether.

In some embodiments, the co-solvent has the formula

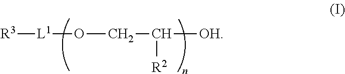

In formula (I), L¹ is unsubstituted C₁-C₆ alkylene, unsubstituted phenylene, unsubstituted cyclohexylene, unsubstituted cyclopentylene or methyl-substituted cyclopentylene. R² is independently hydrogen, methyl or ethyl. R³ is independently hydrogen or

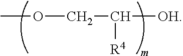

R⁴ is independently hydrogen, methyl or ethyl, n is an integer from 0 to 30, and m is an integer from 0 to 30. In one embodiment, n is an integer from 0 to 25. In one embodiment, n is an integer from 0 to 20. In one embodiment, n is an integer from 0 to 15. In one embodiment, n is an integer from 0 to 10. In one embodiment, n is an integer from 0 to 5. In one embodiment, n is 1. In other embodiments, n is 3. In one embodiment, n is 5. In one embodiment, m is an integer from 0 to 25. In one embodiment, m is an integer from 0 to 20. In one embodiment, m is an integer from 0 to 15. In one embodiment, m is an integer from 0 to 10. In one embodiment, m is an integer from 0 to 5. In one embodiment, m is 1. In other embodiments, m is 3. In one embodiment, m is 5. In formula (I) each of R² and R⁴ can appear more than once and can be optionally different. For example, in one embodiment where n is 2, R² appears twice and can be optionally different. In other embodiments, where m is 3, R⁴ appears three times and can be optionally different.

L¹ may be linear or branched unsubstituted alkylene. In one embodiment, L¹ of formula (I) is linear unsubstituted C₁-C₆ alkylene. In one embodiment, L¹ of formula (I) is branched unsubstituted C₁-C₆ alkylene. In other embodiments, L¹ of formula (I) is linear unsubstituted C₂-C₆ alkylene. In other embodiments, L¹ of formula (I) is branched unsubstituted C₂-C₆ alkylene. In other embodiments, L¹ of formula (I) is linear unsubstituted C₃-C₆ alkylene. In other embodiments, L¹ of formula (I) is branched unsubstituted C₃-C₆ alkylene. In other embodiments, L¹ of formula (I) is linear unsubstituted C₄-C₆ alkylene. In other embodiments, L¹ of formula (I) is branched unsubstituted C₄-C₆ alkylene. In other embodiments, L¹ of formula (I) is linear unsubstituted C₄-alkylene. In other embodiments, L¹ of formula (I) is branched unsubstituted C₄-alkylene.

In one embodiment, where L¹ is linear or branched unsubstituted alkylene (e.g. branched unsubstituted C₁-C₆ alkylene), the alkylene is a saturated alkylene (e.g. a linear or branched unsubstituted saturated alkylene or branched unsubstituted C₁-C₆ saturated alkylene). A “saturated alkylene,” as used herein, refers to an alkylene consisting only of hydrogen and carbon atoms that are bonded exclusively by single bonds. Thus, in one embodiment, L¹ is linear or branched unsubstituted saturated alkylene. In one embodiment, L¹ of formula (I) is linear unsubstituted saturated C₁-C₆ alkylene. In one embodiment, L¹ of formula (I) is branched unsubstituted saturated C₁-C₆ alkylene. In other embodiments, L¹ of formula (I) is linear unsubstituted saturated C₂-C₆ alkylene. In other embodiments, L¹ of formula (I) is branched unsubstituted saturated C₂-C₆ alkylene. In other embodiments, L¹ of formula (I) is linear unsubstituted saturated C₃-C₆ alkylene. In other embodiments, L¹ of formula (I) is branched unsubstituted saturated C₃-C₆ alkylene. In other embodiments, L¹ of formula (I) is linear unsubstituted saturated C₄-C₆ alkylene. In other embodiments, L¹ of formula (I) is branched unsubstituted saturated C₄-C₆ alkylene. In other embodiments, L¹ of formula (I) is linear unsubstituted saturated C₄-alkylene. In other embodiments, L¹ of formula (I) is branched unsubstituted saturated C₄-alkylene.

In one embodiment, L¹ of formula (I) is substituted or unsubstituted cycloalkylene or unsubstituted arylene. In one embodiment, L¹ of formula (I) is R⁷-substituted or unsubstituted cyclopropylene, wherein R⁷ is C₁-C₃ alkyl. In other embodiments, L¹ of formula (I) is R⁸-substituted or unsubstituted cyclobutylene, wherein R⁸ is C₁-C₂ alkyl. In other embodiments, L¹ of formula (I) is R⁹-substituted or unsubstituted cyclopentylene, wherein R⁹ is C₁-alkyl. In other embodiments, L¹ of formula (I) is R¹⁰-substituted or unsubstituted cyclopentylene, wherein R¹⁰ is unsubstituted cyclohexyl. In one embodiment, L¹ of formula (I) is unsubstituted phenylene, unsubstituted cyclohexylene, unsubstituted cyclopentylene or methyl-substituted cyclopentylene.

In one embodiment, -L¹-R³ of formula (I) is C₁-C₆ alkyl, unsubstituted phenyl, unsubstituted cyclohexyl, unsubstituted cyclopentyl or a methyl-substituted cycloalkyl.

In one embodiment, the co-solvent has the structure of formula

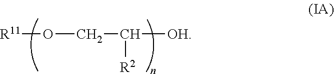

In formula (IA), R¹¹ is C₁-C₆ alkyl, unsubstituted phenyl, unsubstituted cyclohexyl, unsubstituted cyclopentyl or a methyl-substituted cycloalkyl.

In one embodiment, n and m are independently 1 to 20. In other embodiments, n and m are independently 1 to 15. In other embodiments, n and m are independently 1 to 10. In one embodiment, n and m are independently 1 to 6. In one embodiment, n and m are independently 1.

The co-solvent included in the emulsion compositions provided herein may be a monohydric or a dihydric alkoxy alcohol (e.g. C₁-C₆ alkoxy alcohol or C₁-C₆ alkoxy diol). Where the co-solvent is a monohydric alcohol, the co-solvent has the formula (I) and R³ is hydrogen. Where the co-solvent is a diol, the co-solvent has the formula (I) and R³ is

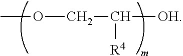

In one embodiment, L¹ is linear unsubstituted C₄ alkylene and n is 3. In one embodiment, the co-solvent is triethyleneglycol butyl ether. In other embodiments, the co-solvent is tetraethylene glycol. In further embodiments, m is 3. In one embodiment, L¹ is linear unsubstituted C₄ alkylene and n is 5. In one embodiment, the co-solvent is pentaethyleneglycol n-butyl ether. In further embodiments, m is 5. In one embodiment, L¹ is branched unsubstituted C₄ alkylene and n is 1. In one embodiment, the co-solvent is ethylene glycol iso-butyl ether. In further embodiments, m is 1. In one embodiment, L¹ is branched unsubstituted C₄ alkylene and n is 3. In one embodiment, the co-solvent is triethylene glycol iso-butyl ether. In further embodiments, m is 3. In one embodiment, the co-solvent is ethylene glycol or propylene glycol. In other embodiments, the co-solvent is ethylene glycol alkoxylate or propylene glycol alkoxylate. In one embodiment, the co-solvent is propylene glycol diethoxylate or propylene glycoltriethoxylate. In one embodiment, the co-solvent is propylene glycol tetraethoxylate.

In the structure of formula (I), R³ may be hydrogen or

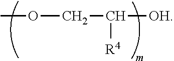

Thus in one embodiment, R³ is

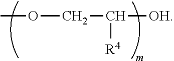

In one embodiment, the co-solvent provided herein may be an alcohol or diol (C₁-C₆ alcohol or C₁-C₆ diol). Where the co-solvent is an alcohol, the co-solvent has a structure of formula (I), where R³ is hydrogen and n is 0. Where the co-solvent is a diol, the co-solvent has a structure of formula (I), where R³ is

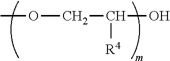

and n and m are 0. Thus, in one embodiment, n and m are independently 0. In one embodiment, L¹ is linear or branched unsubstituted C₁-C₆ alkylene. In other embodiments, L¹ is linear or branched unsubstituted C₂-C₆ alkylene. In one embodiment, L¹ is linear or branched unsubstituted C₂-C₆ alkylene. In one embodiment L¹ is linear or branched unsubstituted C₃-C₆ alkylene. In other embodiments, L¹ is linear or branched unsubstituted C₄-C₆ alkylene. In one embodiment, L¹ is linear or branched unsubstituted C₄-alkylene. In one embodiment, L¹ is branched unsubstituted butylene. In one embodiment, the co-solvent has the structure of formula

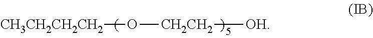

In other embodiments, the co-solvent has the structure of formula

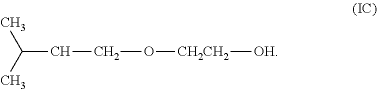

In one embodiment, the co-solvent has the structure of formula

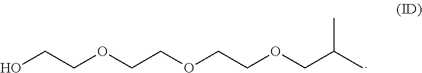

In some embodiments, the co-solvent has the formula

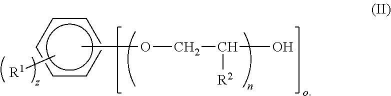

In formula (II) R¹ is independently hydrogen, unsubstituted C₁-C₆ alkyl or R⁵—OH, R² is independently hydrogen or unsubstituted C₁-C₂ alkyl, R⁵ is independently a bond or unsubstituted C₁-C₆ alkyl, n is an integer from 1 to 30, o is an integer from 1 to 5 and z is an integer from 1 to 5. In some embodiments, R¹ is unsubstituted C₂-C₆ alkyl. In some embodiments, R¹ is unsubstituted C₄-C₆ alkyl. In some embodiments, R¹ is unsubstituted C₁-C₅ alkyl. In other embodiments, R¹ is unsubstituted C₁-C₄ alkyl. In other embodiments, R¹ is unsubstituted C₁-C₃ alkyl. In some embodiments, R¹ is unsubstituted C₁-C₂ alkyl. In some embodiments, R¹ is unsubstituted C₂ alkyl. In other embodiments, R¹ is ethyl. In some embodiments, R¹ is methyl. In some embodiment, R¹ is hydrogen.

In some embodiment, R¹ is independently a bond or R⁵—OH. In some embodiment, R¹ is R⁵—OH. In some embodiments, R⁵ is unsubstituted C₂-C₆ alkyl. In some embodiments, R⁵ is unsubstituted C₄-C₆ alkyl. In some embodiments, R⁵ is unsubstituted C₁-C₅ alkyl. In other embodiments, R⁵ is unsubstituted C₁-C₄ alkyl. In other embodiments, R⁵ is unsubstituted C₁-C₃ alkyl. In some embodiments, R⁵ is unsubstituted C₁-C₂ alkyl. In some embodiments, R⁵ is unsubstituted C₂ alkyl. In other embodiments, R⁵ is ethyl. In some embodiments, R⁵ is methyl. In some embodiments, R⁵ is a bond.

In formula (II) the symbol n is an integer from 1 to 30. In one embodiment, n is an integer from 1 to 25. In one embodiment, n is an integer from 1 to 20. In one embodiment, n is an integer from 1 to 15. In one embodiment, n is an integer from 1 to 10. In one embodiment, n is an integer from 1 to 5. In some embodiment, n is 1, 2, 3, 4, 5, 6, 7, 8, 9, 10, 11, 12, 13, 14, 15, 16, 17, 18, 19, 20, 21, 22, 23, 24, 25, 26, 27, 28, 29, or 30. In one embodiment, n is 3. In other embodiments, n is 5. In one embodiment, n is 6. In one embodiment, n is 16.

In formula (II) the symbol o is an integer from 1 to 5 and the symbol z is an integer from 1 to 5. In embodiments, o is 1, 2, 3, 4, or 5. In embodiments, z is 1, 2, 3, 4, or 5. In embodiments, o is 1 and z is 5. In further embodiments, R¹ is independently hydrogen or R⁵—OH and R⁵ is a bond. In other further embodiments, R¹ is hydrogen. In other further embodiments, R¹ is R⁵—OH and R⁵ is a bond.

In some embodiments, the co-solvent has the formula

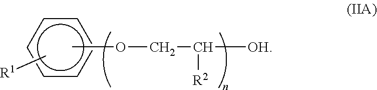

In formula (IIA) R¹ is independently hydrogen or unsubstituted C₁-C₆ alkyl, R² is independently hydrogen or unsubstituted C₁-C₂ alkyl and n is an integer from 1 to 30. In some embodiments, R¹ is unsubstituted C₂-C₆ alkyl. In some embodiments, R¹ is unsubstituted C₄-C₆ alkyl. In some embodiments, R¹ is unsubstituted C₁-C₅ alkyl. In other embodiments, R¹ is unsubstituted C₁-C₄ alkyl. In other embodiments, R¹ is unsubstituted C₁-C₃ alkyl. In some embodiments, R¹ is unsubstituted C₁-C₂ alkyl. In some embodiments, R¹ is unsubstituted C₂ alkyl. In other embodiments, R¹ is ethyl. In some embodiments, R¹ is methyl. In some embodiment, R¹ is hydrogen.

R¹ may be linear or branched unsubstituted alkyl. In one embodiment, R¹ of formula (IIA) is linear unsubstituted C₁-C₆ alkyl. In one embodiment, R¹ of formula (IIA) is branched unsubstituted C₁-C₆ alkyl. In other embodiments, R¹ of formula (IIA) is linear unsubstituted C₁-C₅ alkyl. In other embodiments, R₁ of formula (IIA) is branched unsubstituted C₁-C₅ alkyl. In other embodiments, R₁ of formula (IIA) is linear unsubstituted C₁-C₄ alkyl. In other embodiments, R₁ of formula (IIA) is branched unsubstituted C₁-C₄ alkyl. In other embodiments, R¹ of formula (IIA) is linear unsubstituted C₁-C₃ alkyl. In other embodiments, R₁ of formula (IIA) is branched unsubstituted C₁-C₃ alkyl. In other embodiments, R₁ of formula (IIA) is linear unsubstituted ethyl. In other embodiments, R₁ of formula (IIA) is branched unsubstituted ethyl.

In one embodiment, where R₁ is linear or branched unsubstituted alkyl (e.g. branched unsubstituted C₁-C₆ alkyl), the alkyl is a saturated alkyl (e.g. a linear or branched unsubstituted saturated alkyl or branched unsubstituted C₁-C₆ saturated alkyl). A “saturated alkyl,” as used herein, refers to an alkyl consisting only of hydrogen and carbon atoms that are bonded exclusively by single bonds. Thus, in one embodiment, R₁ is linear or branched unsubstituted saturated alkyl. In one embodiment, R₁ of formula (IIA) is linear unsubstituted saturated C₁-C₆ alkyl. In one embodiment, R₁ of formula (IIA) is branched unsubstituted saturated C₁-C₆ alkyl. In other embodiments, R₁ of formula (IIA) is linear unsubstituted saturated C₁-C₅ alkyl. In other embodiments, R₁ of formula (IIA) is branched unsubstituted saturated C₁-C₅ alkyl. In other embodiments, R₁ of formula (IIA) is linear unsubstituted saturated C₁-C₄ alkyl. In other embodiments, R¹ of formula (IIA) is branched unsubstituted saturated C₁-C₄ alkyl. In other embodiments, R¹ of formula (IIA) is linear unsubstituted saturated C₁-C₃ alkyl. In other embodiments, R¹ of formula (IIA) is branched unsubstituted saturated C₁-C₃ alkyl. In other embodiments, R¹ of formula (IIA) is linear unsubstituted saturated ethyl. In other embodiments, R¹ of formula (IIA) is branched unsubstituted saturated ethyl.

In formula (IIA) the symbol n is an integer from 1 to 30. In one embodiment, n is an integer from 1 to 25. In one embodiment, n is an integer from 1 to 20. In one embodiment, n is an integer from 1 to 15. In one embodiment, n is an integer from 1 to 10. In one embodiment, n is an integer from 1 to 5. In some embodiment, n is 1, 2, 3, 4, 5, 6, 7, 8, 9, 10, 11, 12, 13, 14, 15, 16, 17, 18, 19, 20, 21, 22, 23, 24, 25, 26, 27, 28, 29, or 30. In one embodiment, n is 3. In other embodiments, n is 5. In one embodiment, n is 6. In one embodiment, n is 16.

In some embodiments, R¹ is hydrogen. In other related embodiments, n is as defined in an embodiment above (e.g. n is at least 1, or at least 15, e.g. 5 to 20). Thus, in some embodiments, R¹ is hydrogen and n is 16.

In some embodiments, R¹ is methyl. In other related embodiments, n is as defined in an embodiment above (e.g. n is at least 1, or at least 10, e.g. 5 to 20). Thus, in some embodiments, R¹ is methyl and n is 16.

In some embodiment, the co-solvent has the formula:

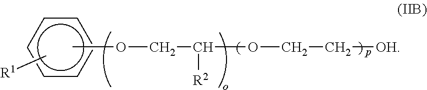

In formula (IIB) R¹ is defined as above (e.g. unsubstituted C₁-C₆ alkyl), R² is methyl or ethyl, o is an integer from 0 to 10 and p is an integer from 1 to 20. In some embodiments, R² is methyl. In other embodiments, R² is ethyl. In formula (IIB) R² can appear more than once and can be optionally different. For example, in some embodiments where o is 3, R² appears three times and can be optionally different. In other embodiments, where o is 6, R² appears six times and can be optionally different.

In some embodiments, o is 0 to 10. In some related embodiments, o is 0 to 8. In some related embodiments, o is 0 to 6. In some related embodiments, o is 0 to 4. In some related embodiments, o is 0 to 2. In still further related embodiments, o is 0. In some further related embodiment, p is 1 to 20. In some further related embodiment, p is 1 to 18. In some further related embodiment, p is 1 to 16. In some further related embodiment, p is 1 to 14. In some further related embodiment, p is 1 to 12. In some further related embodiment, p is 1 to 10. In some further related embodiment, p is 1 to 8. In some further related embodiment, p is 1 to 6. In some further related embodiment, p is 1 to 4. In some further related embodiment, p is 1 to 2. In still some further related embodiment, p is more than 1. In some further embodiment, p is 6. In some further embodiment, p is 16. R¹ and R² may be any of the embodiments described above (e.g. R¹ maybe linear unsubstituted C₁-C₆ alkyl, R² maybe linear unsubstituted C₁-C₂ alkyl). Thus, in some embodiment, R¹ is hydrogen, o is 0 and p is 16.

In some embodiments, o is 1 to 10. In some related embodiments, o is 1 to 8. In some related embodiments, o is 1 to 6. In some related embodiments, o is 1 to 4. In some related embodiments, o is 1 to 2. In some further related embodiment, p is 1 to 20. In some further related embodiment, p is 1 to 18. In some further related embodiment, p is 1 to 16. In some further related embodiment, p is 1 to 14. In some further related embodiment, p is 1 to 12. In some further related embodiment, p is 1 to 10. In some further related embodiment, p is 1 to 8. In some further related embodiment, p is 1 to 6. In some further related embodiment, p is 1 to 4. In some further related embodiment, p is 1 to 2. In still some further related embodiment, p is more than 1. R¹ and R² may be any of the embodiments described above (e.g. R¹ maybe linear unsubstituted C₁-C₆ alkyl, R² maybe linear unsubstituted C₁-C₂ alkyl).

In some embodiments, o is 2 to 10. In some related embodiments, o is 2 to 8. In some related embodiments, o is 2 to 6. In some related embodiments, o is 2 to 4. In some further related embodiment, p is 1 to 20. In some further related embodiment, p is 1 to 18. In some further related embodiment, p is 1 to 16. In some further related embodiment, p is 1 to 14. In some further related embodiment, p is 1 to 12. In some further related embodiment, p is 1 to 10. In some further related embodiment, p is 1 to 8. In some further related embodiment, p is 1 to 6. In some further related embodiment, p is 1 to 4. In some further related embodiment, p is 1 to 2. In still some further related embodiment, p is more than 1. R¹ and R² may be any of the embodiments described above (e.g. R¹ maybe linear unsubstituted C₁-C₆ alkyl, R² maybe linear unsubstituted C₁-C₂ alkyl).

In some embodiments, o is 4 to 10. In some related embodiments, o is 4 to 8. In some related embodiments, o is 4 to 6. In some further related embodiment, p is 1 to 20. In some further related embodiment, p is 1 to 18. In some further related embodiment, p is 1 to 16. In some further related embodiment, p is 1 to 14. In some further related embodiment, p is 1 to 12. In some further related embodiment, p is 1 to 10. In some further related embodiment, p is 1 to 8. In some further related embodiment, p is 1 to 6. In some further related embodiment, p is 1 to 4. In some further related embodiment, p is 1 to 2. In still some further related embodiment, p is more than 1. R¹ and R² may be any of the embodiments described above (e.g. R¹ maybe linear unsubstituted C₁-C₆ alkyl, R² maybe linear unsubstituted C₁-C₂ alkyl).

In some embodiments, o is 6 to 10. In some related embodiments, o is 6 to 8. In some further related embodiment, p is 1 to 20. In some further related embodiment, p is 1 to 18. In some further related embodiment, p is 1 to 16. In some further related embodiment, p is 1 to 14. In some further related embodiment, p is 1 to 12. In some further related embodiment, p is 1 to 10. In some further related embodiment, p is 1 to 8. In some further related embodiment, p is 1 to 6. In some further related embodiment, p is 1 to 4. In some further related embodiment, p is 1 to 2. In still some further related embodiment, p is more than 1. R¹ and R² may be any of the embodiments described above (e.g. R¹ maybe linear unsubstituted C₁-C₆ alkyl, R² maybe linear unsubstituted C₁-C₂ alkyl).

In some embodiments, o is 8 to 10. In some further related embodiment, p is 1 to 20. In some further related embodiment, p is 1 to 18. In some further related embodiment, p is 1 to 16. In some further related embodiment, p is 1 to 14. In some further related embodiment, p is 1 to 12. In some further related embodiment, p is 1 to 10. In some further related embodiment, p is 1 to 8. In some further related embodiment, p is 1 to 6. In some further related embodiment, p is 1 to 4. In some further related embodiment, p is 1 to 2. In still some further related embodiment, p is more than 1. R¹ and R² may be any of the embodiments described above (e.g. R¹ maybe linear unsubstituted C₁-C₆ alkyl, R² maybe linear unsubstituted C₁-C₂ alkyl).

In formula (II), (IIA) or (IIB) R² may be independently hydrogen or unsubstituted C₁-C₂ alkyl. In some embodiments, R² is hydrogen or unsubstituted C₁ or C₂ alkyl. In some related embodiments, R² is hydrogen or branched unsubstituted C₁ or C₂ saturated alkyl. In some embodiments, R² is hydrogen or a branched unsubstituted C₁ saturated alkyl. In some embodiments, R² is independently hydrogen or methyl. In other embodiments, R² is independently hydrogen or ethyl. In some embodiments, R² is independently hydrogen, methyl or ethyl. In some embodiments, R² is hydrogen. In some embodiments, R² is methyl. In some embodiments, R² is ethyl. In formula (II) R² can appear more than once and can be optionally different. For example, in some embodiments where n is 3, R² appears three times and can be optionally different. In other embodiments, where n is 6, R² appears six times and can be optionally different.

In some embodiments, where multiple R² substituents are present and at least two R² substituents are different, R² substituents with the fewest number of carbons are present to the side of the compound of formula (II), (IIA) or (IIB) bound to the —OH group. In this embodiment, the compound of formula (II), (IIA) or (IIB) will be increasingly hydrophilic in progressing from the R¹ substituent to the side of the compound of formula (II), (IIA) or (IIB) bound to the —OH group. The term “side of the compound of formula (II), (IIA) or (IIB) bound to the —OH group” refers to the side of the compound indicated by asterisks in the below structures:

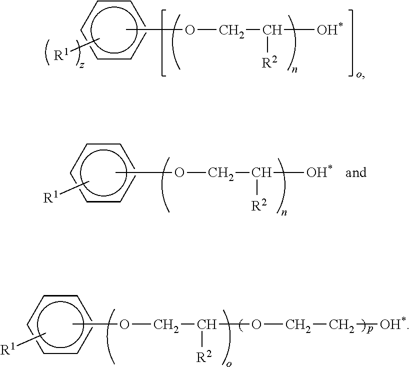

In some embodiments, R² is hydrogen. In other related embodiments, n is as defined in an embodiment above (e.g. n is at least 1, or at least 20, e.g. 5 to 15). Thus, in some embodiments, R² is hydrogen and n is 16.

In some embodiments, R² is methyl. In other related embodiments, n is as defined in an embodiment above (e.g. n is at least 1, or at least 20, e.g. 5 to 15). Thus, in some embodiments, R² is methyl and n is 16.

In some embodiments, the co-solvent is present in an amount sufficient to decrease the viscosity of the heavy crude oil at least 10-fold. In some embodiments, the co-solvent is present in an amount sufficient to decrease the viscosity of the heavy crude oil at least 100-fold. In some embodiments, the co-solvent is present in an amount sufficient to decrease the viscosity of the heavy crude oil at least 1,000-fold. In other words, in the presence of a sufficient amount of the co-solvent, the viscosity of the heavy crude oil is lowered at least 1,000-fold compared to the absence of the co-solvent. Thus, in the presence of a sufficient amount of the co-solvent the viscosity of the heavy crude oil is lower than in the absence of the co-solvent. In some embodiments, the co-solvent is present in an amount sufficient to decrease the viscosity of the heavy crude oil at least 10,000-fold. In some embodiments, the co-solvent is present in an amount sufficient to decrease the viscosity of the heavy crude oil at least 100,000-fold. In some embodiments, the co-solvent is present in an amount sufficient to decrease the viscosity of the heavy crude oil at least 200,000-fold.

The co-solvent as used herein is a compound that may function as an interfacial viscosity reducing agent when in contact with the heavy crude oil (e.g. an unrefined petroleum) within the heavy crude oil emulsion composition. An “interfacial viscosity reducing agent” as provided herein is an agent that in the presence of a basic agent facilitates the formation of soap in situ from carboxylic acids contained in the unrefined oil (also referred to herein as unrefined oil acid). By contacting the basic agent with the carboxylic acid in the crude oil (e.g. by delivering the basic agent more efficiently than water alone) the co-solvent facilitates the generation of soap in situ. The formation of soap in situ promotes the formation of emulsions (both microemulsion and macroemulsion) providing for efficient decrease of the heavy crude oil viscosity by lowering the interfacial tension between the water and the heavy crude oil. The co-solvent provided herein may further allow for the formation of a microemulsion between the unrefined petroleum, the basic agent, the co-solvent and the water. The co-solvent may decrease the interfacial viscosity and thus help promote emulsion formation and transform highly viscous macroemulsions to less viscous microemulsions. The co-solvent may further break the macroemulsions or prevent the formation of highly viscous macroemulsion entirely. Thus, as an interfacial viscosity reducing agent, the co-solvent having the formula (IA), (IB), (IC), (ID), (II), (IIA) or (IIB) provided herein, may act to facilitate the transport of the heavy crude oil emulsion composition by decreasing the viscosity and thereby increasing the flow of heavy crude oil emulsion. The co-solvents according to the embodiments provided herein may also be referred to herein as “co-solvents provided herein” or “the co-solvent of the present invention.” Any one or combination of a co-solvent of formulas (IA), (IB), (IC), (ID), (II), (IIA) or (IIB) is useful in the methods and compositions provided herein.

The total co-solvent concentration (i.e. the total amount of all co-solvent types within the heavy crude oil emulsion compositions provided herein) may be present in an amount from about 0.01% (w/v) to about 5% (w/v). Thus, in some embodiments, the co-solvent is present from about 0.01% (w/v) to about 5% (w/v). In some embodiments, the co-solvent is present from about 0.05% (w/v) to about 5% (w/v). In some embodiments, the co-solvent is present from about 0.1% (w/v) to about 5% (w/v). In some embodiments, the co-solvent is present from about 0.15% (w/v) to about 5% (w/v). In some embodiments, the co-solvent is present from about 0.20% (w/v) to about 5% (w/v). In some embodiments, the co-solvent is present from about 0.25% (w/v) to about 5% (w/v). In some embodiments, the co-solvent is present from about 0.30% (w/v) to about 5% (w/v). In some embodiments, the co-solvent is present from about 0.35% (w/v) to about 5% (w/v). In some embodiments, the co-solvent is present from about 0.40% (w/v) to about 5% (w/v). In some embodiments, the co-solvent is present from about 0.45% (w/v) to about 5% (w/v). In some embodiments, the co-solvent is present from about 0.50% (w/v) to about 5% (w/v). In some embodiments, the co-solvent is present from about 0.55% (w/v) to about 5% (w/v). In some embodiments, the co-solvent is present from about 0.60% (w/v) to about 5% (w/v). In some embodiments, the co-solvent is present from about 0.65% (w/v) to about 5% (w/v). In some embodiments, the co-solvent is present from about 0.70% (w/v) to about 5% (w/v). In some embodiments, the co-solvent is present from about 0.75% (w/v) to about 5% (w/v). In some embodiments, the co-solvent is present from about 0.80% (w/v) to about 5% (w/v). In some embodiments, the co-solvent is present from about 0.85% (w/v) to about 5% (w/v). In some embodiments, the co-solvent is present from about 0.90% (w/v) to about 5% (w/v). In some embodiments, the co-solvent is present from about 0.95% (w/v) to about 5% (w/v). In some embodiments, the co-solvent is present from about 1.00% (w/v) to about 5% (w/v). In some embodiments, the co-solvent is present from about 1.05% (w/v) to about 5% (w/v). In some embodiments, the co-solvent is present from about 1.10% (w/v) to about 5% (w/v). In some embodiments, the co-solvent is present from about 1.15% (w/v) to about 5% (w/v). In some embodiments, the co-solvent is present from about 1.20% (w/v) to about 5% (w/v). In some embodiments, the co-solvent is present from about 1.25% (w/v) to about 5% (w/v). In some embodiments, the co-solvent is present from about 1.30% (w/v) to about 5% (w/v). In some embodiments, the co-solvent is present from about 1.35% (w/v) to about 5% (w/v). In some embodiments, the co-solvent is present from about 1.40% (w/v) to about 5% (w/v). In some embodiments, the co-solvent is present from about 1.45% (w/v) to about 5% (w/v). In some embodiments, the co-solvent is present from about 1.50% (w/v) to about 5% (w/v).

In some embodiments, the co-solvent is present from about 1.55% (w/v) to about 5% (w/v). In some embodiments, the co-solvent is present from about 1.60% (w/v) to about 5% (w/v). In some embodiments, the co-solvent is present from about 1.65% (w/v) to about 5% (w/v). In some embodiments, the co-solvent is present from about 1.70% (w/v) to about 5% (w/v). In some embodiments, the co-solvent is present from about 1.75% (w/v) to about 5% (w/v). In some embodiments, the co-solvent is present from about 1.80% (w/v) to about 5% (w/v). In some embodiments, the co-solvent is present from about 1.85% (w/v) to about 5% (w/v). In some embodiments, the co-solvent is present from about 1.90% (w/v) to about 5% (w/v). In some embodiments, the co-solvent is present from about 1.95% (w/v) to about 5% (w/v). In some embodiments, the co-solvent is present from about 2.00% (w/v) to about 5% (w/v). In some embodiments, the co-solvent is present from about 2.05% (w/v) to about 5% (w/v). In some embodiments, the co-solvent is present from about 2.10% (w/v) to about 5% (w/v). In some embodiments, the co-solvent is present from about 2.15% (w/v) to about 5% (w/v). In some embodiments, the co-solvent is present from about 2.20% (w/v) to about 5% (w/v). In some embodiments, the co-solvent is present from about 2.25% (w/v) to about 5% (w/v). In some embodiments, the co-solvent is present from about 2.30% (w/v) to about 5% (w/v). In some embodiments, the co-solvent is present from about 2.35% (w/v) to about 5% (w/v). In some embodiments, the co-solvent is present from about 2.40% (w/v) to about 5% (w/v). In some embodiments, the co-solvent is present from about 2.45% (w/v) to about 5% (w/v). In some embodiments, the co-solvent is present from about 2.50% (w/v) to about 5% (w/v). In some embodiments, the co-solvent is present from about 3.00% (w/v) to about 5% (w/v). In some embodiments, the co-solvent is present from about 3.50% (w/v) to about 5% (w/v). In some embodiments, the co-solvent is present from about 4.00% (w/v) to about 5% (w/v). In some embodiments, the co-solvent is present from about 4.50% (w/v) to about 5% (w/v).

In some embodiments, the co-solvent is present from about 0.05% (w/v) to about 4% (w/v). In some embodiments, the co-solvent is present from about 0.1% (w/v) to about 4% (w/v). In some embodiments, the co-solvent is present from about 0.15% (w/v) to about 4% (w/v). In some embodiments, the co-solvent is present from about 0.20% (w/v) to about 4% (w/v). In some embodiments, the co-solvent is present from about 0.25% (w/v) to about 4% (w/v). In some embodiments, the co-solvent is present from about 0.30% (w/v) to about 4% (w/v). In some embodiments, the co-solvent is present from about 0.35% (w/v) to about 4% (w/v). In some embodiments, the co-solvent is present from about 0.40% (w/v) to about 4% (w/v). In some embodiments, the co-solvent is present from about 0.45% (w/v) to about 4% (w/v). In some embodiments, the co-solvent is present from about 0.50% (w/v) to about 4% (w/v). In some embodiments, the co-solvent is present from about 0.55% (w/v) to about 4% (w/v). In some embodiments, the co-solvent is present from about 0.60% (w/v) to about 4% (w/v). In some embodiments, the co-solvent is present from about 0.65% (w/v) to about 4% (w/v). In some embodiments, the co-solvent is present from about 0.70% (w/v) to about 4% (w/v). In some embodiments, the co-solvent is present from about 0.75% (w/v) to about 4% (w/v). In some embodiments, the co-solvent is present from about 0.80% (w/v) to about 4% (w/v). In some embodiments, the co-solvent is present from about 0.85% (w/v) to about 4% (w/v). In some embodiments, the co-solvent is present from about 0.90% (w/v) to about 4% (w/v). In some embodiments, the co-solvent is present from about 0.95% (w/v) to about 4% (w/v). In some embodiments, the co-solvent is present from about 1.00% (w/v) to about 4% (w/v). In some embodiments, the co-solvent is present from about 1.05% (w/v) to about 4% (w/v). In some embodiments, the co-solvent is present from about 1.10% (w/v) to about 4% (w/v). In some embodiments, the co-solvent is present from about 1.15% (w/v) to about 4% (w/v). In some embodiments, the co-solvent is present from about 1.20% (w/v) to about 4% (w/v). In some embodiments, the co-solvent is present from about 1.25% (w/v) to about 4% (w/v). In some embodiments, the co-solvent is present from about 1.30% (w/v) to about 4% (w/v). In some embodiments, the co-solvent is present from about 1.35% (w/v) to about 4% (w/v). In some embodiments, the co-solvent is present from about 1.40% (w/v) to about 4% (w/v). In some embodiments, the co-solvent is present from about 1.45% (w/v) to about 4% (w/v). In some embodiments, the co-solvent is present from about 1.50% (w/v) to about 4% (w/v).

In some embodiments, the co-solvent is present from about 1.55% (w/v) to about 4% (w/v). In some embodiments, the co-solvent is present from about 1.60% (w/v) to about 4% (w/v). In some embodiments, the co-solvent is present from about 1.65% (w/v) to about 4% (w/v). In some embodiments, the co-solvent is present from about 1.70% (w/v) to about 4% (w/v). In some embodiments, the co-solvent is present from about 1.75% (w/v) to about 4% (w/v). In some embodiments, the co-solvent is present from about 1.80% (w/v) to about 4% (w/v). In some embodiments, the co-solvent is present from about 1.85% (w/v) to about 4% (w/v). In some embodiments, the co-solvent is present from about 1.90% (w/v) to about 4% (w/v). In some embodiments, the co-solvent is present from about 1.95% (w/v) to about 4% (w/v). In some embodiments, the co-solvent is present from about 2.00% (w/v) to about 4% (w/v). In some embodiments, the co-solvent is present from about 2.05% (w/v) to about 4% (w/v). In some embodiments, the co-solvent is present from about 2.10% (w/v) to about 4% (w/v). In some embodiments, the co-solvent is present from about 2.15% (w/v) to about 4% (w/v). In some embodiments, the co-solvent is present from about 2.20% (w/v) to about 4% (w/v). In some embodiments, the co-solvent is present from about 2.25% (w/v) to about 4% (w/v). In some embodiments, the co-solvent is present from about 2.30% (w/v) to about 4% (w/v). In some embodiments, the co-solvent is present from about 2.35% (w/v) to about 4% (w/v). In some embodiments, the co-solvent is present from about 2.40% (w/v) to about 4% (w/v). In some embodiments, the co-solvent is present from about 2.45% (w/v) to about 4% (w/v). In some embodiments, the co-solvent is present from about 2.50% (w/v) to about 4% (w/v). In some embodiments, the co-solvent is present from about 3.00% (w/v) to about 4% (w/v). In some embodiments, the co-solvent is present from about 3.50% (w/v) to about 4% (w/v).

In some embodiments, the co-solvent is present from about 0.05% (w/v) to about 3% (w/v). In some embodiments, the co-solvent is present from about 0.1% (w/v) to about 3% (w/v). In some embodiments, the co-solvent is present from about 0.15% (w/v) to about 3% (w/v). In some embodiments, the co-solvent is present from about 0.20% (w/v) to about 3% (w/v). In some embodiments, the co-solvent is present from about 0.25% (w/v) to about 3% (w/v). In some embodiments, the co-solvent is present from about 0.30% (w/v) to about 3% (w/v). In some embodiments, the co-solvent is present from about 0.35% (w/v) to about 3% (w/v). In some embodiments, the co-solvent is present from about 0.40% (w/v) to about 3% (w/v). In some embodiments, the co-solvent is present from about 0.45% (w/v) to about 3% (w/v). In some embodiments, the co-solvent is present from about 0.50% (w/v) to about 3% (w/v). In some embodiments, the co-solvent is present from about 0.55% (w/v) to about 3% (w/v). In some embodiments, the co-solvent is present from about 0.60% (w/v) to about 3% (w/v). In some embodiments, the co-solvent is present from about 0.65% (w/v) to about 3% (w/v). In some embodiments, the co-solvent is present from about 0.70% (w/v) to about 3% (w/v). In some embodiments, the co-solvent is present from about 0.75% (w/v) to about 3% (w/v). In some embodiments, the co-solvent is present from about 0.80% (w/v) to about 3% (w/v). In some embodiments, the co-solvent is present from about 0.85% (w/v) to about 3% (w/v). In some embodiments, the co-solvent is present from about 0.90% (w/v) to about 3% (w/v). In some embodiments, the co-solvent is present from about 0.95% (w/v) to about 3% (w/v). In some embodiments, the co-solvent is present from about 1.00% (w/v) to about 3% (w/v). In some embodiments, the co-solvent is present from about 1.05% (w/v) to about 3% (w/v). In some embodiments, the co-solvent is present from about 1.10% (w/v) to about 3% (w/v). In some embodiments, the co-solvent is present from about 1.15% (w/v) to about 3% (w/v). In some embodiments, the co-solvent is present from about 1.20% (w/v) to about 3% (w/v). In some embodiments, the co-solvent is present from about 1.25% (w/v) to about 3% (w/v). In some embodiments, the co-solvent is present from about 1.30% (w/v) to about 3% (w/v). In some embodiments, the co-solvent is present from about 1.35% (w/v) to about 3% (w/v). In some embodiments, the co-solvent is present from about 1.40% (w/v) to about 3% (w/v). In some embodiments, the co-solvent is present from about 1.45% (w/v) to about 3% (w/v). In some embodiments, the co-solvent is present from about 1.50% (w/v) to about 3% (w/v).

In some embodiments, the co-solvent is present from about 1.55% (w/v) to about 3% (w/v). In some embodiments, the co-solvent is present from about 1.60% (w/v) to about 3% (w/v). In some embodiments, the co-solvent is present from about 1.65% (w/v) to about 3% (w/v). In some embodiments, the co-solvent is present from about 1.70% (w/v) to about 3% (w/v). In some embodiments, the co-solvent is present from about 1.75% (w/v) to about 3% (w/v). In some embodiments, the co-solvent is present from about 1.80% (w/v) to about 3% (w/v). In some embodiments, the co-solvent is present from about 1.85% (w/v) to about 3% (w/v). In some embodiments, the co-solvent is present from about 1.90% (w/v) to about 3% (w/v). In some embodiments, the co-solvent is present from about 1.95% (w/v) to about 3% (w/v). In some embodiments, the co-solvent is present from about 2.00% (w/v) to about 3% (w/v). In some embodiments, the co-solvent is present from about 2.05% (w/v) to about 3% (w/v). In some embodiments, the co-solvent is present from about 2.10% (w/v) to about 3% (w/v). In some embodiments, the co-solvent is present from about 2.15% (w/v) to about 3% (w/v). In some embodiments, the co-solvent is present from about 2.20% (w/v) to about 3% (w/v). In some embodiments, the co-solvent is present from about 2.25% (w/v) to about 3% (w/v). In some embodiments, the co-solvent is present from about 2.30% (w/v) to about 3% (w/v). In some embodiments, the co-solvent is present from about 2.35% (w/v) to about 3% (w/v). In some embodiments, the co-solvent is present from about 2.40% (w/v) to about 3% (w/v). In some embodiments, the co-solvent is present from about 2.45% (w/v) to about 3% (w/v). In some embodiments, the co-solvent is present from about 2.50% (w/v) to about 3% (w/v).

In one embodiment, the co-solvent is present at about 0.2% (w/v). In another embodiment, the co-solvent is present at about 0.32% (w/v). In another embodiment, the co-solvent is present at about 0.48% (w/v). In another embodiment, the co-solvent is present at about 0.60% (w/v). In another embodiment, the co-solvent is present at about 0.64% (w/v). In another embodiment, the co-solvent is present at about 0.48% (w/v). In another embodiment, the co-solvent is present at about 0.96% (w/v). In another embodiment, the co-solvent is present at about 0.8% (w/v). In another embodiment, the co-solvent is present at about 1.28% (w/v). In another embodiment, the co-solvent is present at about 1.5% (w/v). In another embodiment, the co-solvent is present at about 1.6% (w/v). In another embodiment, the co-solvent is present at about 2% (w/v). In another embodiment, the co-solvent is present at about 2.04% (w/v). In another embodiment, the co-solvent is present at about 2.5% (w/v). In another embodiment, the co-solvent is present at about 3.2% (w/v). In another embodiment, the co-solvent is present at about 3% (w/v). A person of ordinary skill in the art will immediately recognize that the above referenced values refer to weight percent of co-solvent per volume of emulsion (i.e. total volume of aqueous and non-aqueous solution).

The emulsion composition provided herein may further include a basic agent. In some embodiments, the basic agent is an alkali or an organic base. In some embodiments, the alkali is NaOH, KOH, LiOH, Na₂CO₃, NaHCO₃, Na-metaborate, Na silicate, Na orthosilicate or NH₄OH. In some embodiments, the organic base is a substituted or unsubstituted monoamine, a substituted or unsubstituted polyamine, or a substituted or unsubstituted amino carboxylate. In one embodiment, the alkali is NaOH. In another embodiment, the alkali is Na₂CO₃.

The basic agent may be present in the heavy crude oil emulsion composition from about 0.01% (w/v) to about 3% (w/v). Thus in some embodiments, the basic agent is present from about 0.01% (w/v) to about 3% (w/v). In some embodiments, the basic agent is present from about 0.02% (w/v) to about 3% (w/v). In some embodiments, the basic agent is present from about 0.03% (w/v) to about 3% (w/v). In some embodiments, the basic agent is present from about 0.04% (w/v) to about 3% (w/v). In some embodiments, the basic agent is present from about 0.05% (w/v) to about 3% (w/v). In some embodiments, the basic agent is present from about 0.06% (w/v) to about 3% (w/v). In some embodiments, the basic agent is present from about 0.08% (w/v) to about 3% (w/v). In some embodiments, the basic agent is present from about 0.09% (w/v) to about 3% (w/v). In some embodiments, the basic agent is present from about 0.1% (w/v) to about 3% (w/v). In some embodiments, the basic agent is present from about 0.2% (w/v) to about 3% (w/v). In some embodiments, the basic agent is present from about 0.3% (w/v) to about 3% (w/v). In some embodiments, the basic agent is present from about 0.4% (w/v) to about 3% (w/v). In some embodiments, the basic agent is present from about 0.5% (w/v) to about 3% (w/v). In some embodiments, the basic agent is present from about 0.6% (w/v) to about 3% (w/v). In some embodiments, the basic agent is present from about 0.7% (w/v) to about 3% (w/v). In some embodiments, the basic agent is present from about 0.8% (w/v) to about 3% (w/v). In some embodiments, the basic agent is present from about 0.9% (w/v) to about 3% (w/v). In some embodiments, the basic agent is present from about 1% (w/v) to about 3% (w/v). In some embodiments, the basic agent is present from about 1.5% (w/v) to about 3% (w/v). In some embodiments, the basic agent is present from about 2% (w/v) to about 3% (w/v). In some embodiments, the basic agent is present from about 2.5% (w/v) to about 3% (w/v).

In some embodiments, the basic agent is present from about 0.01% (w/v) to about 2.5% (w/v). In some embodiments, the basic agent is present from about 0.02% (w/v) to about 2.5% (w/v). In some embodiments, the basic agent is present from about 0.03% (w/v) to about 2.5% (w/v). In some embodiments, the basic agent is present from about 0.04% (w/v) to about 2.5% (w/v). In some embodiments, the basic agent is present from about 0.05% (w/v) to about 2.5% (w/v). In some embodiments, the basic agent is present from about 0.06% (w/v) to about 2.5% (w/v). In some embodiments, the basic agent is present from about 0.08% (w/v) to about 2.5% (w/v). In some embodiments, the basic agent is present from about 0.09% (w/v) to about 2.5% (w/v). In some embodiments, the basic agent is present from about 0.1% (w/v) to about 2.5% (w/v). In some embodiments, the basic agent is present from about 0.2% (w/v) to about 2.5% (w/v). In some embodiments, the basic agent is present from about 0.3% (w/v) to about 2.5% (w/v). In some embodiments, the basic agent is present from about 0.4% (w/v) to about 2.5% (w/v). In some embodiments, the basic agent is present from about 0.5% (w/v) to about 2.5% (w/v). In some embodiments, the basic agent is present from about 0.6% (w/v) to about 2.5% (w/v). In some embodiments, the basic agent is present from about 0.7% (w/v) to about 2.5% (w/v). In some embodiments, the basic agent is present from about 0.8% (w/v) to about 2.5% (w/v). In some embodiments, the basic agent is present from about 0.9% (w/v) to about 2.5% (w/v). In some embodiments, the basic agent is present from about 1% (w/v) to about 2.5% (w/v). In some embodiments, the basic agent is present from about 1.5% (w/v) to about 2.5% (w/v). In some embodiments, the basic agent is present from about 2% (w/v) to about 2.5% (w/v).

In some embodiments, the basic agent is present from about 0.01% (w/v) to about 2% (w/v). In some embodiments, the basic agent is present from about 0.02% (w/v) to about 2% (w/v). In some embodiments, the basic agent is present from about 0.03% (w/v) to about 2% (w/v). In some embodiments, the basic agent is present from about 0.04% (w/v) to about 2% (w/v). In some embodiments, the basic agent is present from about 0.05% (w/v) to about 2% (w/v). In some embodiments, the basic agent is present from about 0.06% (w/v) to about 2% (w/v). In some embodiments, the basic agent is present from about 0.08% (w/v) to about 2% (w/v). In some embodiments, the basic agent is present from about 0.09% (w/v) to about 2% (w/v). In some embodiments, the basic agent is present from about 0.10% (w/v) to about 2% (w/v). In some embodiments, the basic agent is present from about 0.2% (w/v) to about 2% (w/v). In some embodiments, the basic agent is present from about 0.3% (w/v) to about 2% (w/v). In some embodiments, the basic agent is present from about 0.4% (w/v) to about 2% (w/v). In some embodiments, the basic agent is present from about 0.5% (w/v) to about 2% (w/v). In some embodiments, the basic agent is present from about 0.6% (w/v) to about 2% (w/v). In some embodiments, the basic agent is present from about 0.7% (w/v) to about 2% (w/v). In some embodiments, the basic agent is present from about 0.8% (w/v) to about 2% (w/v). In some embodiments, the basic agent is present from about 0.9% (w/v) to about 2% (w/v). In some embodiments, the basic agent is present from about 1% (w/v) to about 2% (w/v). In some embodiments, the basic agent is present from about 1.5% (w/v) to about 2% (w/v).

In some embodiments, the basic agent is present from about 0.01% (w/v) to about 1.5% (w/v). In some embodiments, the basic agent is present from about 0.02% (w/v) to about 1.5% (w/v). In some embodiments, the basic agent is present from about 0.03% (w/v) to about 1.5% (w/v). In some embodiments, the basic agent is present from about 0.04% (w/v) to about 1.5% (w/v). In some embodiments, the basic agent is present from about 0.05% (w/v) to about 1.5% (w/v). In some embodiments, the basic agent is present from about 0.06% (w/v) to about 1.5% (w/v). In some embodiments, the basic agent is present from about 0.08% (w/v) to about 1.5% (w/v). In some embodiments, the basic agent is present from about 0.09% (w/v) to about 1.5% (w/v). In some embodiments, the basic agent is present from about 0.1% (w/v) to about 1.5% (w/v). In some embodiments, the basic agent is present from about 0.2% (w/v) to about 1.5% (w/v). In some embodiments, the basic agent is present from about 0.3% (w/v) to about 1.5% (w/v). In some embodiments, the basic agent is present from about 0.4% (w/v) to about 1.5% (w/v). In some embodiments, the basic agent is present from about 0.5% (w/v) to about 1.5% (w/v). In some embodiments, the basic agent is present from about 0.6% (w/v) to about 1.5% (w/v). In some embodiments, the basic agent is present from about 0.7% (w/v) to about 1.5% (w/v). In some embodiments, the basic agent is present from about 0.8% (w/v) to about 1.5% (w/v). In some embodiments, the basic agent is present from about 0.9% (w/v) to about 1.5% (w/v). In some embodiments, the basic agent is present from about 1% (w/v) to about 1.5% (w/v).

In some embodiments, the basic agent is present from about 0.01% (w/v) to about 1% (w/v). In some embodiments, the basic agent is present from about 0.02% (w/v) to about 1% (w/v). In some embodiments, the basic agent is present from about 0.03% (w/v) to about 1% (w/v). In some embodiments, the basic agent is present from about 0.04% (w/v) to about 1% (w/v). In some embodiments, the basic agent is present from about 0.05% (w/v) to about 1% (w/v). In some embodiments, the basic agent is present from about 0.06% (w/v) to about 1% (w/v). In some embodiments, the basic agent is present from about 0.08% (w/v) to about 1% (w/v). In some embodiments, the basic agent is present from about 0.09% (w/v) to about 1% (w/v). In some embodiments, the basic agent is present from about 0.10% (w/v) to about 1% (w/v). In some embodiments, the basic agent is present from about 0.2% (w/v) to about 1% (w/v). In some embodiments, the basic agent is present from about 0.3% (w/v) to about 1% (w/v). In some embodiments, the basic agent is present from about 0.4% (w/v) to about 1% (w/v). In some embodiments, the basic agent is present from about 0.5% (w/v) to about 1% (w/v). In some embodiments, the basic agent is present from about 0.6% (w/v) to about 1% (w/v). In some embodiments, the basic agent is present from about 0.7% (w/v) to about 1% (w/v). In some embodiments, the basic agent is present from about 0.8% (w/v) to about 1% (w/v). In some embodiments, the basic agent is present from about 0.9% (w/v) to about 1% (w/v).

In some embodiments, the basic agent is present from about 0.01% (w/v) to about 0.5% (w/v). In some embodiments, the basic agent is present from about 0.02% (w/v) to about 0.5% (w/v). In some embodiments, the basic agent is present from about 0.03% (w/v) to about 0.5% (w/v). In some embodiments, the basic agent is present from about 0.04% (w/v) to about 0.5% (w/v). In some embodiments, the basic agent is present from about 0.05% (w/v) to about 0.5% (w/v). In some embodiments, the basic agent is present from about 0.06% (w/v) to about 0.5% (w/v). In some embodiments, the basic agent is present from about 0.08% (w/v) to about 0.5% (w/v). In some embodiments, the basic agent is present from about 0.09% (w/v) to about 0.5% (w/v). In some embodiments, the basic agent is present from about 0.1% (w/v) to about 0.5% (w/v). In some embodiments, the basic agent is present from about 0.2% (w/v) to about 0.5% (w/v). In some embodiments, the basic agent is present from about 0.3% (w/v) to about 0.5% (w/v). In some embodiments, the basic agent is present from about 0.4% (w/v) to about 0.5% (w/v).

In one embodiment, the basic agent is present at about 0.03% (w/v). In one embodiment, the basic agent is present at about 0.05% (w/v). In one embodiment, the basic agent is present at about 0.10% (w/v). In one embodiment, the basic agent is present at about 0.2% (w/v). In one embodiment, the basic agent is present at about 0.3% (w/v). In one embodiment, the basic agent is present at about 0.5% (w/v). A person of ordinary skill in the art will immediately recognize that the above referenced values refer to weight percent of basic agent per volume of aqueous solution.

The heavy crude oil emulsion compositions provided herein may further include a salt to increase the salinity of the emulsion composition. Thus, in some embodiments, the heavy crude oil composition further includes a salt. In some embodiments, the salt is NaCl, Na₂SO₄, K₂SO₄ or KCl. In some embodiments, the salt is NaCl or KCl. The salt included in the heavy crude oil emulsion compositions provided herein may be present in an amount sufficient to increase the activity of the in situ generated soap, which is formed through the reaction of the carboxylic acids in the oil with the basic agent. The activity of the in situ generated soap refers to the surface activity of the in situ generated soap. In some embodiments, the salt is present in an amount sufficient to decrease the interfacial tension between the water and the heavy crude oil. In some embodiments, the salt is present in an amount sufficient to decrease the interfacial viscosity of the emulsion. In some embodiments, the salt is present in an amount sufficient to increase the solubility of the co-solvent or basic agent in the emulsion relative to the absence of the salt. In other words, in the presence of a sufficient amount of the salt, the solubility of the co-solvent or the basic agent in the heavy crude oil emulsion composition is higher than in the absence of the salt. The salt may be present in the heavy crude oil emulsion composition from about 0.01% to about 2% (w/v). Thus in some embodiments, the salt is present from about 0.01% to about 2% (w/v). In other embodiments, the salt is present from about 0.05% to about 2% (w/v). In other embodiments, the salt is present from about 0.1% to about 2% (w/v). In other embodiments, the salt is present from about 0.2% to about 2% (w/v). In other embodiments, the salt is present from about 0.3% to about 2% (w/v). In other embodiments, the salt is present from about 0.4% to about 2% (w/v). In other embodiments, the salt is present from about 0.5% to about 2% (w/v). In other embodiments, the salt is present from about 0.6% to about 2% (w/v). In other embodiments, the salt is present from about 0.7% to about 2% (w/v). In other embodiments, the salt is present from about 0.8% to about 2% (w/v). In other embodiments, the salt is present from about 0.9% to about 2% (w/v). In other embodiments, the salt is present from about 1.0% to about 2% (w/v). In other embodiments, the salt is present from about 1.2% to about 2% (w/v). In other embodiments, the salt is present from about 1.4% to about 2% (w/v). In other embodiments, the salt is present from about 1.6% to about 2% (w/v). In other embodiments, the salt is present from about 1.8% to about 2% (w/v).

In some embodiments, the salt is present from about 0.01% to about 1% (w/v). In other embodiments, the salt is present from about 0.05% to about 1% (w/v). In other embodiments, the salt is present from about 0.1% to about 1% (w/v). In other embodiments, the salt is present from about 0.2% to about 1% (w/v). In other embodiments, the salt is present from about 0.3% to about 1% (w/v). In other embodiments, the salt is present from about 0.4% to about 1% (w/v). In other embodiments, the salt is present from about 0.5% to about 1% (w/v). In other embodiments, the salt is present from about 0.6% to about 1% (w/v). In other embodiments, the salt is present from about 0.7% to about 1% (w/v). In other embodiments, the salt is present from about 0.8% to about 1% (w/v). In other embodiments, the salt is present from about 0.9% to about 1% (w/v). In one embodiment, the salt is present at an amount of about 0.1% (w/v). In one embodiment, the salt is present at an amount of about 1% (w/v). In one embodiment, the salt is present at an amount of about 0.2% (w/v). In another embodiment, the salt is present at an amount of about 0.8% (w/v). A person of ordinary skill in the art will immediately recognize that the above referenced values refer to weight percent of salt per volume of aqueous solution.

The heavy crude oil emulsion compositions provided herein may further include seawater, or fresh water from an aquifer, river or lake. In some embodiments, the water is hard brine. In other embodiments, the water is soft brine. In some embodiments, the brine is derived from the same reservoir as the heavy crude oil. In other embodiments, the brine is derived from a different reservoir than the heavy crude oil. In some embodiments, salt is removed from the brine.

The heavy crude oil emulsion compositions as provided herein are surprisingly stable at ambient temperature. A heavy crude oil emulsion composition is stable, when it retains the same features (e.g. viscosity) over an extended period of time (e.g. at least a week). As described above, the heavy crude oil emulsions provided herein have a viscosity that is at least 1,000-fold lower than the viscosity of the heavy crude oil. Surprisingly, the heavy crude oil emulsion compositions provided herein maintain a low viscosity, which is at least 1,000-fold lower than the viscosity of the heavy crude oil, at ambient temperature and for extended periods of time. An ambient temperature as provided herein may be a temperature of less than 80° C. Thus, in some embodiments, the ambient temperature is less than 80° C. In other embodiments, the ambient temperature is less than 60° C. In some embodiments, the ambient temperature is less than 40° C. In some embodiments, the emulsion is stable at ambient temperature for at least one hour. In some embodiments, the emulsion is stable at ambient temperature for at least a day. In some embodiments, the emulsion is stable at ambient temperature for at least a week. In other embodiments, the emulsion is stable at ambient temperature for at least a month.

As described above, the heavy crude oils included in the emulsion compositions provided herein are highly viscous. In some embodiments, the viscosity of the heavy crude oil is about 100,000 cP. In other embodiments, the viscosity of the heavy crude oil is about 200,000 cP. In some embodiments, the viscosity of the heavy crude oil is about 300,000 cP. In some embodiments, the viscosity of the heavy crude oil is about 1,000,000 cP. In some embodiments, the viscosity of the heavy crude oil is about 100,000 cP at ambient temperature. In other embodiments, the viscosity of the heavy crude oil is about 200,000 cP at ambient temperature. In some embodiments, the viscosity of the heavy crude oil is about 300,000 cP at ambient temperature. In some embodiments, the viscosity of the heavy crude oil is about 1,000,000 cP at ambient temperature.

Upon formation of a heavy crude oil emulsion according to the compositions and methods provided herein, the viscosity of the heavy crude oil emulsion decreases and remains low over extended periods of time and at ambient temperatures. In some embodiments, the viscosity of the emulsion is about a 10 times less than the viscosity of the heavy crude oil. In some embodiments, the viscosity of the emulsion is about a 100 times less than the viscosity of the heavy crude oil. In some embodiments, the viscosity of the emulsion is about a 1,000 times less than the viscosity of the heavy crude oil. In other embodiments, the viscosity of the emulsion is about a 10,000 times less than the viscosity of the heavy crude oil. In other embodiments, the viscosity of the emulsion is about a 100,000 times less than the viscosity of the heavy crude oil.

The formation of low viscosity heavy crude oil emulsions according to the compositions and methods provided herein allows for cost effective and efficient transport of a heavy crude oil. Thus, the emulsion compositions provided herein may be within a vessel. In some embodiments, the emulsion is within a vessel. In a further embodiment, the vessel is a pipeline. In another further embodiment, the vessel forms part of transportation vehicle. A transportation vehicle as provided herein refers to a vehicle appropriate for the transport of heavy crude oil emulsions. Examples of transportation vehicles are without limitation vehicles appropriate for ground transportation (e.g. trucks, trains), water transportation (e.g. sea or river) and air transportation. In some embodiments, the emulsion is transported in a pipeline. In some further embodiment, the method further includes after the transporting of step (iv) separating the heavy crude oil from the co-solvent, the basic agent and the water, thereby forming a recovered heavy crude oil. A person of ordinary skill in the art will immediately recognize that where the heavy crude oil is separated from the co-solvent, the basic agent and the water, the heavy crude oil emulsion is broken.

In one embodiment, the heavy crude oil emulsion includes a heavy crude oil at 60% (v/v); a co-solvent having the formula (IIA), wherein R¹ and R² are hydrogen and n is 16, present at 0.32% (w/v); a basic agent, wherein the basic agent is NaOH present at 0.2% (w/v); and a salt, wherein the salt is NaCl present 0.8% (w/v). In another embodiment, the heavy crude oil emulsion includes a heavy crude oil at 60% (v/v); a co-solvent having the formula (IIA), wherein R¹ and R² are hydrogen and n is 16, present at 0.64% (w/v); a basic agent, wherein the basic agent is NaOH present at 0.2% (w/v); and a salt, wherein the salt is NaCl present 0.8% (w/v). In one embodiment, the heavy crude oil emulsion includes a heavy crude oil at 60% (v/v); a co-solvent having the formula (IIA), wherein R¹ and R² are hydrogen and n is 16, present at 0.32% (w/v); a basic agent, wherein the basic agent is NaOH present at 0.1% (w/v); and a salt, wherein the salt is NaCl present 0.8% (w/v).

In one embodiment, the heavy crude oil emulsion includes a heavy crude oil at 40% (v/v); a co-solvent having the formula (IIA), wherein R¹ and R² are hydrogen and n is 16, present at 0.48% (w/v); a basic agent, wherein the basic agent is NaOH present at 0.2% (w/v); and a salt, wherein the salt is NaCl present 0.8% (w/v). In another embodiment, the heavy crude oil emulsion includes a heavy crude oil at 40% (v/v); a co-solvent having the formula (IIA), wherein R¹ and R² are hydrogen and n is 16, present at 0.96% (w/v); a basic agent, wherein the basic agent is NaOH present at 0.2% (w/v); and a salt, wherein the salt is NaCl present 0.8% (w/v). In one embodiment, the heavy crude oil emulsion includes a heavy crude oil at 40% (v/v); a co-solvent having the formula (IIA), wherein R¹ and R² are hydrogen and n is 16, present at 0.48% (w/v); a basic agent, wherein the basic agent is NaOH present at 0.1% (w/v); and a salt, wherein the salt is NaCl present 0.8% (w/v). In one embodiment, the heavy crude oil emulsion includes a heavy crude oil at 40% (v/v); a co-solvent having the formula (IIA), wherein R¹ and R² are hydrogen and n is 16, present at 0.48% (w/v); a basic agent, wherein the basic agent is NaOH present at 0.2% (w/v); and a salt, wherein the salt is NaCl present 0.1% (w/v). In one embodiment, the heavy crude oil emulsion includes a heavy crude oil at 40% (v/v); a co-solvent having the formula (IIA), wherein R¹ and R² are hydrogen and n is 16, present at 0.48% (w/v); a basic agent, wherein the basic agent is Na₂CO₃ present at 0.1% (w/v); and a salt, wherein the salt is NaCl present 0.1% (w/v). A person of ordinary skill in the art will immediately recognize that the above referenced values for the concentration of co-solvent refer to weight percent per volume of water and oil combined. The above referenced values for the concentration of other components (salt, basic agent) refer to weight percent per volume of aqueous solution.

In one embodiment, the heavy crude oil emulsion includes a heavy crude oil at 60% (v/v); a co-solvent having the formula (IIA), wherein R¹ and R² are hydrogen and n is 16, present at 1.6% (w/v); and a basic agent, wherein the basic agent is NaOH present at 0.2% (w/v). In one embodiment, the heavy crude oil emulsion includes a heavy crude oil at 20% (v/v); a co-solvent having the formula (IIA), wherein R¹ and R² are hydrogen and n is 16, present at 1.6% (w/v); a basic agent, wherein the basic agent is NaOH present at 0.2% (w/v); and a salt, wherein the salt is present at 0.8% (w/v). In one embodiment, the heavy crude oil emulsion includes a heavy crude oil at 40% (v/v); a co-solvent having the formula (IIA), wherein R¹ and R² are hydrogen and n is 16, present at 1.6% (w/v); a basic agent, wherein the basic agent is NaOH present at 0.2% (w/v); and a salt, wherein the salt is present at 0.8% (w/v). In one embodiment, the heavy crude oil emulsion includes a heavy crude oil at 60% (v/v); a co-solvent having the formula (IIA), wherein R¹ and R² are hydrogen and n is 16, present at 1.6% (w/v); a basic agent, wherein the basic agent is NaOH present at 0.2% (w/v); and a salt, wherein the salt is present at 0.8% (w/v). In one embodiment, the heavy crude oil emulsion includes a heavy crude oil at 80% (v/v); a co-solvent having the formula (IIA), wherein R¹ and R² are hydrogen and n is 16, present at 1.6% (w/v); a basic agent, wherein the basic agent is NaOH present at 0.2% (w/v); and a salt, wherein the salt is present at 0.8% (w/v). In one embodiment, the heavy crude oil emulsion includes a heavy crude oil at 95% (v/v); a co-solvent having the formula (IIA), wherein R¹ and R² are hydrogen and n is 16, present at 1.6% (w/v); a basic agent, wherein the basic agent is NaOH present at 0.2% (w/v); and a salt, wherein the salt is present at 0.8% (w/v). A person of ordinary skill in the art will immediately recognize that the above referenced values for the concentration of co-solvent refer to weight percent per volume of water and oil combined. The above referenced values for the concentration of other components (salt, basic agent) refer to weight percent per volume of aqueous solution.

In one embodiment, the heavy crude oil emulsion includes a heavy crude oil at 40% (v/v); a co-solvent having the formula (IIA), wherein R¹ and R² are hydrogen and n is 16, present at 0.8% (w/v); a basic agent, wherein the basic agent is NaOH present at 0.2% (w/v); and a salt, wherein the salt is present at 0.1% (w/v). In one embodiment, the heavy crude oil emulsion includes a heavy crude oil at 40% (v/v); a co-solvent having the formula (IIA), wherein R¹ and R² are hydrogen and n is 16, present at 0.8% (w/v); a basic agent, wherein the basic agent is NaOH present at 0.2% (w/v); and a salt, wherein the salt is present at 0.8% (w/v). In one embodiment, the heavy crude oil emulsion includes a heavy crude oil at 40% (v/v); a co-solvent having the formula (IIA), wherein R¹ and R² are hydrogen and n is 16, present at 3.2% (w/v); a basic agent, wherein the basic agent is NaOH present at 0.2% (w/v); and a salt, wherein the salt is present at 0.8% (w/v). A person of ordinary skill in the art will immediately recognize that the above referenced values for the concentration of co-solvent refer to weight percent per volume of water and oil combined. The above referenced values for the concentration of other components (salt, basic agent) refer to weight percent per volume of aqueous solution.

In one embodiment, the heavy crude oil emulsion includes a heavy crude oil at 80% (v/v); a co-solvent having the formula (IIA), wherein R¹ and R² are hydrogen and n is 16, present at 1.6% (w/v); a basic agent, wherein the basic agent is NaOH present at 0.2% (w/v); and a salt, wherein the salt is present at 0.8% (w/v). In one embodiment, the heavy crude oil emulsion includes a heavy crude oil at 80% (v/v); a co-solvent having the formula (IIA), wherein R¹ and R² are hydrogen and n is 16, present at 3% (w/v); a basic agent, wherein the basic agent is NaOH present at 0.2% (w/v); and a salt, wherein the salt is present at 0.8% (w/v). A person of ordinary skill in the art will immediately recognize that the above referenced values for the concentration of co-solvent refer to weight percent per volume of water and oil combined (i.e. emulsion). The above referenced values for the concentration of other components (salt, basic agent) refer to weight percent per volume of aqueous solution.

In one embodiment, the heavy crude oil emulsion includes a heavy crude oil at 60% (v/v); a co-solvent having the formula (IIA), wherein R¹ and R² are hydrogen and n is 2, present at 1.6% (w/v); a basic agent, wherein the basic agent is NaOH present at 0.2% (w/v); and a salt, wherein the salt is present at 0.8% (w/v). In one embodiment, the heavy crude oil emulsion includes a heavy crude oil at 60% (v/v); a co-solvent having the formula (IIA), wherein R¹ and R² are hydrogen and n is 8, present at 1.6% (w/v); a basic agent, wherein the basic agent is NaOH present at 0.2% (w/v); and a salt, wherein the salt is present at 0.8% (w/v). A person of ordinary skill in the art will immediately recognize that the above referenced values for the concentration of co-solvent refer to weight percent per volume of water and oil combined (i.e. emulsion). The above referenced values for the concentration of other components (salt, basic agent) refer to weight percent per volume of aqueous solution.

In one embodiment, the heavy crude oil emulsion includes a heavy crude oil at 40% (v/v); a co-solvent having the formula (IIA), wherein R¹ and R² are hydrogen and n is 16, present at 0.8% (w/v); a basic agent, wherein the basic agent is NaOH present at 0.1% (w/v); and a salt, wherein the salt is present at 0.8% (w/v). In one embodiment, the heavy crude oil emulsion includes a heavy crude oil at 40% (v/v); a co-solvent having the formula (IIA), wherein R¹ and R² are hydrogen and n is 16, present at 0.05% (w/v); a basic agent, wherein the basic agent is NaOH present at 0.1% (w/v); and a salt, wherein the salt is present at 0.8% (w/v).

In one embodiment, the heavy crude oil emulsion includes a heavy crude oil at 60% (v/v); a co-solvent having the formula (IIA), wherein R¹ and R² are hydrogen and n is 16, present at 0.8% (w/v); a basic agent, wherein the basic agent is NaOH present at 0.1% (w/v); and a salt, wherein the salt is present at 0.8% (w/v). In one embodiment, the heavy crude oil emulsion includes a heavy crude oil at 60% (v/v); a co-solvent having the formula (IIA), wherein R¹ and R² are hydrogen and n is 16, present at 0.8% (w/v); a basic agent, wherein the basic agent is NaOH present at 0.2% (w/v); and a salt, wherein the salt is present at 0.8% (w/v). A person of ordinary skill in the art will immediately recognize that the above referenced values for the concentration of co-solvent refer to weight percent per volume of water and oil combined (i.e. emulsion). The above referenced values for the concentration of other components (salt, basic agent) refer to weight percent per volume of aqueous solution.

In one embodiment, the heavy crude oil emulsion includes a heavy crude oil at 40% (v/v); a co-solvent having the formula (IIA), wherein R¹ and R² are hydrogen and n is 16, present at 0.8% (w/v); a basic agent, wherein the basic agent is Na₂CO₃ present at 0.1% (w/v); and a salt, wherein the salt is present at 0.1% (w/v). In one embodiment, the heavy crude oil emulsion includes a heavy crude oil at 40% (v/v); a co-solvent having the formula (IIA), wherein R¹ and R² are hydrogen and n is 16, present at 0.8% (w/v); a basic agent, wherein the basic agent is Na₂CO₃ present at 0.3% (w/v); and a salt, wherein the salt is present at 0.1% (w/v). In one embodiment, the heavy crude oil emulsion includes a heavy crude oil at 40% (v/v); a co-solvent having the formula (IIA), wherein R¹ and R² are hydrogen and n is 16, present at 0.8% (w/v); a basic agent, wherein the basic agent is Na₂CO₃ present at 0.5% (w/v); and a salt, wherein the salt is present at 0.1% (w/v). A person of ordinary skill in the art will immediately recognize that the above referenced values for the concentration of co-solvent refer to weight percent per volume of water and oil combined (i.e. emulsion). The above referenced values for the concentration of other components (salt, basic agent) refer to weight percent per volume of aqueous solution.

In one embodiment, the heavy crude oil emulsion includes a heavy crude oil at 60% (v/v); a co-solvent having the formula (IIA), wherein R¹ and R² are hydrogen and n is 16, present at 1.6% (w/v); a basic agent, wherein the basic agent is NaOH present at 0.2% (w/v); and a salt, wherein the salt is present at 0.1% (w/v). In one embodiment, the heavy crude oil emulsion includes a heavy crude oil at 60% (v/v); a co-solvent having the formula (IIA), wherein R¹ and R² are hydrogen and n is 16, present at 1.6% (w/v); a basic agent, wherein the basic agent is NaOH present at 0.2% (w/v); and a salt, wherein the salt is present at 1.6% (w/v). A person of ordinary skill in the art will immediately recognize that the above referenced values for the concentration of co-solvent refer to weight percent per volume of water and oil combined (i.e. emulsion). The above referenced values for the concentration of other components (salt, basic agent) refer to weight percent per volume of aqueous solution.

In another aspect, a heavy crude oil emulsion is provided. The heavy crude oil emulsion includes a first phase and a second phase, wherein the first phase includes an oil-immiscible compound and a basic agent and the second phase includes a heavy crude oil. An “oil-immiscible compound” as referred to herein is a compound that is not soluble in heavy crude oil. In one embodiment, the oil-immiscible compound is only lightly soluble in heavy crude oil. In embodiments, the oil-immiscible compound is a liquid. An oil-immiscible compound is capable of lubricating viscous crude oil and has a lower viscosity than the heavy crude oil. Upon formation of the heavy crude oil emulsion the oil-immiscible compound is within the first phase of the emulsion and is capable of facilitating the interaction of other components (e.g., co-solvent, basic agent, surfactant) with the crude oil. Thus, in some embodiments, the oil-immiscible compound forms part of the first phase of the emulsion. In embodiments, the oil immiscible compound is ethylene glycol, di-ethylene glycol, glycerol, propylene glycol, pentaerythritol, sorbitol or methanol. In embodiments, the oil-immiscible compound is ethylene glycol. In embodiments, the oil-immiscible compound is glycerol. A person of ordinary skill in the art will immediately recognize that the above referenced values for the concentration of co-solvent refer to weight percent per volume of water and oil combined (i.e. emulsion). The above referenced values for the concentration of other components (salt, basic agent) refer to weight percent per volume of aqueous solution.

In another aspect, a heavy crude oil emulsion is provided. The heavy crude oil emulsion includes a first phase and a second phase, wherein the first phase includes an oil-immiscible compound and a basic agent and the second phase includes a heavy crude oil. In embodiments, the heavy crude oil is bitumen. “Bitumen” as referred to herein is a heavy crude oil including asphaltene. Therefore, in embodiments, the emulsions provided herein are bituminous emulsions. Bituminous emulsions may be used for the formation of asphalt.

In embodiments, the oil-immiscible compound is present at about 5% (w/v). In embodiments, the oil-immiscible compound is present at about 10% (w/v). In embodiments, the oil-immiscible compound is present at about 15% (w/v). In embodiments, the oil-immiscible compound is present at about 20% (w/v). In embodiments, the oil-immiscible compound is present at about 25% (w/v). In embodiments, the oil-immiscible compound is present at about 30% (w/v). In embodiments, the oil-immiscible compound is present at about 35% (w/v). In embodiments, the oil-immiscible compound is present at about 40% (w/v). In embodiments, the oil-immiscible compound is present at about 45% (w/v). In embodiments, the oil-immiscible compound is present at about 50% (w/v). In embodiments, the oil-immiscible compound is present at about 55% (w/v). In embodiments, the oil-immiscible compound is present at about 60% (w/v).

In embodiments, the oil-immiscible compound is present from about 5% (w/v) to about 70% (w/v). In embodiments, the oil-immiscible compound is present from about 10% (w/v) to about 70% (w/v). In embodiments, the oil-immiscible compound is present from about 15% (w/v) to about 70% (w/v). In embodiments, the oil-immiscible compound is present from about 20% (w/v) to about 70% (w/v). In embodiments, the oil-immiscible compound is present from about 25% (w/v) to about 70% (w/v). In embodiments, the oil-immiscible compound is present from about 30% (w/v) to about 70% (w/v). In embodiments, the oil-immiscible compound is present from about 35% (w/v) to about 70% (w/v). In embodiments, the oil-immiscible compound is present from about 40% (w/v) to about 70% (w/v). In embodiments, the oil-immiscible compound is present from about 45% (w/v) to about 70% (w/v). In embodiments, the oil-immiscible compound is present from about 50% (w/v) to about 70% (w/v). In embodiments, the oil-immiscible compound is present from about 55% (w/v) to about 70% (w/v). In embodiments, the oil-immiscible compound is present from about 60% (w/v) to about 70% (w/v). In embodiments, the oil-immiscible compound is present from about 65% (w/v) to about 70% (w/v).

In embodiments, the first phase is about 5% oil-immiscible compound. In embodiments, the first phase is about 10% oil-immiscible compound. In embodiments, the first phase is about 15% oil-immiscible compound. In embodiments, the first phase is about 20% oil-immiscible compound. In embodiments, the first phase is about 25% oil-immiscible compound. In embodiments, the first phase is about 30% oil-immiscible compound. In embodiments, the first phase is about 35% oil-immiscible compound. In embodiments, the first phase is about 40% oil-immiscible compound. In embodiments, the first phase is about 45% oil-immiscible compound. In embodiments, the first phase is about 50% oil-immiscible compound. In embodiments, the first phase is about 55% oil-immiscible compound. In embodiments, the first phase is about 60% oil-immiscible compound. In embodiments, the first phase is about 65% oil-immiscible compound. In embodiments, the first phase is about 70% oil-immiscible compound. In embodiments, the first phase is about 75% oil-immiscible compound. In embodiments, the first phase is about 80% oil-immiscible compound. In embodiments, the first phase is about 85% oil-immiscible compound. In embodiments, the first phase is about 90% oil-immiscible compound. In embodiments, the first phase is about 95% oil-immiscible compound. In embodiments, the first phase is about 98% oil-immiscible compound. In embodiments, the first phase is about 99% oil-immiscible compound. A person of ordinary skill in the art will immediately recognize that the above referenced values refer to weight percent per volume of first phase of the emulsion.

In embodiments, the heavy crude oil emulsion includes an amphiphilic co-solvent. An “amphiphilic co-solvent” refers to a co-solvent as provided herein (e.g., a compound of formula (I), (IA), (IB), (IC), (ID), (II), (IIA) or (IIB)), including embodiments thereof, which is at least partially soluble in both the first phase including the oil-immiscible compound, and the second phase including the heavy crude oil. Therefore, the amphiphilic co-solvent is by definition chemically distinct from the oil-immiscible compound. In embodiments, the amphiphilic co-solvent forms part of the first phase. In embodiments, the amphiphilic co-solvent forms part of the second phase. In embodiments, the amphiphilic co-solvent forms part of the first phase and the second phase. In embodiments, the first phase includes a basic agent. Where the heavy crude oil emulsion includes an amphiphilic co-solvent any co-solvent useful in enhanced oil recovery and transport of heavy oil may be used. Examples of co-solvents useful for the emulsions and methods provided have been described above (e.g., a compound of formula (I), (IA), (IB), (IC), (ID), (II), (IIA) or (IIB)). An amphiphilic co-solvent as provided herein is present at the same concentrations described herein for co-solvents. Thus, in embodiments, the amphiphilic co-solvent is present at about 0.01% (w/v) to 5% (w/v). A person of ordinary skill in the art will immediately recognize that the above referenced values for the concentration of amphiphilic co-solvent refer to weight percent per volume of first and second phase (i.e., water and oil combined or emulsion).

In embodiments, the amphiphilic co-solvent has the formula

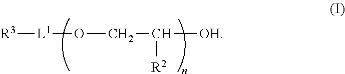

In formula (I) L¹ is unsubstituted C₁-C₆ alkylene, unsubstituted phenylene, unsubstituted cyclohexylene, unsubstituted cyclopentylene or methyl-substituted cyclopentylene. R² is independently hydrogen, methyl or ethyl. R³ is independently hydrogen or

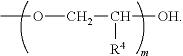

R⁴ is independently hydrogen, methyl or ethyl, n is an integer from 0 to 30, and m is an integer from 0 to 30. In some embodiments, the amphiphilic co-solvent has the formula

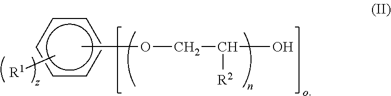

In formula (II) R¹ is independently hydrogen, unsubstituted C₁-C₆ alkyl or R⁵—OH, R² is independently hydrogen or unsubstituted C₁-C₂ alkyl, R⁵ is independently a bond or unsubstituted C₁-C₆ alkyl, n is an integer from 1 to 30, o is an integer from 1 to 5 and z is an integer from 1 to 5. In other embodiments, the amphiphilic co-solvent has the formula

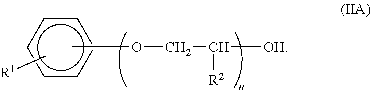

In formula (IIA) R¹ is independently hydrogen or unsubstituted C₁-C₆ alkyl. R² is independently hydrogen or unsubstituted C₁-C₂ alkyl and n is an integer from 1 to 30.

In embodiments, the heavy crude oil emulsion includes a surfactant. Where the heavy crude oil emulsion includes a surfactant, any surfactant useful in enhanced oil recovery and transport of heavy oil may be used. Examples of surfactants useful for the methods provided have been described above. In embodiments, the viscosity of the emulsion is lower than the viscosity of the heavy crude oil. In embodiments, the emulsion is formed at an ambient temperature.

In embodiments, the heavy crude oil emulsion does not include water. In embodiments, the heavy crude oil emulsion is anhydrous. In embodiments, the heavy crude oil emulsion includes traces of water. Where the heavy crude oil emulsion includes traces of water, the heavy crude oil emulsion includes less than about 0.01% (w/v) water. In embodiments, the heavy crude oil emulsion includes less than about 20% (w/v) water. In embodiments, the heavy crude oil emulsion includes less than about 15% (w/v) water. In embodiments, the heavy crude oil emulsion includes less than about 10% (w/v) water. In embodiments, the heavy crude oil emulsion includes less than about 5% (w/v) water. In embodiments, the heavy crude oil emulsion includes less than about 4% (w/v) water. In embodiments, the heavy crude oil emulsion includes less than about 3% (w/v) water. In embodiments, the heavy crude oil emulsion includes less than about 2% (w/v) water. In embodiments, the heavy crude oil emulsion includes less than about 1% (w/v) water. In embodiments, the heavy crude oil emulsion includes less than about 0.5% (w/v) water. In embodiments, the heavy crude oil emulsion includes less than about 0.4% (w/v) water. In embodiments, the heavy crude oil emulsion includes less than about 0.3% (w/v) water. In embodiments, the heavy crude oil emulsion includes less than about 0.2% (w/v) water. In embodiments, the heavy crude oil emulsion includes less than about 0.1% (w/v) water. In embodiments, the heavy crude oil emulsion includes less than about 0.01% (w/v) water. A person of ordinary skill in the art will immediately recognize that the above referenced values refer to weight percent per volume of emulsion.

In embodiments, the first phase further includes heavy crude oil water. “Heavy crude oil water” is water that is endogenous to the heavy crude oil and refers to the water found in the heavy crude oil as extracted. In embodiments, the amount of heavy crude oil water in a heavy crude oil is from about 0.01% (w/v) to about 95% w/v. In embodiments, the amount of heavy crude oil water in a heavy crude oil is from about 1% (w/v) to about 95% w/v. In embodiments, the amount of heavy crude oil water in a heavy crude oil is from about 5% (w/v) to about 95% w/v. In embodiments, the amount of heavy crude oil water in a heavy crude oil is from about 10% (w/v) to about 95% w/v. In embodiments, the amount of heavy crude oil water in a heavy crude oil is from about 15% (w/v) to about 95% w/v. In embodiments, the amount of heavy crude oil water in a heavy crude oil is from about 20% (w/v) to about 95% w/v. In embodiments, the amount of heavy crude oil water in a heavy crude oil is from about 30% (w/v) to about 95% w/v. In embodiments, the amount of heavy crude oil water in a heavy crude oil is from about 40% (w/v) to about 95% w/v. In embodiments, the amount of heavy crude oil water in a heavy crude oil is from about 50% (w/v) to about 95% w/v. In embodiments, the amount of heavy crude oil water in a heavy crude oil is from about 60% (w/v) to about 95% w/v. In embodiments, the amount of heavy crude oil water in a heavy crude oil is from about 70% (w/v) to about 95% w/v. In embodiments, the amount of heavy crude oil water in a heavy crude oil is from about 80% (w/v) to about 95% w/v. In embodiments, the amount of heavy crude oil water in a heavy crude oil is from about 90% (w/v) to about 95% w/v.

In embodiments, the heavy crude oil water is present at about 95% (w/v). In embodiments, the heavy crude oil water is present at about 90% (w/v). In embodiments, the heavy crude oil water is present at about 85% (w/v). In embodiments, the heavy crude oil water is present at about 80% (w/v). In embodiments, the heavy crude oil water is present at about 75% (w/v). In embodiments, the heavy crude oil water is present at about 60% (w/v). In embodiments, the heavy crude oil water is present at about 65% (w/v). In embodiments, the heavy crude oil water is present at about 50% (w/v). In embodiments, the heavy crude oil water is present at about 45% (w/v). In embodiments, the heavy crude oil water is present at about 40% (w/v). In embodiments, the heavy crude oil water is present at about 35% (w/v). In embodiments, the heavy crude oil water is present at about 30% (w/v). In embodiments, the heavy crude oil water is present at about 25% (w/v). In embodiments, the heavy crude oil water is present at about 20% (w/v). In embodiments, the heavy crude oil water is present at about 15% (w/v). In embodiments, the heavy crude oil water is present at about 10% (w/v). In embodiments, the heavy crude oil water is present at about 5% (w/v). In embodiments, the heavy crude oil water is present at about 4% (w/v). In embodiments, the heavy crude oil water is present at about 3% (w/v). In embodiments, the heavy crude oil water is present at about 2% (w/v). In embodiments, the heavy crude oil water is present at about 1% (w/v). In embodiments, the heavy crude oil water is present at about 0.5% (w/v). In embodiments, the heavy crude oil water is present at about 0.1% (w/v). In embodiments, the heavy crude oil water is present at about 0.01% (w/v). In embodiments, traces of the heavy crude oil water are present in the heavy crude oil emulsion. Where traces of the heavy crude oil water are present in the heavy crude oil emulsion, the heavy crude oil emulsion includes less than 0.01% (w/v) of heavy crude oil water. In embodiments, the heavy crude oil emulsion does not include heavy crude oil water. In embodiments, the amount of water in the heavy crude oil emulsion is equal to the amount of the heavy crude oil water. A person of ordinary skill in the art will immediately recognize that the above referenced values refer to weight percent per volume.

As described above the heavy crude oil emulsion as provided herein may include a heavy crude oil, an oil-immiscible compound, an amphiphilic co-solvent and a basic agent. In one embodiment, the heavy crude oil is oil A, present at about 80% (w/v), the oil-immiscible compound is ethylene glycol, present at about 15% (w/v), the amphiphilic compound is a compound having the formula (IIA), wherein R¹ and R² are hydrogen and n is 15, present at about 0.3% (w/v), and the basic agent is NaOH, present at about 0.04% (w/v). In a further embodiment, the heavy crude oil water is present at about 4.7% (w/v). In one embodiment, the heavy crude oil is oil A, present at about 80% (w/v), the oil-immiscible compound is ethylene glycol, present at about 19.7% (w/v), the amphiphilic compound is a compound having the formula (IIA), wherein R¹ and R² are hydrogen and n is 15, present at about 0.3% (w/v), and the basic agent is NaOH, present at about 0.04% (w/v). In a further embodiment, the heavy crude oil emulsion does not include water.

In another aspect, a non-aqueous composition including an oil-immiscible compound, an amphiphilic co-solvent and a basic agent is provided. In embodiments, the oil immiscible compound is ethylene glycol, di-ethylene glycol, glycerol, propylene glycol, pentaerythritol, sorbitol or methanol. In embodiments, the oil-immiscible compound is ethylene glycol. In embodiments, the oil-immiscible compound is glycerol. In embodiments, the non-aqueous composition includes a surfactant. Where the non-aqueous composition includes a surfactant any surfactant useful in enhanced oil recovery and transport of heavy oil may be used. Examples of surfactants useful for the methods provided have been described above. Where the non-aqueous composition includes an amphiphilic co-solvent any co-solvent useful in enhanced oil recovery and transport of heavy oil may be used. Examples of co-solvents useful for the emulsions and methods provided have been described above (e.g., a compound of formula (I), (IA), (IB), (IC), (ID), (II), (IIA) or (IIB)).

### III. Methods

In another aspect, a method of forming a heavy crude oil emulsion is provided. The method includes contacting a heavy crude oil extracted from an oil reservoir with a co-solvent (e.g. a compound of formula (I), (IA), (IB), (IC), (ID), (II), (IIA) or (IIB)), a basic agent (e.g. an alkali or an organic base) and water at an emulsion forming temperature, thereby forming a high temperature heavy crude oil emulsion. The high temperature heavy crude oil emulsion is allowed to cool to a transport temperature, thereby forming a heavy crude oil emulsion (e.g. an emulsion composition provided herein including embodiments thereof). In some embodiments, the heavy crude oil is present from about 10% to about 95% (w/v). As described above the heavy crude oil may be present at about 10%, 15%, 20%, 25%, 30%, 35%, 40%, 45%, 50%, 55%, 60%, 65%, 70%, 75%, 80%, 85% or 90% (w/v). In some embodiments, the heavy crude oil is present at about 20% (w/v). In other embodiments, the heavy crude oil is present at about 40% (w/v). In other embodiments, the heavy crude oil is present at about 60% (w/v). In other embodiments, the heavy crude oil is present at about 80% (w/v). A person of ordinary skill in the art will immediately recognize that the above referenced values refer to weight percent per volume of emulsion.

In some embodiments, the method further includes contacting the heavy crude oil extracted from an oil reservoir with a surfactant. For the methods provided herein any surfactant useful in enhanced oil recovery and transport of heavy oil may be used. Examples of surfactants useful for the methods provided have been described above.

In some embodiments, the method further includes contacting the heavy crude oil extracted from an oil reservoir with a catalyst. For the methods provided herein any catalyst useful in the process of oil refining may be used. Examples of catalysts useful for the methods provided have been described above.

The method provided herein includes contacting the heavy crude oil with a co-solvent, a basic agent and water. In some embodiments, the co-solvent is an alcohol, alkoxy alcohol, glycol ether, or glycol. In embodiments, the co-solvent is an alcohol, alkoxy alcohol or glycol ether. In other embodiments, the co-solvent has the formula

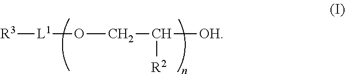

In formula (I) L¹ is unsubstituted C₁-C₆ alkylene, unsubstituted phenylene, unsubstituted cyclohexylene, unsubstituted cyclopentylene or methyl-substituted cyclopentylene. R² is independently hydrogen, methyl or ethyl. R³ is independently hydrogen or

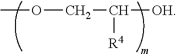

R⁴ is independently hydrogen, methyl or ethyl, n is an integer from 0 to 30, and m is an integer from 0 to 30. In some embodiments, the co-solvent has the formula

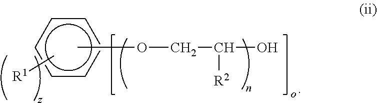

In formula (II) R¹ is independently hydrogen, unsubstituted C₁-C₆ alkyl or R⁵—OH, R² is independently hydrogen or unsubstituted C₁-C₂ alkyl, R⁵ is independently a bond or unsubstituted C₁-C₆ alkyl, n is an integer from 1 to 30, o is an integer from 1 to 5 and z is an integer from 1 to 5. In other embodiments, the co-solvent has the formula

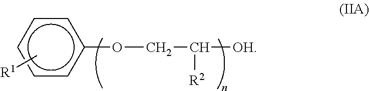

In formula (IIA) R¹ is independently hydrogen or unsubstituted C₁-C₆ alkyl. R² is independently hydrogen or unsubstituted C₁-C₂ alkyl and n is an integer from 1 to 30.

As described above the co-solvent may be present at an amount sufficient to decrease the viscosity of the heavy crude oil. In some embodiments, the co-solvent is present in an amount sufficient to decrease the viscosity of the heavy crude oil at least 1,000-fold. In other embodiments, the co-solvent is present from about 0.01% to about 5% (w/v).

The basic agent provided herein may be an alkali or an organic base. Thus, in some embodiments, the basic agent is an alkali or an organic base. In some embodiment, the alkali is NaOH, KOH, LiOH, Na₂CO₃, NaHCO₃, Na-metaborate, Na silicate, Na orthosilicate or NH₄OH. In other embodiments, the organic base is a substituted or unsubstituted monoamine, a substituted or unsubstituted polyamine, a substituted or unsubstituted amino carboxylate, a substituted or unsubstituted amino sulfonate, a substituted or unsubstituted amino sulfate, or a substituted or unsubstituted amino phosphate. The basic agent may be present at concentrations according to the embodiments provided herein (e.g. from about 0.01% to about 3% (w/v)). In some embodiment, the basic agent is present from about 0.01% to about 3% (w/v). In one embodiment, the basic agent is present at about 0.03% (w/v). In one embodiment, the basic agent is present at about 0.05% (w/v). In one embodiment, the basic agent is present at about 0.1% (w/v). In one embodiment, the basic agent is present at about 0.2% (w/v). In one embodiment, the basic agent is present at about 0.3% (w/v). In one embodiment, the basic agent is present at about 0.5% (w/v). A person of ordinary skill in the art will immediately recognize that the above referenced values refer to weight percent of basic agent per volume of aqueous solution.

The heavy crude oil may further be contacted with a salt to increase the salinity of the heavy crude oil emulsion. Thus, in some embodiments, the method further includes contacting the heavy crude oil with a salt. The salt included in the heavy crude oil emulsion provided herein may be present in an amount sufficient to increase the activity of the in situ generated soap, which is formed through the reaction of the carboxylic acids in the oil with the basic agent. The activity of the in situ generated soap refers to the surface activity of the in situ generated soap. In some embodiments, the salt is NaCl or KCl. In some embodiments, the salt is NaCl, Na₂SO₄, K₂SO₄ or KCl. In other embodiments, the salt is present in an amount sufficient to increase the solubility of the co-solvent or basic agent in the emulsion relative to the absence of the salt. In other embodiments, the salt is present in an amount sufficient to optimize the activity of the co-solvent or basic agent in the emulsion relative to the absence of the salt. The salt may be present from about 0.01% to about 5% (w/v). In some embodiments, the water is hard brine. In other embodiments, the water is soft brine.

Using the methods provided herein a heavy crude oil emulsion according to the compositions provided herein may be formed. As described above the heavy crude oil composition is stable (e.g. maintains a viscosity lower than the viscosity of the heavy crude oil) at ambient temperature and for extended time periods (e.g. hours, days, weeks, months). In some embodiments, the emulsion is stable at ambient temperature for at least an hour. In some embodiments, the emulsion is stable at ambient temperature for at least a day. In some embodiments, the emulsion is stable at ambient temperature for at least a week. In some embodiments, the heavy crude oil emulsion is stable at the transport temperature for at least an hour. In some embodiments, the heavy crude oil emulsion is stable at the transport temperature for at least a day. In some embodiments, the heavy crude oil emulsion is stable at the transport temperature for at least a week. In other embodiments, the heavy crude oil emulsion is stable at the transport temperature for at least a month.

The emulsion provided herein is formed at an emulsion forming temperature. The emulsion forming temperature may be equivalent to the temperature of the heavy crude oil in the reservoir. In some embodiments, the emulsion forming temperature is at least 60° C. In some embodiments, the emulsion forming temperature is at least 70° C. In other embodiments, the emulsion forming temperature is about 100° C. The heavy crude oil emulsion formed at the emulsion forming temperature is referred to herein as high temperature heavy crude oil emulsion. The high temperature heavy crude oil emulsion has a viscosity which is lower than the heavy crude oil viscosity and may be cooled to a transport temperature (e.g. ambient temperature). In some embodiments, the transport temperature is less than 60° C. In other embodiments, the transport temperature is about 25° C. Surprisingly, after the high temperature heavy crude oil emulsion is cooled to a transport temperature, the viscosity of the heavy crude oil emulsion remains lower than the viscosity of the heavy crude oil. In some embodiments, the heavy crude oil has a viscosity of at least 100,000 cP. In other embodiments, the heavy crude oil has a viscosity of at least 200,000 cP. In some embodiments, the heavy crude oil has a viscosity of at least 300,000 cP. In some embodiments, the heavy crude oil has a viscosity of at least 1,000,000 cP. In some embodiments, the extracted heavy crude oil has a viscosity of at least 100,000 cP at ambient temperature. In other embodiments, the extracted heavy crude oil has a viscosity of at least 200,000 cP at ambient temperature. In some embodiments, the extracted heavy crude oil has a viscosity of at least 300,000 cP at ambient temperature. In some embodiments, the extracted heavy crude oil has a viscosity of at least 1,000,000 cP at ambient temperature. The viscosity of the heavy crude oil emulsion may be 1,000 times lower than the viscosity of the heavy crude oil. In some embodiments, the viscosity of the heavy crude oil emulsion is 10,000 times lower than the viscosity of the heavy crude oil. In other embodiments, the viscosity of the heavy crude oil emulsion is 100,000 times lower than the viscosity of the heavy crude oil.

In another aspect, a method of optimizing a heavy crude oil emulsion is provided. The method includes contacting a plurality of heavy crude oil samples with an amount of a co-solvent, an amount of a basic agent, an amount of a salt and an amount of water at an emulsion forming temperature. The amount of a co-solvent, the amount of a basic agent, the amount of a salt and the amount of water is different for each of the plurality of heavy crude oil samples, thereby forming a plurality of different high temperature heavy crude oil emulsion samples. The plurality of different high temperature heavy crude oil emulsion samples is allowed to cool to an ambient temperature, thereby forming a plurality of different low temperature heavy crude oil emulsion samples. A low temperature heavy crude oil emulsion sample is identified amongst the plurality of different low temperature heavy crude oil emulsion samples having a viscosity at least 100 times lower than the viscosity of the heavy crude oil, thereby optimizing a heavy crude oil emulsion. In some embodiments, the amount of a co-solvent is from about 0.01% to about 5% (w/v). In other embodiments, the amount of a basic agent is from about 0.01% to about 3% (w/v). In some embodiments, the amount of water is from about 1% to about 90% (w/v). In some embodiments, the heavy crude oil emulsion is stable at a shear rate from about 0.01 to about 100,000 reciprocal seconds.

In some embodiments, the method further includes contacting the plurality of heavy crude oil samples with a surfactant. In other embodiments, the method further includes contacting the plurality of heavy crude oil samples with a catalyst.

In another aspect, a method of transporting a heavy crude oil is provided. The method includes extracting a heavy crude oil from an oil reservoir, thereby forming an extracted heavy crude oil. The extracted heavy crude oil is contacted with a co-solvent (e.g., a compound of formula (I), (IA), (IB), (IC), (ID), (II), (IIA) or (IIB)), a basic agent (e.g., an alkali or organic base) and water at an emulsion forming temperature, thereby forming a high temperature heavy crude oil emulsion. The high temperature heavy crude oil emulsion is allowed to cool to a transport temperature, thereby forming a heavy crude oil emulsion. The heavy crude oil emulsion is transported from a first location to a second location, thereby transporting the heavy crude oil. In some embodiments, the transporting of step (iv) is performed in a vessel. In other embodiments, the vessel is a pipeline. In some embodiments, the vessel forms part of a transportation vehicle. In other embodiments, the method further includes after the transporting of step (iv) separating the heavy crude oil from the co-solvent, the basic agent and the water, thereby forming a recovered heavy crude oil. In some embodiments, the method further includes contacting the extracted heavy crude oil with a surfactant. In another embodiment, the method further includes contacting the extracted heavy crude oil with a catalyst. In embodiments, the first location is a production well.

In another aspect, a method of transporting a heavy crude oil is provided. The method includes extracting a heavy crude oil from an oil reservoir, thereby forming an extracted heavy crude oil. The extracted heavy crude oil is contacted with a catalyst, thereby forming a catalytic heavy crude oil. The catalytic heavy crude oil is transported from a first location to a second location, thereby transporting the heavy crude oil. In some embodiments, the transporting of step (iv) is performed in a vessel. In other embodiments, the vessel is a pipeline. In some embodiments, the vessel forms part of a transportation vehicle. In other embodiments, the method further includes after the transporting of step (iv) separating the heavy crude oil from the catalyst, thereby forming a reformed oil.

In another aspect, a method of forming a heavy crude oil emulsion in a production well is provided. The method includes contacting an extracted heavy crude oil in a production well with a co-solvent (e.g., a compound of formula (I), (IA), (IB), (IC), (ID), (II), (IIA) or (IIB)), a basic agent (e.g., an alkali or organic base) and water, thereby forming a heavy crude oil emulsion in the production well. In some embodiments, the extracted heavy crude oil is present from about 10% to about 95% (w/v). The extracted heavy crude oil may be present at about 10%, 15%, 20%, 25%, 30%, 35%, 40%, 45%, 50%, 55%, 60%, 65%, 70%, 75%, 80%, 85% or 90% (w/v). In some embodiments, the extracted heavy crude oil is present at about 20% (w/v).

In other embodiments, the extracted heavy crude oil is present at about 40% (w/v). In other embodiments, the extracted heavy crude oil is present at about 60% (w/v). In other embodiments, the extracted heavy crude oil is present at about 80% (w/v). A person of ordinary skill in the art will immediately recognize that the above referenced values refer to weight percent of oil per volume of emulsion. The emulsion provided herein is formed at an emulsion forming temperature. The emulsion forming temperature may be equivalent to the temperature of the heavy crude oil in the reservoir. In some embodiments, the emulsion forming temperature is at least 60° C. In some embodiments, the emulsion forming temperature is at least 70° C. In other embodiments, the emulsion forming temperature is about 100° C.

In some embodiments, the heavy crude oil emulsion is stable at the transport temperature for at least an hour. In some embodiments, the heavy crude oil emulsion is stable at the transport temperature for at least a day. In some embodiments, the heavy crude oil emulsion is stable at the transport temperature for at least a week. In other embodiments, the heavy crude oil emulsion is stable at the transport temperature for at least a month.

In some embodiments, the extracted heavy crude oil has a viscosity of at least 100,000 cP. In other embodiments, the extracted heavy crude oil has a viscosity of at least 200,000 cP. In some embodiments, the extracted heavy crude oil has a viscosity of at least 300,000 cP. In some embodiments, the extracted heavy crude oil has a viscosity of at least 1,000,000 cP. In some embodiments, the extracted heavy crude oil has a viscosity of at least 100,000 cP at ambient temperature. In other embodiments, the extracted heavy crude oil has a viscosity of at least 200,000 cP at ambient temperature. In some embodiments, the extracted heavy crude oil has a viscosity of at least 300,000 cP at ambient temperature. In some embodiments, the extracted heavy crude oil has a viscosity of at least 1,000,000 cP at ambient temperature. The viscosity of the heavy crude oil emulsion may be 1,000 times lower than the viscosity of the extracted heavy crude oil. In some embodiments, the viscosity of the heavy crude oil emulsion is 10,000 times lower than the viscosity of the extracted heavy crude oil. In other embodiments, the viscosity of the heavy crude oil emulsion is 100,000 times lower than the viscosity of the extracted heavy crude oil.

In embodiments, the extracted heavy crude oil is contacted with a surfactant. In embodiments, the extracted heavy crude oil is contacted with a catalyst. In embodiments, the co-solvent is an alcohol, alkoxy alcohol, glycol ether, glycol or glycerol. In embodiments, the co-solvent is an alcohol, alkoxy alcohol or glycol ether. In embodiments, the co-solvent is a compound of formula (IA), (IB), (IC), (ID), (II), (IIA) or (IIB). In embodiments, the co-solvent is a co-solvent blend.

In another aspect, a method of transporting an extracted heavy crude oil from a production well is provided. The method includes contacting an extracted heavy crude oil in a production well with a co-solvent (e.g., a compound of formula (I), (IA), (IB), (IC), (ID), (II), (IIA) or (IIB)), a basic agent (e.g., an alkali or organic base) and water at an emulsion forming temperature, thereby forming a heavy crude oil emulsion in a production well. The heavy crude oil emulsion is transported from the production well to the surface, thereby transporting the extracted heavy crude oil from the production well. In embodiments, the extracted heavy crude oil is contacted with a surfactant. In embodiments, the transporting of step (ii) includes moving the heavy crude oil transport emulsion with a mechanical pump. In embodiments, the mechanical pump is an electrical submersible pump.

In another aspect, a method of forming a heavy crude oil emulsion is provided. The method includes contacting a heavy crude oil extracted from an oil reservoir with an oil-immiscible compound, an amphiphilic co-solvent and a basic agent at an emulsion forming temperature, thereby forming a high temperature heavy crude oil emulsion. The high temperature heavy crude oil emulsion is allowed to cool to a transport temperature, thereby forming a heavy crude oil emulsion. In embodiments, the oil immiscible compound is ethylene glycol, di-ethylene glycol, glycerol, propylene glycol, pentaerythritol, sorbitol or methanol.

In embodiments, the amount of water in the heavy crude oil emulsion is equal to the amount of water in the extracted heavy crude oil. In embodiments, the heavy crude oil emulsion does not include water. In embodiments, the heavy crude oil emulsion does not include exogenous water. Where the heavy crude oil emulsion does not include exogenous water, no water is added to the emulsion. In embodiments, the heavy crude oil emulsion is anhydrous. In embodiments, the extracted heavy crude oil emulsion includes heavy crude oil water. In embodiments, the amount of water in the heavy crude oil emulsion is equal to the amount of the heavy crude oil water. In embodiments, the heavy crude oil emulsion includes traces of water. Where the heavy crude oil emulsion includes traces of water, the heavy crude oil emulsion includes less than about 0.01% (w/v) water. In embodiments, the heavy crude oil emulsion includes less than about 20% (w/v) water. In embodiments, the heavy crude oil emulsion includes less than about 15% (w/v) water. In embodiments, the heavy crude oil emulsion includes less than about 10% (w/v) water. In embodiments, the heavy crude oil emulsion includes less than about 5% (w/v) water. In embodiments, the heavy crude oil emulsion includes less than about 4% (w/v) water. In embodiments, the heavy crude oil emulsion includes less than about 3% (w/v) water. In embodiments, the heavy crude oil emulsion includes less than about 2% (w/v) water. In embodiments, the heavy crude oil emulsion includes less than about 1% (w/v) water. In embodiments, the heavy crude oil emulsion includes less than about 0.5% (w/v) water. In embodiments, the heavy crude oil emulsion includes less than about 0.4% (w/v) water. In embodiments, the heavy crude oil emulsion includes less than about 0.3% (w/v) water. In embodiments, the heavy crude oil emulsion includes less than about 0.2% (w/v) water. In embodiments, the heavy crude oil emulsion includes less than about 0.1% (w/v) water. In embodiments, the heavy crude oil emulsion includes less than about 0.01% (w/v) water. In embodiments, the amount of the heavy crude oil water is less than about 5% (w/v). In embodiments, the amount of the heavy crude oil water is less than about 2% (w/v). In embodiments, the amount of the heavy crude oil water is less than about 1% (w/v). In embodiments, the amount of water in the heavy crude oil emulsion is equal to the amount of the heavy crude oil water. A person of ordinary skill in the art will immediately recognize that the above referenced values refer to weight percent per volume of emulsion. In embodiments, the extracted heavy crude oil is contacted with a surfactant.

In another aspect, a method of forming a heavy crude oil emulsion in a production well is provided. The method includes contacting an extracted heavy crude oil in a production well with an oil-immiscible compound, an amphiphilic co-solvent and a basic agent, thereby forming a heavy crude oil emulsion in a production well. In embodiments, the oil immiscible compound is ethylene glycol, di-ethylene glycol, glycerol, propylene glycol, pentaerythritol sorbitol or methanol. In embodiments, the oil immiscible compound is ethylene glycol, di-ethylene glycol, propylene glycol, dimethyl ether, pentaerythritol sorbitol, ethanol, isopropanol, secondary butanol or methanol.

In embodiments, the amount of water in the heavy crude oil emulsion is equal to the amount of water in the extracted heavy crude oil. In embodiments, the heavy crude oil emulsion does not include water. In embodiments, the heavy crude oil emulsion is anhydrous. In embodiments, the extracted heavy crude oil emulsion includes heavy crude oil water. In embodiments, the heavy crude oil emulsion includes traces of water. Where the heavy crude oil emulsion includes traces of water, the heavy crude oil emulsion includes less than about 0.01% (w/v) water. In embodiments, the heavy crude oil emulsion includes less than about 20% (w/v) water. In embodiments, the heavy crude oil emulsion includes less than about 15% (w/v) water. In embodiments, the heavy crude oil emulsion includes less than about 10% (w/v) water. In embodiments, the heavy crude oil emulsion includes less than about 5% (w/v) water. In embodiments, the heavy crude oil emulsion includes less than about 4% (w/v) water. In embodiments, the heavy crude oil emulsion includes less than about 3% (w/v) water. In embodiments, the heavy crude oil emulsion includes less than about 2% (w/v) water. In embodiments, the heavy crude oil emulsion includes less than about 1% (w/v) water. In embodiments, the heavy crude oil emulsion includes less than about 0.5% (w/v) water. In embodiments, the heavy crude oil emulsion includes less than about 0.4% (w/v) water. In embodiments, the heavy crude oil emulsion includes less than about 0.3% (w/v) water. In embodiments, the heavy crude oil emulsion includes less than about 0.2% (w/v) water. In embodiments, the heavy crude oil emulsion includes less than about 0.10% (w/v) water. In embodiments, the heavy crude oil emulsion includes less than about 0.01% (w/v) water. In embodiments, the amount of the heavy crude oil water is less than about 5% (w/v). In embodiments, the amount of the heavy crude oil water is less than about 2% (w/v). In embodiments, the amount of the heavy crude oil water is less than about 1% (w/v). In embodiments, the amount of water in the heavy crude oil emulsion is equal to the amount of the heavy crude oil water. A person of ordinary skill in the art will immediately recognize that the above referenced values refer to weight percent per volume of emulsion. In embodiments, the extracted heavy crude oil is contacted with a surfactant.

In another aspect, a method of transporting an extracted heavy crude oil from a production well is provided. The method includes contacting an extracted heavy crude oil in a production well with an oil-immiscible compound, an amphiphilic co-solvent and a basic agent at an emulsion forming temperature, thereby forming a heavy crude oil emulsion in a production well. The heavy crude oil emulsion is transported from the production well to the surface, thereby transporting the extracted heavy crude oil from the production well. In embodiments, the oil immiscible compound is ethylene glycol, di-ethylene glycol, glycerol, propylene glycol, pentaerythritol, sorbitol or methanol.

In embodiments, the amount of water in the heavy crude oil emulsion is equal to the amount of water in the extracted heavy crude oil. In embodiments, the heavy crude oil emulsion does not include water. In embodiments, the heavy crude oil emulsion does not include added water. In embodiments, the heavy crude oil emulsion is anhydrous. In embodiments, the extracted heavy crude oil emulsion includes heavy crude oil water. In embodiments, the heavy crude oil emulsion includes traces of water. Where the heavy crude oil emulsion includes traces of water, the heavy crude oil emulsion includes less than about 0.01% (w/v) water. In embodiments, the heavy crude oil emulsion includes less than about 20% (w/v) water. In embodiments, the heavy crude oil emulsion includes less than about 15% (w/v) water. In embodiments, the heavy crude oil emulsion includes less than about 10% (w/v) water. In embodiments, the heavy crude oil emulsion includes less than about 5% (w/v) water. In embodiments, the heavy crude oil emulsion includes less than about 4% (w/v) water. In embodiments, the heavy crude oil emulsion includes less than about 3% (w/v) water. In embodiments, the heavy crude oil emulsion includes less than about 2% (w/v) water. In embodiments, the heavy crude oil emulsion includes less than about 1% (w/v) water. In embodiments, the heavy crude oil emulsion includes less than about 0.5% (w/v) water. In embodiments, the heavy crude oil emulsion includes less than about 0.4% (w/v) water. In embodiments, the heavy crude oil emulsion includes less than about 0.3% (w/v) water. In embodiments, the heavy crude oil emulsion includes less than about 0.2% (w/v) water. In embodiments, the heavy crude oil emulsion includes less than about 0.1% (w/v) water. In embodiments, the heavy crude oil emulsion includes less than about 0.01% (w/v) water. In embodiments, the amount of the heavy crude oil water is less than about 5% (w/v). In embodiments, the amount of the heavy crude oil water is less than about 2% (w/v). In embodiments, the amount of the heavy crude oil water is less than about 1% (w/v). In embodiments, the amount of water in the heavy crude oil emulsion is equal to the amount of the heavy crude oil water. A person of ordinary skill in the art will immediately recognize that the above referenced values refer to weight percent per volume of emulsion. In embodiments, the extracted heavy crude oil is contacted with a surfactant.

### IV. Examples

Applicants have discovered the combination of certain co-solvents and alkali that are superior to the use of alkali only or surfactant only or diluent (solvent) only. Such co-solvents promote the formation of low-viscosity microemulsions as well as low viscosity macroemulsions. Furthermore, such a co-solvent(s) physically disrupts the asphaltenes (asphalt) in heavy crude oils by interacting with the resins that stabilize the asphaltenes. The phenolic co-solvents may directly interact with asphaltenes and cause disruptions of intermolecular aggregations. Remarkably low concentrations of certain tailored co-solvents are effective in this regard. Depending on the crude oil properties, it is sometimes necessary to first moderately increase the temperature of the mixture of co-solvent, alkali, brine and heavy oil to form the emulsions, but they do not need to be kept hot since the viscosity remains low when the temperature is lowered. In many cases, thermal methods such as steam are used to extract heavy oil from the reservoir so the oil will already be hot when it reaches the surface and thus no heating will be necessary. Surfactants and other combinations of chemicals could also be added to the mixture to promote the formation of the desired emulsions and to provide additional degrees of freedom to optimize the behavior. The present invention provides novel compositions and methods using tailored co-solvents to control the process and enable heavy crude oils to be transported long distances at low cost.

Phase Behavior Procedures

Phase Behavior Screening: Phase behavior studies have been used to characterize chemicals for EOR. There are many benefits in using phase behavior as a screening method. Phase Behavior studies are used to determine the effect of electrolytes, co-solvents, alkalis, surfactants, polymers, temperature, pressure and other variables on: (1) IFT reduction; (2) oil solubilization ratios, (3) microemulsion densities; (4) microemulsion viscosities; (5) coalescence times; (6) interfacial viscosity (7) optimal properties for recovering oil from cores and reservoirs.

Thermodynamically stable phases can form with oil, water and non-surfactant aqueous mixtures. In situ generated soaps form micellar structures at concentrations at or above the critical micelle concentration (CMC). The emulsion coalesces into a separate phase at the oil-water interface and is referred to as a microemulsion. A microemulsion is a surfactant-rich or soap-rich distinct phase consisting of in situ generated soaps, oil, water and co-solvent, alkali agent and other components. This phase is thermodynamically stable in the sense that it will return to the same phase volume at a given temperature. Some workers in the past have added additional requirements, but for the purposes of this engineering study, the only requirement will be that the microemulsion is a thermodynamically stable phase.

The phase transition is examined by keeping all variables fixed except for the scanning variable. The scan variable is changed over a series of pipettes and may include, but is not limited to, salinity, temperature, chemical (co-solvent, alcohol, electrolyte), oil, which is sometimes characterized by its equivalent alkane carbon number (EACN), and co-solvent structure, which is sometimes characterized by its hydrophilic-lipophilic balance (HLB). The phase transition was first characterized by Winsor (1954) into three regions: Type I—excess oleic phase, Type III—aqueous, microemulsion and oleic phases, and the Type II—excess aqueous phase. The phase transition boundaries and some common terminology are described as follows: Type I to III—lower critical salinity, Type III to II—upper critical salinity, oil solubilization ratio (Vo/Vs), water solubilization ratio (Vw/Vs), the solubilization value where the oil and water solubilization ratios are equal is called the Optimum Solubilization Ratio (σ*), and the electrolyte concentration where the optimum solubilization ratio occurs is referred to as the Optimal Salinity (S*). Since no surfactant is added, the only surfactant present is the in-situ generated soap. For the purpose of calculating a solubilization ratio, one can assume a value for soap level using TAN (total acid number) and an approximate molecular weight for the soap.

Determining Interfacial Tension

Efficient use of time and lab resources can lead to valuable results when conducting phase behavior scans. A correlation between oil and water solubilization ratios and interfacial tension was suggested by Healy and Reed (1976) and a theoretical relationship was later derived by Chun Huh (1979). Lowest oil-water IFT occurs at optimum solubilization ration as shown by the Chun Huh theory. This is equated to an interfacial tension through the Chun Huh equation, where IFT varies with the inverse square of the solubilization ratio:

$$γ = \frac{C}{{σ}^{2}} \qquad ( 1 )$$

For most crude oils and microemulsions, C=0.3 is a good approximation. Therefore, a quick and convenient way to estimate IFT is to measure phase behavior and use the Chun-Huh equation to calculate IFT. The IFT between microemulsions and water and/or oil can be very difficult and time consuming to measure and is subject to larger errors, so using the phase behavior approach to screen hundreds of combinations of co-solvents, electrolytes, oil, and so forth is not only simpler and faster, but avoids the measurement problems and errors associated with measuring IFT especially of combinations that show complex behavior (gels and so forth) and will be screened out anyway. Once a good formulation has been identified, then it is still a good idea to measure IFT.

Equipment

Phase behavior experiments are created with the following materials and equipment.

Mass Balance: Mass balances are used to measure chemicals for mixtures and determine initial saturation values of cores.

Water Deionizer: Deionized (DI) water is prepared for use with all the experimental solutions using a Nanopure™ filter system. This filter uses a recirculation pump and monitors the water resistivity to indicate when the ions have been removed. Water is passed through a 0.45 micron filter to eliminate undesired particles and microorganisms prior to use.

Borosilicate Pipettes: Standard 5 mL borosilicate pipettes with 0.1 mL markings are used to create phase behavior scans as well as run dilution experiments with aqueous solutions. Ends are sealed using a propane and oxygen flame.

Pipette Repeater: An Eppendorf Repeater Plus® instrument is used for most of the pipetting. This is a handheld dispenser calibrated to deliver between 25 microliter and 1 ml increments. Disposable tips are used to avoid contamination between stocks and allow for ease of operation and consistency.

Propane-oxygen Torch: A mixture of propane and oxygen gas is directed through a Bemz-O-Matic flame nozzle to create a hot flame about ½ inch long. This torch is used to flame-seal the glass pipettes used in phase behavior experiments.

Convection Ovens: Several convection ovens are used to incubate the phase behaviors and core flood experiments at the reservoir temperatures. The phase behavior pipettes are primarily kept in Blue M and Memmert ovens that are monitored with mercury thermometers and oven temperature gauges to ensure temperature fluctuations are kept at a minimal between recordings. A large custom built flow oven was used to house most of the core flood experiments and enabled fluid injection and collection to be done at reservoir temperature.

pH Meter: An ORION research model 701/digital ion analyzer with a pH electrode is used to measure the pH of most aqueous samples to obtain more accurate readings. This is calibrated with 4.0, 7.0 and 10.0 pH solutions. For rough measurements of pH, indicator papers are used with several drops of the sampled fluid.

Phase Behavior Calculations

The oil and water solubilization ratios are calculated from interface measurements taken from phase behavior pipettes. These interfaces are recorded over time as the mixtures approached equilibrium and the volume of any macroemulsions that initially formed decreased or disappeared.

Phase Behavior Methodology

The methods for creating, measuring and recording observations are described in this section. Scans are made using a variety of electrolyte mixtures described below. Oil is added to most aqueous non-surfactant solutions to see if a microemulsion formed, how long it took to form and equilibrate if it formed, what type of microemulsion formed and some of its properties such as viscosity. However, the behavior of aqueous mixtures without oil added is also important and is also done in some cases to determine if the aqueous solution is clear and stable over time, becomes cloudy or separated into more than one phase.

Preparation of samples. Phase behavior samples are made by first preparing non-surfactant aqueous stock solutions and combining them with brine stock solutions in order to observe the behavior of the mixtures over a range of salinities.

Solution Preparation. Non-surfactant aqueous stock solutions are based on active weight-percent co-solvent. The masses of co-solvent, alkali agent and de-ionized water (DI) are measured out on a balance and mixed in glass jars using magnetic stir bars. The order of addition is recorded on a mixing sheet along with actual masses added and the pH of the final solution. Brine solutions are created at the necessary weight percent concentrations for making the scans.

Co-solvent Stock. The chemicals being tested are first mixed in a concentrated stock solution that usually consisted of co-solvent, alkali agent and/or polymer along with de-ionized water. The quantity of chemical added is calculated based on activity and measured by weight percent of total solution. Initial experiments are at about 1-3% co-solvent so that the volume of the middle microemulsion phase would be large enough for accurate measurements assuming a solubilization ratio of at least 10 at optimum salinity.

Polymer Stock. Often these stocks were quite viscous and made pipetting difficult so they are diluted with de-ionized water accordingly to improve ease of handling. Mixtures with polymer are made only for those co-solvent formulations that showed good behavior and merited additional study for possible testing in core floods. Consequently, scans including polymer are limited since they are done only as a final evaluation of compatibility with the co-solvent.

Pipetting Procedure. Phase behavior components are added volumetrically into 5 ml pipettes using an Eppendorf Repeater Plus or similar pipetting instrument. Co-solvent, alkali agent and brine stocks are mixed with DI water into labeled pipettes and brought to temperature before agitation. Almost all of the phase behavior experiments are initially created with a water oil ratio (WOR) of 1:1, which involves mixing 2 ml of the aqueous phase with 2 ml of the evaluated crude oil or hydrocarbon, and different WOR experiments are mixed accordingly. The typical phase behavior scan consisted of 10-20 pipettes, each pipette being recognized as a data point in the series.

Order of Addition. Consideration must be given to the addition of the components since the concentrations are often several folds greater than the final concentration. Therefore, an order is established to prevent any adverse effects resulting from co-solvent, alkali agent or polymer coming into direct contact with the concentrated electrolytes. The desired sample compositions are made by combining the stocks in the following order: (1) Electrolyte stock(s); (2) De-ionized water; (3) co-solvent stock; (4) alkali agent stock; (5) Polymer stock; and (6) Crude oil or hydrocarbon.

Initial Observations. Once the components are added to the pipettes, sufficient time is allotted to allow all the fluid to drain down the sides. Then aqueous fluid levels are recorded before the addition of oil. These measurements are marked on record sheets. Levels and interfaces are recorded on these documents with comments over several days and additional sheets are printed as necessary.

Sealing and Mixing. The pipettes are blanketed with argon gas to prevent the ignition of any volatile gas present by the flame sealing procedure. The tubes are then sealed with the propane-oxygen torch to prevent loss of additional volatiles when placed in the oven. Pipettes are arranged on the racks to coincide with the change in the scan variable. Once the phase behavior scan is given sufficient time to reach reservoir temperature (15-30 minutes), the pipettes are inverted several times to provide adequate mixing. Tubes are observed for low tension upon mixing by looking at droplet size and how uniform the mixture appeared. Then the solutions are allowed to equilibrate over time and interface levels are recorded to determine equilibration time and co-solvent/alkali agent performance.

Measurements and Observations. Phase behavior experiments are allowed to equilibrate in an oven that is set to the reservoir temperature for the crude oil being tested. The fluid levels in the pipettes are recorded periodically and the trend in the phase behavior observed over time. Equilibrium behavior is assumed when fluid levels ceased to change within the margin of error for reading the samples.

Fluid Interfaces. The fluid interfaces are the most crucial element of phase behavior experiments. From them, the phase volumes are determined and the solubilization ratios are calculated. The top and bottom interfaces are recorded as the scan transitioned from an oil-in-water microemulsion to a water-in-oil microemulsion. Initial readings are taken one day after initial agitation and sometimes within hours of agitation if coalescence appeared to happen rapidly. Measurements are taken thereafter at increasing time intervals (for example, one day, four days, one week, two weeks, one month and so on) until equilibrium is reached or the experiment is deemed unessential or uninteresting for continued observation.

Emulsion Preparation Procedure

Prepare the stock solutions listed below:
a. Alkali Solution
b. Brine solution
c. Co-solvent Solution
   Pipet the required volume of the stock solutions to get a solution with specified alkali, brine, and co-solvent concentrations. Pipet the required volume of the aqueous solution into a 50 ml glass centrifuge tube. Pipet the required volume of the oil into the glass centrifuge tube. Cap the centrifuge tube and put the samples into a 100° C. oven. After the samples are at the oven temperature, mix (hand shake) the samples well every 20 minutes for 2 hour. The samples are mixed approx. 15-30 seconds. Take the samples out of the oven and let them reach room temperature (˜25° C.).

Viscosity Measurement Procedure

Briefly mix (hand shake) the emulsion sample and pour it into a 25 ml column. Using mineral oil and Teledyne ISCO 500D Series Syringe Pump, inject the mineral oil into the 25 ml column and displace the emulsion into the capillary tube at constant volumetric flow rates. The mixing between the mineral oil and emulsion seemed to be minimal. When a flow rate is inputted into the pump, check the pressure drop across the capillary tube every 30 seconds using a transducer that is connected to the LabView program. Wait until steady state pressure drop is observed and recorded the pressure drop. Change the flow rate and repeat to measure a range of shear rates by varying the flow rate.

Oil Sample C

Oil viscosity of oil C (Table 1) is approximately 60,000 cP at 10 s⁻¹ at 25° C. “Solid” as provided in the table below refers to a completely solid emulsion above the viscosity of the oil. “Excess Oil” refers to significant amount of oil that is not emulsified is present. “Heterogeneous” refers to no free oil is seen by eye. However, wide fluctuation in pressure drop is observed and is because of the presence of small oil blobs present in the emulsion.

Oil Sample A

Oil viscosity of oil A (Table 2) is approximately 320,000 cP at 10 s⁻¹ at 25° C. “Solid” as provided in the table below refers to a completely solid emulsion above the viscosity of the oil. “Excess Oil” refers to significant amount of oil that is not emulsified is present. “Heterogeneous” refers to no free oil is seen by eye. However, wide fluctuation in pressure drop is observed and is because of the presence of small oil blobs present in the emulsion.

Samples 2 and 3 (80 volume % oil), 4-12 (60% oil), 13-29 (40% oil), and 30-32 (20% oil) show the effect of fraction of oil in the emulsion on the viscosity. Samples 23, 28, and 29 have different co-solvent in the emulsion while everything else is kept constant. The group of samples shows that any of the co-solvents can be used to form low viscosity emulsion in case any of the co-solvents have any negative environmental concerns.

Samples 4, 13, 17, and 30 show that without the co-solvent, the emulsion is very viscous, probably more so than the pure oil. Samples 5, 14, and 18 show that addition of a small quantity of co-solvent prevents the formation of this very viscous emulsion and creates emulsions with very low viscosity. Samples 13 and 22 (only difference is the salinity) show that the salinity (% NaCl) is critical in the formation of low viscosity emulsion without co-solvent. It is possible to form low viscosity emulsion without the co-solvent as long as right conditions are met such as % oil, salinity, oil composition, and alkali concentration. However if the oil percentage is changed to 60% such as in sample 11, with or without the co-solvent, all the oil can't be emulsified.

Samples 4-6 and 11 show the importance of controlling the salinity to emulsify all the oil to form just one phase. Samples 13-16, 17-19, 20, and 21 show the significant impact alkali concentration can have on the viscosity of emulsion samples. Insufficient concentration of alkali as in sample 21 results in only partial emulsification of the oil. Higher alkali concentration may increase viscosity causing an optimization problem. Samples 25-27 were made using a different alkali and seem to show the same trend. Samples 9-12 show that it is not possible to emulsify 60% oil samples at 0.1% NaCl concentration while samples 5-7 show that increasing the NaCl concentration to 0.8% fixes the problem.

Experimental Procedure for Emulsion Breaking

Acids such as sulfuric acid, hydrochloric acid can be administered to the heavy oil emulsion to neutralize the alkali initially added to create the emulsion and to return the pH from neutral to acidic. The sample is shaken and allowed sufficient time to convert the soap produced from the heavy oil back to the acidic components of the oil. The temperature of the sample may be increased to improve the kinetics of the reaction. The sample is briefly centrifuged to separate the demulsified heavy oil from the aqueous solution (water, salt, co-solvent). In some embodiments, methods known in the art for breaking a heavy crude oil emulsion are used. Useful methods of breaking an emulsion are for example disclosed in Verzaro et al. (2002; SPE/Petroleum Society of CIM/CHOA 78959, page 1-5).

Upgrading of Heavy Oil During Transportation (Formation of Reformate)

Nanoparticle Catalyst Upgrading in Pipeline

Catalytic nanoparticles have larger surface area per mass for reactions to occur, thus requiring smaller quantity. The property of nanoparticles to prefer to be in the interface of oil and water is advantageous and necessary for the heavy oil upgrading because of the emulsion transportation method claimed. The catalytic nanoparticles are incorporated into the emulsion along with water, alkali, and co-solvent and transported through pipeline, ending with the separation of the catalyst for possible reuse. Several examples of catalysts and different reactions for upgrading oil (forming reformates) are listed below.

Hydrogenation and Hydrogenolysis Reactions Via H₂ Transfer

Catalysts used are platinum, palladium, rhodium or nickel.

Dehydrogenation and Metathesis Reactions Via Loss of H₂ from Oil Molecules

Catalysts used are chromium oxide, Pt/Al₂O₃, or zinc titanium oxide.

Hydrocracking Reaction

Breaking of carbon-carbon bond to create smaller oil molecules. Catalysts used are aluminum oxide or zeolites.

The residence time of the heavy oil in the pipeline is rather long (e.g. weeks, months) and the average speed of oil flow in pipelines is around 5 miles/hour. Depending on the length of the pipelines, the oil being transported in pipelines can spend days flowing from start to end. For example, the proposed Keystone Pipeline, if completed, would be around 2000 miles long. At 5 mile/hr, it will take 2-3 weeks for the oil to reach its destination. The residence time in the pipeline can be used to upgrade the heavy oil with the use of an appropriate catalyst. The advantages of this over the conventional means of upgrading heavy oil in refineries are (i) faster refining time to end products since a part of refining the heavy oil is done before it gets to the refineries; (ii) increase in refinery capacity since it will take shorter time to create the end products; (iii) less energy and cost necessary to upgrade heavy oil; (iv) lower temperature and less catalyst is used to do the upgrading since the available window for heavy oil upgrading reaction is days/weeks instead of hours; (v) and less equipment such as reactors and heat exchangers is required for heavy oil upgrading in the refinery since the pipeline serves as a reactor.

Preparation of Heavy Crude Oil in Water Emulsions

All emulsion samples were created using the following procedure unless otherwise noted. The aqueous solution consisting of deionized water (DI), NaCl, an alkali, and a co-solvent is mixed and prepared. All chemicals were measured and reported as weight percent of the aqueous solution. A mixture of the aqueous solution and a heavy crude oil was poured into a volumetric vial to create emulsions with different concentrations of oil (i.e., 20%, 40%, 60%, 80%, and 85%). The concentration of a crude oil in an emulsion is reported as a weight percent of the total volume of an emulsion (w/v). The mixture was sealed and placed in a 100° C. oven. After reaching the oven temperature, the sample was hand shaken for 30 seconds every 20 minutes for an hour. The sample was taken out of the oven and cooled down to a room temperature of 25° C.±2° C. overnight.

Measurement of Apparent Viscosity of Emulsions

Apparent viscosities of all emulsion samples were measured using a stainless steel tube viscometer unless otherwise stated.

Tube Viscometer

A stainless steel tubing was purchased from Swagelok with the specifications listed in Table 4. A Rosemount 3051 Pressure Transmitter was connected to the inlet and outlet of the tube viscometer using three way fittings to record the differential pressure along the tube. The transmitter was calibrated and the range of measurable differential pressure was set at 0-35 psi. 500D syringe pump from Teledyne Isco was used to displace samples through the tube viscometer at constant flow rates. Viscosity standards (50, 100, 200, and 500 mPa s) were injected through the tube to calibrate the tube viscometer based on differential pressure readings, flow rates, and tube dimensions. An effective inner diameter (ID) of 0.8176 mm was established after calibration. Emulsion samples are injected into the tube viscometer at constant flow rates. A range of flow rates were tested and pressure drops recorded to obtain apparent viscosity data at a range of apparent shear rates. When a flow rate was picked, the pressure drop across the tube was allowed to reach steady state and recorded before the next flow rate was tested. After a sample has been tested, the tube viscometer was cleaned thoroughly with the following procedure. Flush out the emulsion from the tube with 0.1% NaCl brine. Clean out any residual crude oil present in the tube with toluene. Displace all the toluene in the tube with 0.1% NaCl brine.

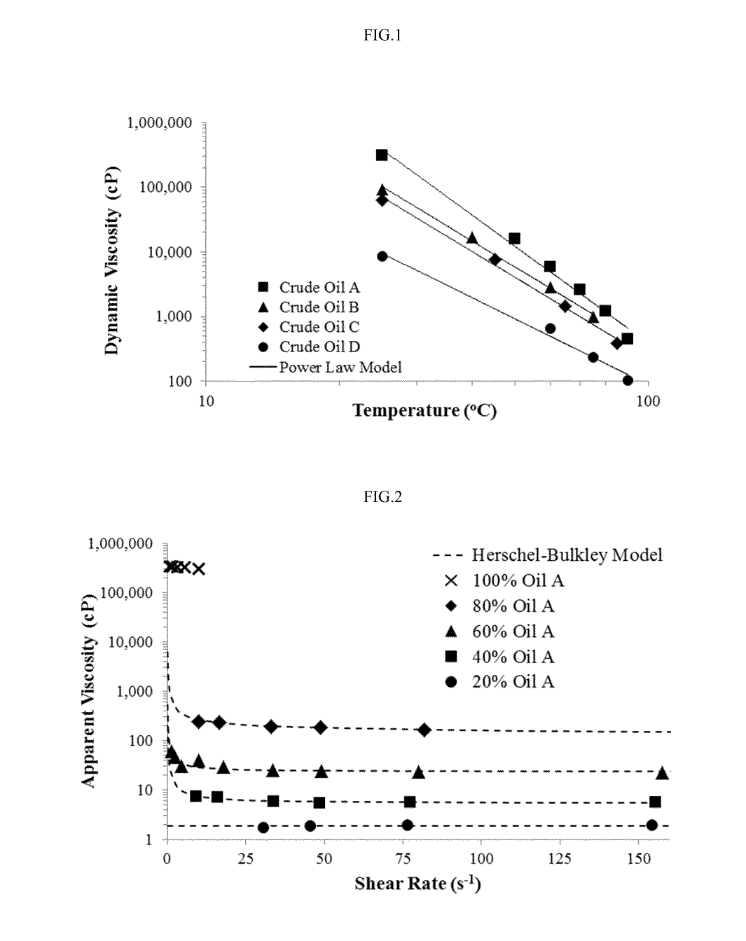

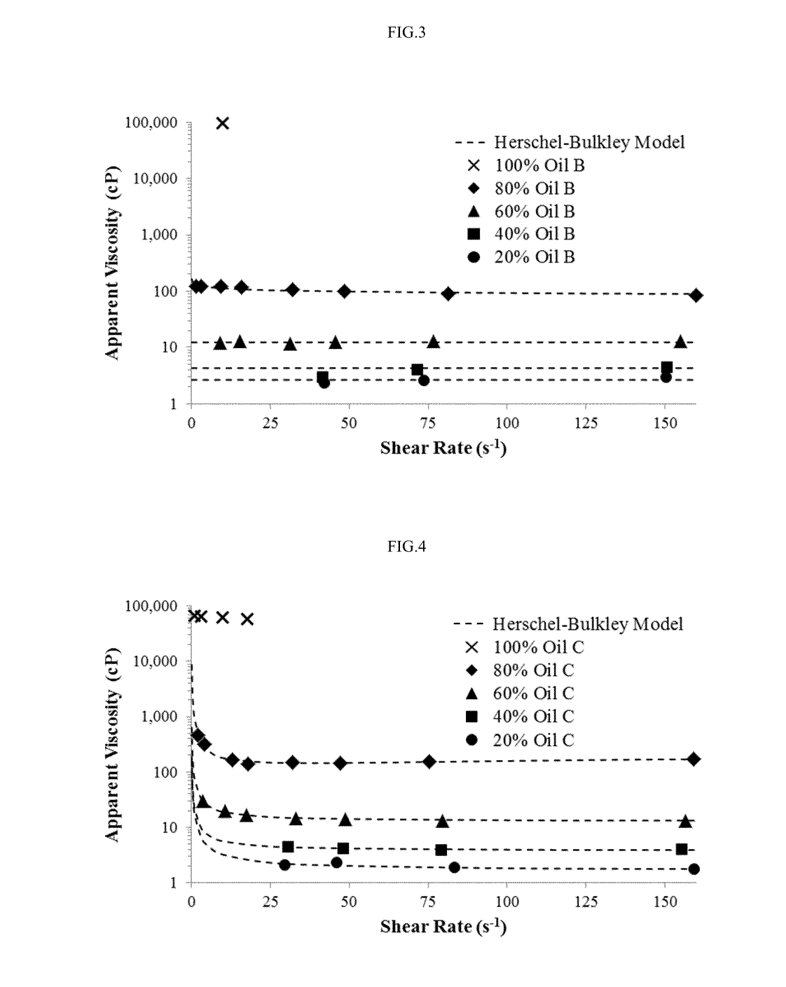

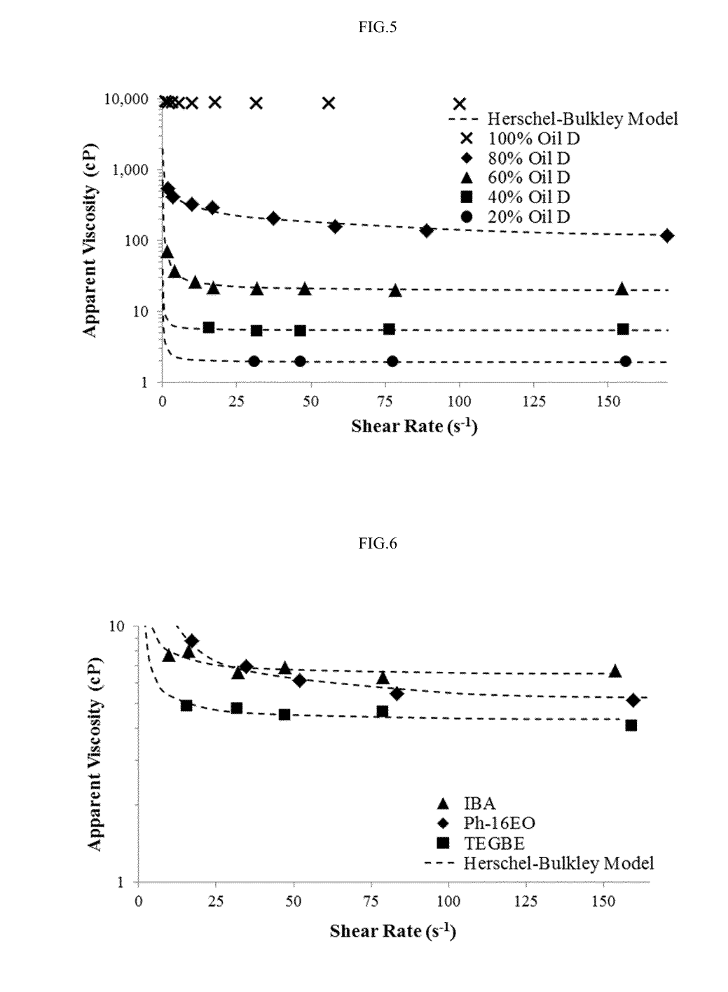

FIGS. 2-5 show the effects of heavy crude oil type, shear rate, oil content of the emulsion on the viscosity of the emulsions. The measurements of the emulsions were taken using a stainless steel tube viscometer with the dimensions mentioned in Table 4. All emulsions mentioned in FIGS. 2-5 were created with exactly the same aqueous solution consisting of 1.6% Phenol-16EO, 0.8% NaCl, and 0.2% NaOH dissolved in DI water. All chemical quantities are expressed in weight % and in respect to aqueous solution volume only. The crude oil and the aqueous solution are mixed and expressed in volume %. The general observations based on FIGS. 2-5 are that Applicants were successful in creating low viscosity emulsions with all four heavy crude oils tested. A viscosity range of 10,000 to 310,000 cP was measured using heavy crude oils from various parts of the world.

The Oil Content of the Emulsion has a Tremendous Effect on Emulsion Viscosity.

The emulsion viscosity seems to be relatively insensitive to crude oil viscosity. The higher the crude oil viscosity, the greater the viscosity reduction of the oil when emulsified. For example, 80% emulsions for all four oils show a viscosity range of 100-300 cP, while crude oil viscosities vary from 10,000-300,000 cP. Crude oil A shows ˜1500 times reduction in viscosity while crude oil D shows only 40-50 times reduction in viscosity when comparing 80% emulsions. All crude oils show evidence of yield stress except for crude oil B.

FIG. 6 shows that heavy crude oil emulsions can be prepared using a variety of co-solvents. The advantages of this is that multiple co-solvent options are available in case of co-solvent supply shortage, environmental concerns, or any other problems that might prevent the use of a specific type of co-solvent.

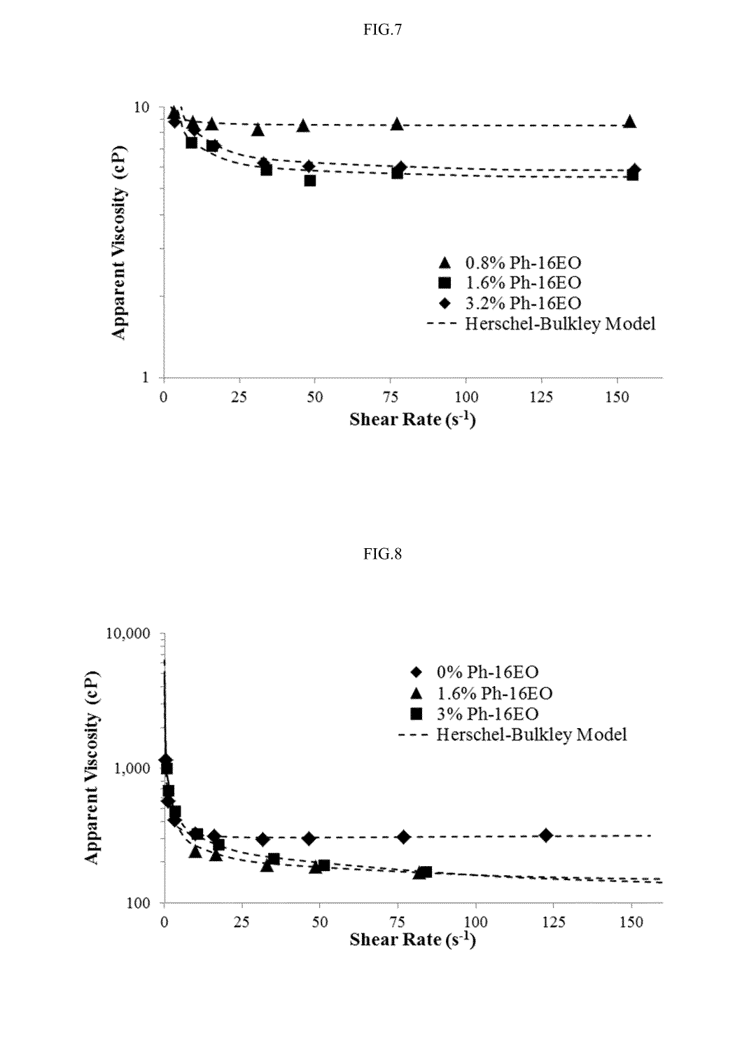

FIG. 7 shows the effect of co-solvent concentration vs. emulsion viscosity for 40% oil emulsions. With the formulation shown in FIG. 7, 0% Ph-16EO produced an emulsion with multiple phases, one of which has equal or greater viscosity than the crude oil. Increasing to 0.8% Ph-16EO, homogeneous, low viscosity emulsion was created. Further increase to 1.6% decreased the emulsion viscosity even further. However, when the co-solvent concentration was increased to 3.2%, there was minimal change in emulsion viscosity compared to 1.6%, suggesting there is a plateau where additional increase of co-solvent concentration doesn't equal further reduction in emulsion viscosity.

FIG. 8 with 80% oil emulsions shows similar results to FIG. 7. Low viscosity, homogeneous, and stable emulsion was prepared with 0% co-solvent. However, addition of 1.6% co-solvent lowered the emulsion viscosity further. A 3% co-solvent didn't produce any noticeable benefit compared to 1.6% co-solvent.

FIG. 9 shows the minimal change in emulsion viscosity when comparing Ph-8EO to Ph-16EO. Viscous, two phase emulsion was produce when Ph-2EO was used. FIG. 9 along with Table 5 show that by varying the number of EOs attached to the co-solvent, Applicants can create stable, homogeneous, low viscosity emulsions that can tolerate higher salinity brine compared to emulsions with no co-solvent. The advantages of the results shown in FIG. 9 and Table 5 are that the use of freshwater is not required. Cost of freshwater is high compared to brine.

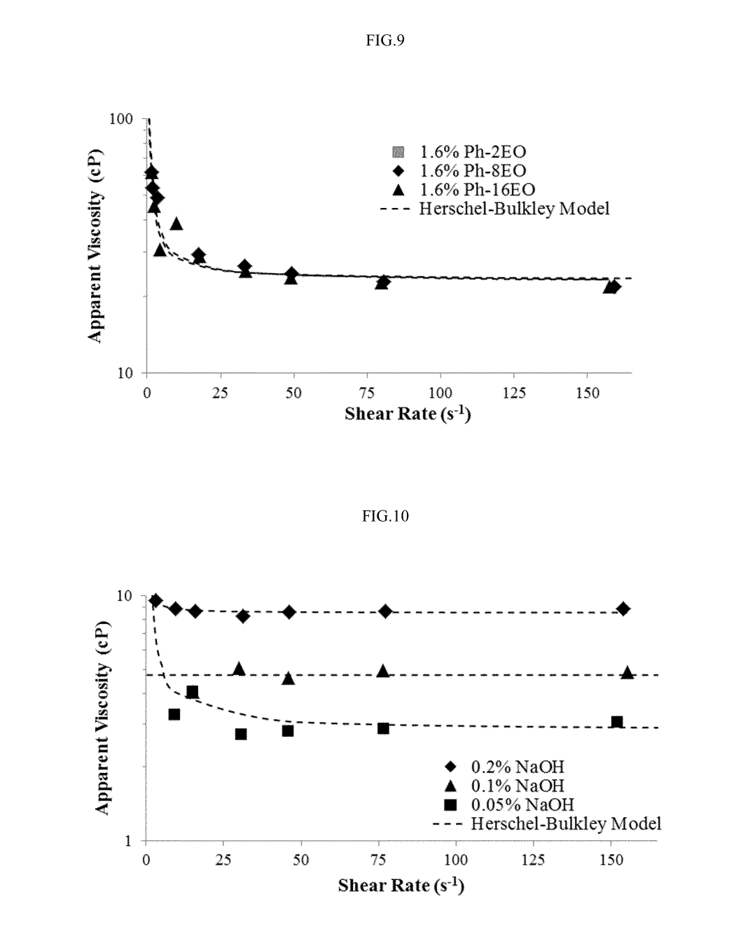

Prevention of reversal of O/W (low viscosity) emulsion to W/O (extremely high viscosity) emulsion if some high salinity brine is introduced by accident. Heavy crude oils are almost always produced as W/O emulsion and can contain some brine. For example, the heavy crude oil could have 1% water content where the water contains 10% NaCl (W/O emulsion). If 80% oil emulsion is created, that 1% water content in the crude oil will increase the salinity of the aqueous solution by ˜0.4% NaCl. That might be enough to reverse the low viscosity emulsion to extremely viscous emulsion. The present invention allows for incorporation of higher concentrations of alkali without catastrophic reversal to W/O emulsion. Why this is advantageous will be explained using the information in FIGS. 10-12.

FIGS. 10-11 show the effect of NaOH concentration on emulsion viscosity for 40% and 60% oil emulsions. Lower NaOH concentration produced emulsions with lower viscosity. However, for FIG. 10, 0.03% NaOH could not generate enough soap to emulsify all the oil. Large blobs of heavy oil were present. The same phenomenon was seen for FIG. 11 at 0.05% NaOH.

One of the disadvantages of using NaOH is that emulsion viscosity is extremely sensitive to NaOH concentration. The viscosity almost doubled from 0.05% to 0.1% NaOH and doubled from 0.1% to 0.2% NaOH in FIG. 10. If anything consumes OH-such as a small quantity of divalent ions and chemical reactions, the pH would change, some of the activated soap components (R—COO⁻) would revert back to its acidic form (R—COOH) and lose its surfactant properties. This would result in an unstable emulsion with pure viscous crude oil as one of the phases, possibly resulting in plugged pipelines. If larger quantity of NaOH is used to account for possible consumption of NaOH, the viscosity of the emulsion would increase significantly.

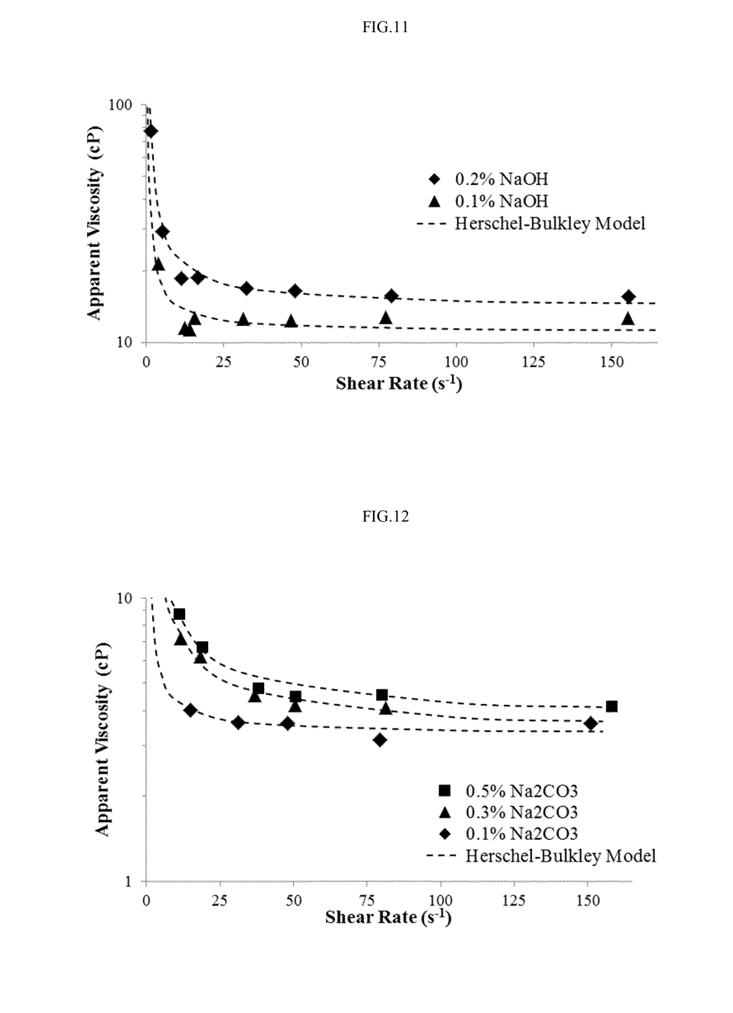

A solution to this problem is to use Na₂CO₃, which is a buffering agent. Na₂CO₃ would maintain the pH at 10.5-11 after a certain concentration of the alkali. This would allow for the use of higher concentration of Na₂CO₃ to account for possible OH⁻ consumption without greatly increasing the emulsion viscosity as seen in FIG. 12.

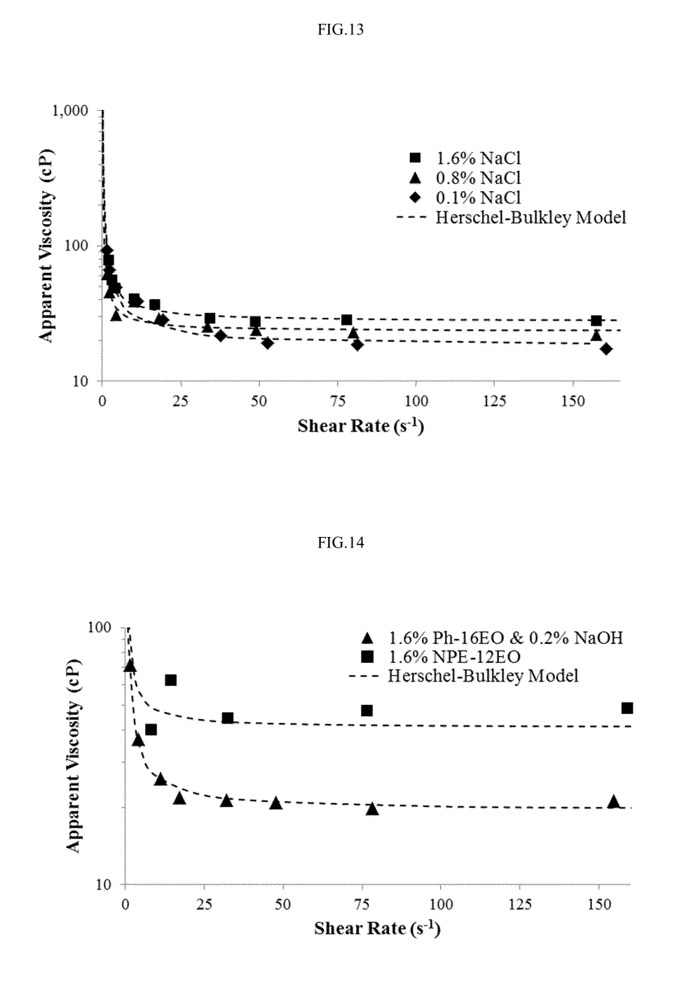

From Table 5, Applicants concluded that through the use of highly ethoxylated co-solvents, Applicants' emulsions can tolerate higher salinity than without co-solvents. FIG. 13 shows the effect of NaCl concentration on emulsion viscosity. Higher salinity increases the emulsion viscosity. However, the change in emulsion viscosity is not too significant to cause major problems.

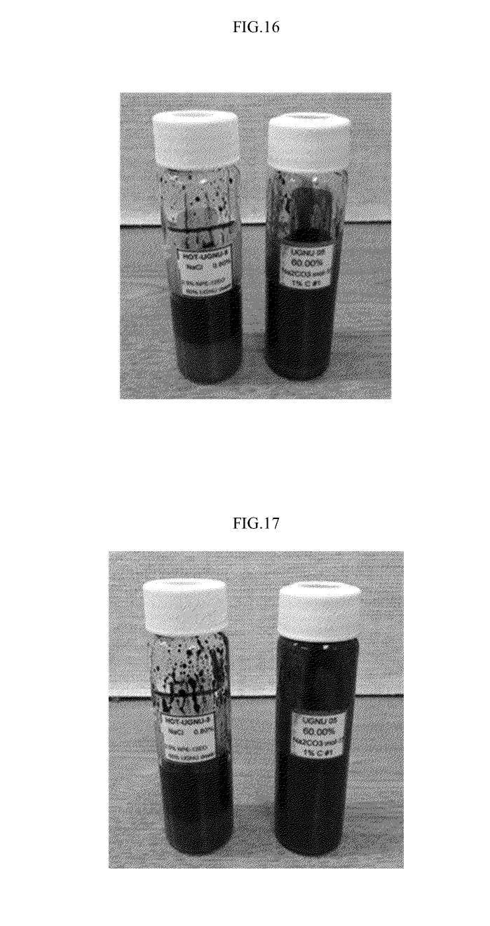

There are multiple methods of making O/W emulsion to decrease the oil viscosity. One of the common methods is using alkali to generate soap to emulsify the crude oil. Applicants have shown in FIGS. 7-8 that adding a small quantity of co-solvent improves the viscosity and there are other benefits (Table 5). Another method is using a non-ionic surfactant to create O/W emulsion. A common surfactant used in literature with widely available data is nonylphenol ethoxylate (NPE). When 60% & 80% oil D samples were emulsified with 2.5% NPE-12EO at 70° C. and hand-mixed, there was non-emulsified oil present which clogged the capillary tube. Thus, it was not possible to measure emulsion viscosity. The emulsions were also very unstable. In FIG. 16, stability of 60% oil D emulsions with different formulations are compared. The sample prepared using NPE clearly shows phase separation. After tilting the samples upside down once, the sample on the left did not flow suggesting the presence of pure viscous oil at the top. The sample on the right flow very easily and the small amount of creaming at the bottom vanished as shown in FIG. 17.

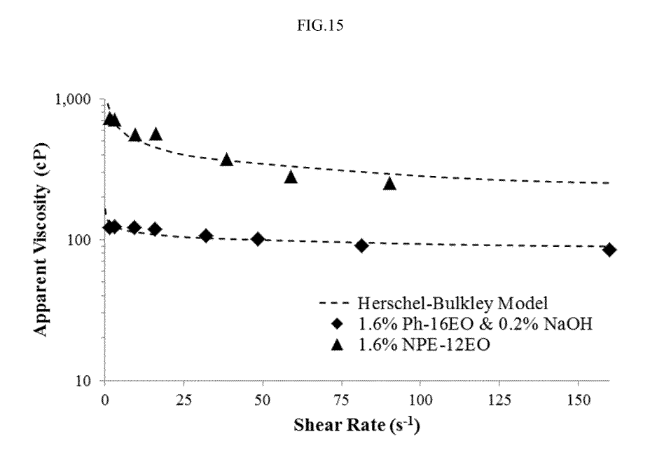

To create a more homogeneous emulsion with NPE, 60% oil D emulsion was prepared with 1.6% NPE-12EO with one change in the procedure. The emulsion was mixed in a blender at low setting for 5 minutes at 60 C after the emulsion was hand mixed in 70° C. oven every 20 minutes for 1.5 hrs. Using the blender, we were able to break up the non-emulsified oil blobs and capillary tube viscosity measurements were possible. FIG. 14 shows the comparison of 60% oil D emulsions prepared with NPE-12EO and alkali & Ph-16EO. FIG. 15 shows comparison of 80% oil B emulsions created with two different formulations. The NPE emulsion was only hand mixed and not blended. While pressure readings could be recorded, the NPE emulsion also plugged the tube viscometer several times and had to be unplugged. FIGS. 14-15 and FIGS. 16 and 17 show that Applicants' emulsions are more stable, homogeneous, and less viscous compared to emulsion made using NPE-12EO.

Summary of Discoveries

Oil concentration increase equals higher emulsion viscosity equals higher stability. Heavy oil viscosity seems to have very little effect on emulsion viscosity above 10,000 cp oil that was tested. Therefore, Applicants' emulsion making process has bigger effect when heavy oil is very viscous. The composition of crude oil, especially the surface active components that are activated with change in pH, seems to have a large effect on emulsion viscosity. The composition of soap is different for every crude oil. The salinity of water increases the emulsion viscosity as salinity increases (FIG. 13). The effect is minor compared to pH change or oil %. Alkali has two effects: Increasing the salinity and increasing pH. Increasing the pH results in more soap and higher viscosity and higher stability (FIG. 10-12). Na₂CO₃ buffers at lower pH compared to NaOH and therefore lower emulsion viscosity is obtained from Na₂CO₃ (FIGS. 10 & 12). The type of co-solvent used is important as illustrated in FIG. 6. Increasing co-solvent concentration decreases the emulsion viscosity up to a concentration and viscosity plateaus with increasing concentration (FIGS. 7-8). The number of EO's doesn't see to affect the emulsion viscosity as long as O/W emulsion is created (FIG. 9). The higher the number of EO, the more hydrophilic the soap/solvent system becomes and the higher the salinity tolerance (Table 5). Number of EO should depend on the salinity of available water supply. Shear rate depends on pipeline diameter and flow rate. Generally, higher shear rate equals lower emulsion viscosity. The temperature of transport has significant effect on the emulsion viscosity.

Comparison of heavy oil emulsion preparation methods have been made between Applicants' alkali/co-solvent method to established surfactant method (NPE). Applicants' results show significant advantages of the co-solvent method compared to surfactant method (NPE). Example: emulsion viscosity (FIG. 14-15) and emulsion stability (FIGS. 16 and 17). Applicants have increased the emulsion viscosity data from 2 to 4 different heavy oils (9,000-310,000 cP) demonstrating the versatility of the process (Table 3). Applicants have shown that salinity requirement of the brine could be matched by optimizing the hydrophilicity (xEO) of the co-solvent. (Table 5 and FIG. 9). Applicants have shown the effect of salinity on the emulsion viscosity based on Applicants' ability to design emulsions that can tolerate higher salinity. (FIG. 13).

### V. References

1. Verzaro F. et al. Heavy Acidic Oil Transportation by Emulsion in Water, SPE, 2002
2. Hasan S. W. et al. Heavy crude oil viscosity reduction and rheology for pipeline transportation. Fuel. 2010.
3. Wylde, J. J. Heavy Oil Transportation: Advances in Water-Continuous Emulsion Methods. 2012. World Heavy Oil Congress (Aberdeen, Scotland).

### VI. Tables

TABLE 1
Apparent Viscosity vs. Shear Rate of Heavy Oil Emulsion
of Oil Sample C.

| | | | | | Total | | Appar- |
|---|---|---|---|---|---|---|---|
| | Oil | | Aqueous | Aqueous | Co- | | ent |
| | Conc. | | Alkali | NaCl | Solvent | Shear | Viscos- |
| Sam- | (% | | Conc. | Conc. | Conc. | Rate | ity |
| ple | Vol.) | Co-Solvent | (wt %) | (wt %) | (%) | (s\hat{ }-1) | (cP) |
| 2 | 40% | Phenol- | 0.1 NaOH | 0.8 | 0.48 | 3.7 | 7.3 |
| | | 16EO | | | | 11 | 5.7 |
| | | | | | | 36.5 | 4.3 |
| 3 | | | | | 0.96 | 3.7 | 8.1 |
| | | | | | | 11 | 6.1 |
| | | | | | | 36.5 | 4.4 |
| 4 | | TEGBE | 0.1 NaOH | 0.8 | 0.48 | 3.7 | 7.2 |
| | | | | | | 11 | 5.8 |
| | | | | | | 36.5 | 4.6 |
| 5 | | | | | 0.96 | 3.7 | 8.6 |
| | | | | | | 11 | 7.0 |
| | | | | | | 36.5 | 5.6 |

TABLE 2
Apparent Viscosity vs. Shear Rate of Heavy Oil Emulsion of Oil
Sample C.

| | | | | | Total | | |
|---|---|---|---|---|---|---|---|
| | | | Aqueous | Aqueous | Co- | | |
| | | | Alkali | NaCl | Solvent | Shear | |
| Sample | Oil Conc. | Co- | Conc. (wt | Conc. | Conc. | Rate | Apparent |
| Number | (% Vol.) | Solvent | %) | (wt %) | (%) | (s\hat{ }-1) | Viscosity (cP) |
| 2 | 80% | Phenol- | 0.2 NaOH | 0.8 | 0.2 | 3.7 | 574 |
| | | 16EO | | | | 11 | 312 |
| | | | | | | 36.5 | 224 |
| 3 | | | | | 0.6 | 3.7 | 511 |
| | | | | | | 11 | 352 |
| | | | | | | 36.5 | 235 |
| 4 | 60% | Phenol- | 0.2 NaOH | 0.8 | 0 | | Solid |
| | | 16EO | | | | | |
| 5 | | | | | 0.32 | 3.7 | 44 |
| | | | | | | 11 | 20.5 |
| | | | | | | 36.5 | 18.2 |
| 6 | | | | | 0.64 | 3.7 | 62.4 |
| | | | | | | 11 | 33 |
| | | | | | | 36.5 | 27.2 |
| 7 | | Phenol- | 0.1 NaOH | 0.8 | 0.32 | 3.7 | 13.9 |
| | | 16EO | | | | 11 | 13.4 |
| | | | | | | 36.5 | 12.7 |
| 8 | | TEGBE | 0.1 NaOH | 0.8 | 0.32 | | Heterogeneous |
| | | | | | 0.64 | | Heterogeneous |
| 9 | | Phenol- | 0.1 NaOH | 0.1 | 0 | | Excess Oil |
| | | 16EO | | | 0.32 | | Excess Oil |
| | | | | | 0.64 | | Excess Oil |
| 10 | | TEGBE | 0.1 NaOH | 0.1 | 0 | | Excess Oil |
| | | | | | 0.32 | | Excess Oil |
| | | | | | 0.64 | | Excess Oil |
| 11 | | Phenol- | 0.2 NaOH | 0.1 | 0 | | Excess Oil |
| | | 16EO | | | 0.32 | | Excess Oil |
| | | | | | 0.64 | | Excess Oil |
| 12 | | TEGBE | 0.2 NaOH | 0.1 | 0 | | Excess Oil |
| | | | | | 0.32 | | Excess Oil |
| | | | | | 0.64 | | Excess Oil |
| 13 | 40% | Phenol- | 0.2 NaOH | 0.8 | 0 | | Solid |
| | | 16EO | | | | | |
| 14 | | | | | 0.48 | 3.7 | 9.2 |
| | | | | | | 11 | 8.9 |
| | | | | | | 36.5 | 8.6 |
| 15 | | | | | 0.96 | 3.7 | 7.4 |
| | | | | | | 11 | 6.8 |
| | | | | | | 36.5 | 6.3 |
| 16 | | | | | 2.04 | 3.7 | 9.1 |
| | | | | | | 11 | 7.9 |
| | | | | | | 36.5 | 6.8 |
| 17 | | Phenol- | 0.1 NaOH | 0.8 | 0 | | Solid |
| | | 16EO | | | | | |
| 18 | | | | | 0.48 | 3.7 | 4.3 |
| | | | | | | 11 | 4.4 |
| | | | | | | 36.5 | 4.5 |
| 19 | | | | | 0.96 | 3.7 | 4.4 |
| | | | | | | 11 | 4.5 |
| | | | | | | 36.5 | 4.5 |
| 20 | | Phenol- | 0.05 | 0.8 | 0.48 | 3.7 | ~3.8 |
| | | 16EO | NaOH | | | 11 | 3.8 |
| | | | | | | 36.5 | 3.7 |
| 21 | | Phenol- | 0.03 | 0.8 | 0.48 | | Excess Oil |
| | | 16EO | NaOH | | | | |
| 22 | | Phenol- | 0.2 NaOH | 0.1 | 0 | 3.7 | 8.6 |
| | | 16EO | | | | 11 | 7.9 |
| | | | | | | 36.5 | 7.3 |
| 23 | | | | | 0.48 | 3.7 | 12.2 |
| | | | | | | 11 | 9.6 |
| | | | | | | 36.5 | 7.4 |
| 24 | | | | | 0.96 | 3.7 | 13.5 |
| | | | | | | 11 | 10.5 |
| | | | | | | 36.5 | 7.9 |
| 25 | | Phenol- | 0.1 | 0.1 | 0.48 | 3.7 | 3.6 |
| | | 16EO | Na2CO3 | | | 11 | 3.6 |
| | | | | | | 36.5 | 3.6 |
| 26 | | Phenol- | 0.3 | 0.1 | 0.48 | 3.7 | 15.1 |
| | | 16EO | Na2CO3 | | | 11 | 8.4 |
| | | | | | | 36.5 | 4.9 |
| 27 | | Phenol- | 0.5 | 0.1 | 0.48 | 3.7 | 15.8 |
| | | 16EO | Na2CO3 | | | 11 | 9.5 |
| | | | | | | 36.5 | 5.1 |
| 28 | | IBA | 0.2 NaOH | 0.1 | 0.48 | 3.7 | 10.2 |
| | | | | | | 11 | 8.7 |
| | | | | | | 36.5 | 7.3 |
| 29 | | TEGBE | 0.2 NaOH | 0.1 | 0.48 | 3.7 | 5.3 |
| | | | | | | 11 | 5.1 |
| | | | | | | 36.5 | 4.8 |
| 30 | 20% | Phenol- | 0.2 NaOH | 0.8 | 0 | | Solid |
| | | 16EO | | | | | |
| 31 | | | | | 0.64 | | Excess Oil |
| 32 | | | | | 1.28 | 3.7 | 1.7 Hetero |
| | | | | | | 11 | 1.7 Hetero |
| | | | | | | 36.5 | 1.8 Hetero |

TABLE 3
Heavy crude oil properties

| | TotalC (A) | Zuata (B) | PRB (C) | Ugnu (D) |
|---|---|---|---|---|
| Origins | Venezuela | Venezuela | Canada | Alaska |
| Dynamic viscosi- | 310,000 | 93,000 | 62,500 | 9,000 |
| ty (cP) at 25° C. | | | | |
| & 10 s⁻¹ | | | | |
| Specific gravity | 1.1013 | 0.996 | 1.02 | 0.973 |
| at 25° C. | | | | |

TABLE 4
Tube viscometer specifications

| | Tube dimensions |
|---|---|
| Outer diameter (OD) | 1.5875 mm |
| Wall thickness | 0.385 mm |
| Inner diameter (ID) | 0.8176 mm |
| Length | 92.964 cm |

TABLE 5
Emulsion: Oil A (60% w/v) 1.6% aq. Ph-xEO 0.2% aq. NaOH

| Type of | | | | |
|---|---|---|---|---|
| co-solvent | 0.1% NaCl | 0.8% NaCl | 1.6% NaCl | 2.4% NaCl |
| No co-solvent | Fluid | Solid | Solid | Solid |
| PH-2EO | Fluid | Solid | Solid | Solid |
| Ph-8EO | Fluid | Fluid | Fluid | Solid |
| PH-16EO | Fluid | Fluid | Fluid | Solid |
| PH-20EO | Fluid | Fluid | Fluid | Solid |

*Fluid describes O/W emulsions that are single phase, homogeneous, and fluid enough to measure viscosity
*Solid describes emulsions that consist of multiple phases, are extremely heterogeneous, or too viscous to measure viscosity.

TABLE 6
Effect of many variables on emulsion viscosity and stability

| | | | | Viscosity | Stability |
|---|---|---|---|---|---|
| Heavy Crude Oil | Oil %¹ | | ↑ | ↑ | ↑ |
| | Viscosity² | | ↑ | minor | ? |
| | | | | effect | |
| | Composition³ | | | | |
| Aqueous | Salinity⁴ | | ↑ | ↑ | ? |
| | Alkali Conc.^{5a} | | | | |
| | | NaOH | ↑ | ↑ | ↑ |
| | | Na2CO3^{5b} | ↑ | ↑ | ↑ |
| Co-solvent | Type⁶ | | | | |
| | Concentration⁷ | | ↑ | ↓ | ? |
| | # of EO's⁸ | | ↑ | Minor | ? |
| | | | | effect | |
| Shear rate in | | | ↑ | ↓ | ? |
| pipeline⁹ | | | | | |
| Environmental | Temp of | | ↑ | ↓ | ↓ |
| | Transport¹⁰ | | | | |
| | Time of | | ↑ | ↓ | |
| | storage¹¹ | | | | |
| Emulsion Prep | Temp of | | ↑ | ↓ | ↑ |
| Procedure | mixing¹² | | | | |
| | Mixing time¹² | | ↑ | ↑ | ↑ |
| | Mixing | | ↑ | ↑ | ↑ |
| | speed¹² | | | | |

TABLE 7
Oil Pipeline Shear Rate and Specifications. 20 cst are assumed for the viscosity of oil required in Reynold's
number calculation and Rm, f, and Pressure drop were calculated using the MIT-Shell Equation.
The friction factor f is not the same as Darcy friction factor.

| | | | | | Calculaed | | veloc- | | | | | |
|---|---|---|---|---|---|---|---|---|---|---|---|---|
| | | | | | Shear | | ity | Velocity | | | | |
| | | | Max | | Rate | Shear | (miles/ | (miles/ | | | | Pres- |
| | | | Flow | Current | (l/s) | Rate @ | hr) | hr @ | | | | sure |
| | | Diam- | Rate | Flow | @ Max | Current | @ Max | Current | | | | Drop |
| Pipeline | Length | eter | (bbl/ | Rate | Flow | Flow | Flow | Flow | Reynolds | | | (psi/ |
| Name | (miles) | (inch) | day) | (bbl/day) | Rate | Rate | Rate | Rate | Number | Rm | f | mile) |
| Major | | | | | | | | | | | | |
| Pipelines | | | | | | | | | | | | |
| Africa | | | | | | | | | | | | |
| Chad- | 645 | 30 | 250,000 | 110,000 | 10.59 | 4.66 | 2.26 | 0.99 | 38433 | 4.96 | 0.005548 | 2.92 |
| Cameroon | | | | in 2009 | | | | | | | | |
| Sumed | 200 | 42 | 2,500,000 | 1,700,000 | 38.61 | 26.25 | 11.52 | 7.83 | 274524 | 35.46 | 0.003665 | 35.91 |
| | | | | in 2011 | | | | | | | | |
| Asia | | | | | | | | | | | | |
| Caspian | 940 | 40 | 1,300,000 | 700,000 | 23.24 | 12.51 | 6.60 | 3.55 | 149890 | 19.36 | 0.004112 | 13.90 |
| | | | | in 2012 | | | | | | | | |
| | | 42 | 1,300,000 | 700,000 | 20.07 | 10.81 | 5.99 | 3.22 | 142752 | 18.44 | 0.004152 | 11.00 |
| | | | | in 2012 | | | | | | | | |
| Eastern | 3,018 | 48 | 1,600,000 | 1,000,000 | 16.55 | 10.35 | 5.64 | 3.53 | 153733 | 19.86 | 0.004091 | 8.42 |
| Siberia- | | | | by 2016 | | | | | | | | |
| Pacific | | | | | | | | | | | | |
| Ocean | | | | | | | | | | | | |
| Habshan- | 220 | 48 | 1,500,000 | 1,000,000 | 15.52 | 10.35 | 5.29 | 3.53 | 144125 | 18.62 | 0.004144 | 7.50 |
| Fujairah | | | | in 2012 | | | | | | | | |
| Kirkuk | 600 | 40 | 500,000 | | 8.94 | | 2.54 | | 57650 | 7.45 | 0.005046 | 2.52 |
| Ceyhan | | 46 | 1,100,000 | | 12.93 | | 4.22 | | 110287 | 14.25 | 0.004378 | 5.27 |
| Samsun- | 340 | 42 | 1,500,000 | 1,000,000 | 23.16 | 15.44 | 6.91 | 4.61 | 164714 | 21.28 | 0.004036 | 14.23 |
| Ceyhan | | | | in 2012 | | | | | | | | |
| | | 48 | 1,500,000 | 1,000,000 | 15.52 | 10.35 | 5.29 | 3.53 | 144125 | 18.62 | 0.004144 | 7.50 |
| Europe | | | | in 2012 | | | | | | | | |
| Forties | 105 | 36 | 700,000 | 700,000 | 17.17 | 17.17 | 4.39 | 4.39 | 89678 | 11.58 | 0.004575 | 7.59 |
| | | | | in 2012 | | | | | | | | |
| Ninian | 109 | 36 | 910,000 | | 22.31 | | 5.71 | | 116581 | 15.06 | 0.004328 | 12.14 |
| North | | | | | | | | | | | | |
| America | | | | | | | | | | | | |
| Keystone | 2,147 | 30 | 590,000 | | 25.00 | | 5.33 | | 90703 | 11.72 | 0.004563 | 13.39 |
| | 2,000 | 36 | 1,100,000 | not yet | 26.97 | | 6.90 | | 140922 | 18.20 | 0.004163 | 17.07 |
| | | | | completed | | | | | | | | |
| Trans- | 800 | 48 | 2,136,000 | 600,000 | 22.10 | 6.21 | 7.53 | 2.12 | 205234 | 26.51 | 0.003868 | 14.19 |
| Alaska | | | | in 2012 | | | | | | | | |
| Range | 100- | 30-48 | 0.25-2.5 | 0.1-1.7 | 9~40 | 4.5-26 | 2-11.5 | 1~8 | | | | |
| | 3000 | | MMbbl/d | MMbbl/d | | | | | | | | |
| Average | | | | | 19.91 | 12.41 | 5.74 | 3.73 | | | | |
| Minor | | | | | | | | | | | | |
| Pipelines | | | | | | | | | | | | |
| Portland- | 236 | 18 | 192,000 | | 37.67 | | 4.82 | 2.76 | 49195 | 6.35 | 0.005234 | 20.92 |
| Montreal | | 24 | 410,000 | | 33.93 | | 5.78 | 1.55 | 78788 | 10.18 | 0.004705 | 20.35 |
| Houma to | | 22 | 325,000 | 325,000 | 34.92 | 34.92 | 5.46 | 1.85 | 68132 | 8.80 | 0.004859 | 20.40 |
| Houston | | | | | | | | | | | | |
| Pipeline | | | | | | | | | | | | |
| Houma to | | 18 | 260,000 | 260,000 | 51.01 | 51.01 | 6.52 | 2.76 | 66618 | 8.60 | 0.004883 | 35.79 |
| St. James, | | | | | | | | | | | | |
| LA | | | | | | | | | | | | |
| Athabasca | 335 | 30 | 345,000 | | 14.62 | | 3.11 | 0.99 | 53038 | 6.85 | 0.005143 | 5.16 |
| Chicap | 205 | 26 | 360,000 | | 23.43 | | 4.33 | 1.32 | 63858 | 8.25 | 0.00493 | 11.02 |
| Waupisoo | 237 | 30 | 350,000 | | 14.83 | | 3.16 | 0.99 | 53807 | 6.95 | 0.005126 | 5.29 |

### VII. Embodiments

### Embodiment 1

A heavy crude oil emulsion comprising a heavy crude oil, a co-solvent, a basic agent and water, wherein the viscosity of said emulsion is lower than the viscosity of said heavy crude oil.

### Embodiment 2

The emulsion of embodiment 1, further comprising a surfactant.

### Embodiment 3

The emulsion of embodiments 1 or 2, further comprising a catalyst.

### Embodiment 4

The emulsion of any one of the preceding embodiments, wherein said emulsion is at a transport temperature.

### Embodiment 5

The emulsion of any one of the preceding embodiments, wherein said transport temperature is less than 70° C.

### Embodiment 6

The emulsion of any one of the preceding embodiments, wherein said heavy crude oil is present from about 10% to about 95% (w/v).

### Embodiment 7

The emulsion of any one of the preceding embodiments, wherein said co-solvent is an alcohol, alkoxy alcohol, glycol ether, or glycol.

### Embodiment 8

The emulsion of any one of the preceding embodiments, wherein said co-solvent is an alcohol, alkoxy alcohol or glycol ether.

### Embodiment 9

The emulsion of any one of the preceding embodiments, wherein said co-solvent has the formula:

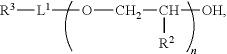

wherein
L¹ is unsubstituted C₁-C₆ alkylene, unsubstituted phenylene, unsubstituted cyclohexylene, unsubstituted cyclopentylene or methyl-substituted cyclopentylene; R² is independently hydrogen, methyl or ethyl; R³ is independently hydrogen or

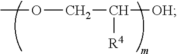

R⁴ is independently hydrogen, methyl or ethyl; n is an integer from 0 to 30, and m is an integer from 0 to 30.

### Embodiment 10

The emulsion of any one of the preceding embodiments, wherein said co-solvent has the formula:

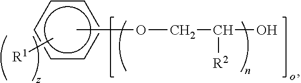

wherein R¹ is independently hydrogen, unsubstituted C₁-C₆ alkyl or R⁵—OH; R² is independently hydrogen or unsubstituted C₁-C₂ alkyl; R⁵ is independently a bond or unsubstituted C₁-C₆ alkyl; n is an integer from 1 to 30; o is an integer from 1 to 5; and z is an integer from 1 to 5.

### Embodiment 11

The emulsion of any one of the preceding embodiments, wherein said co-solvent is present in an amount sufficient to decrease the viscosity of said heavy crude oil at least 10-fold.

### Embodiment 12

The emulsion of any one of the preceding embodiments, wherein said co-solvent is present in an amount sufficient to decrease the viscosity of said heavy crude oil at least 100-fold.

### Embodiment 13

The emulsion of any one of the preceding embodiments, wherein said co-solvent is present in an amount sufficient to decrease the viscosity of said heavy crude oil at least 1,000-fold.

### Embodiment 14

The emulsion of any one of the preceding embodiments, wherein said co-solvent is present from about 0.01% to about 5% (w/v).

### Embodiment 15

The emulsion of any one of the preceding embodiments, wherein said basic agent is an alkali or an organic base.

### Embodiment 16

The emulsion of embodiment 15, wherein said alkali is NaOH, KOH, LiOH, Na₂CO₃, Na-metaborate, Na silicate, Na orthosilicate or NH₄OH.

### Embodiment 17

The emulsion of embodiment 15, wherein said organic base is a substituted or unsubstituted monoamine, a substituted or unsubstituted polyamine, a substituted or unsubstituted amino carboxylate, or a substituted or unsubstituted amino sulfonate.

### Embodiment 18

The emulsion of any one of the preceding embodiments, wherein said basic agent is present from about 0.01% to about 3% (w/v).

### Embodiment 19

The emulsion of embodiment 1, further comprising a salt.

### Embodiment 20

The emulsion of embodiment 19, wherein said salt is NaCl, or KCl.

### Embodiment 21

The emulsion of embodiments 19 or 20, wherein said salt is present in an amount sufficient to increase the solubility of said co-solvent or basic agent in said emulsion relative to the absence of said salt.

### Embodiment 22

The emulsion of any one of embodiments 19-22, wherein said salt is present from about 0.01% to about 2% (w/v).

### Embodiment 23

The emulsion of any one of the preceding embodiments, wherein said water is hard brine.

### Embodiment 24

The emulsion of any one of the preceding embodiments, wherein said water is soft brine.

### Embodiment 25

The emulsion of any one of the preceding embodiments, wherein said emulsion is stable at ambient temperature for at least an hour.

### Embodiment 26

The emulsion of any one of the preceding embodiments, wherein said emulsion is stable at ambient temperature for at least a day.

### Embodiment 27

The emulsion of any one of the preceding embodiments, wherein said emulsion is stable at ambient temperature for at least a week.

### Embodiment 28

The emulsion of any one of the preceding embodiments, wherein said emulsion is stable at ambient temperature for at least a month.

### Embodiment 29

The emulsion of embodiment 25 or 28, wherein said ambient temperature is less than 80° C.

### Embodiment 30

The emulsion of embodiment 25 or 28, wherein said ambient temperature is less than 60° C.

### Embodiment 31

The emulsion of embodiment 25 or 28, wherein said ambient temperature is less than 40° C.

### Embodiment 32

The emulsion of any one of the preceding embodiments, wherein said viscosity of said heavy crude oil is about 100,000 cP at ambient temperature.

### Embodiment 33

The emulsion of any one of the preceding embodiments, wherein said viscosity of said heavy crude oil is about 200,000 cP at ambient temperature

### Embodiment 34

The emulsion of any one of the preceding embodiments, wherein said viscosity of said heavy crude oil is about 300,000 cP at ambient temperature.

### Embodiment 35

The emulsion of any one of the preceding embodiments, wherein said viscosity of said heavy crude oil is about 1,000,000 cP at ambient temperature.

### Embodiment 36

The emulsion of any one of the preceding embodiments, wherein said viscosity of said emulsion is about a 1,000 times less than the viscosity of said heavy crude oil.

### Embodiment 37

The emulsion of any one of the preceding embodiments, wherein said viscosity of said emulsion is about a 10,000 times less than the viscosity of said heavy crude oil.

### Embodiment 38

The emulsion of any one of the preceding embodiments, wherein said viscosity of said emulsion is about a 100,000 times less than the viscosity of said heavy crude oil.

### Embodiment 39

The emulsion as in one of embodiments 1-38, wherein said emulsion is within a vessel.

### Embodiment 40

The emulsion of embodiment 39, wherein said vessel is a pipeline.

### Embodiment 41

The emulsion of embodiment 39, wherein said vessel forms part of a transportation vehicle.

### Embodiment 42

The emulsion as in one of embodiments 1-38, wherein said emulsion is transported in a pipeline.

### Embodiment 43

A method of forming a heavy crude oil emulsion, said method comprising: (i) contacting a heavy crude oil extracted from an oil reservoir with a co-solvent, a basic agent and water at an emulsion forming temperature, thereby forming a high temperature heavy crude oil emulsion; (ii) allowing said high temperature heavy crude oil emulsion to cool to a transport temperature, thereby forming a heavy crude oil emulsion.

### Embodiment 44

The method of embodiment 43, further comprising contacting said heavy crude oil extracted from an oil reservoir with a surfactant.

### Embodiment 45

The method of embodiment 43 or 44, further comprising contacting said heavy crude oil extracted from an oil reservoir with a catalyst.

### Embodiment 46

The method of any one of embodiments 43-45, wherein said heavy crude oil is present from about 10% to about 95% (w/v).

### Embodiment 47

The method of any one of embodiments 43-46, wherein said co-solvent is an alcohol, alkoxy alcohol, glycol ether, or glycol.

### Embodiment 48

The method of any one of embodiments 43-47, wherein said co-solvent is a co-solvent blend.

### Embodiment 49

The method of any one of embodiments 43-48, wherein said co-solvent has the formula:

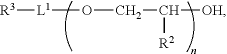

wherein L¹ is unsubstituted C₁-C₆ alkylene, unsubstituted phenylene, unsubstituted cyclohexylene, unsubstituted cyclopentylene or methyl-substituted cyclopentylene; R² is independently hydrogen, methyl or ethyl; R³ is independently hydrogen or

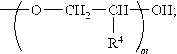

R⁴ is independently hydrogen, methyl or ethyl; n is an integer from 0 to 30, and m is an integer from 0 to 30.

### Embodiment 50

The method of any one of embodiments 43-49, wherein said co-solvent has the formula:

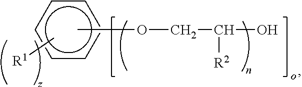

wherein R¹ is independently hydrogen, unsubstituted C₁-C₆ alkyl or R⁵—OH; R² is independently hydrogen or unsubstituted C₁-C₂ alkyl; R⁵ is independently a bond or unsubstituted C₁-C₆ alkyl; n is an integer from 1 to 30; o is an integer from 1 to 5; and z is an integer from 1 to 5.

### Embodiment 51

The method of any one of embodiments 43-50, wherein said co-solvent is present in an amount sufficient to decrease the viscosity of said heavy crude oil at least 1,000-fold.

### Embodiment 52

The method as in one of embodiments 43-51, wherein said co-solvent is present from about 0.01% to about 5% (w/v).

### Embodiment 53

The method of any one of embodiments 43-52, wherein said basic agent is an alkali or an organic base.

### Embodiment 54

The method of embodiment 53, wherein said alkali is NaOH, KOH, LiOH, Na₂CO₃, Na-metaborate, Na silicate, Na orthosilicate or NH₄OH.

### Embodiment 55

The method of embodiment 53, wherein said organic base is a substituted or unsubstituted monoamine, a substituted or unsubstituted polyamine, a substituted or unsubstituted amino carboxylate, or a substituted or unsubstituted amino sulfonate.

### Embodiment 56

The method of any one of embodiments 43-55, wherein said basic agent is present from about 0.01% to about 3% (w/v).

### Embodiment 57

The method of any one of embodiments 43-56, further comprising contacting said heavy crude oil with a salt.

### Embodiment 58

The method of embodiment 57, wherein said salt is NaCl or KCl.

### Embodiment 59

The method of embodiment 57 or 58, wherein said salt is present in an amount sufficient to increase the solubility of said co-solvent or basic agent in said emulsion relative to the absence of said salt.

### Embodiment 60

The method of any one of embodiments 57-59, wherein said salt is present from about 0.01% to about 5% (w/v).

### Embodiment 61

The method of any one of embodiments 43-60, wherein said water is hard brine.

### Embodiment 62

The method of any one of embodiments 43-61, wherein said water is soft brine.

### Embodiment 63

The method of any one of embodiments 43-62, wherein said emulsion is stable at ambient temperature for at least an hour.

### Embodiment 64

The method of any one of embodiments 43-63, wherein said emulsion is stable at ambient temperature for at least a day.

### Embodiment 65

The method of any one of embodiments 43-64, wherein said emulsion is stable at ambient temperature for at least a week.

### Embodiment 66

The method of any one of embodiments 43-65, wherein said emulsion forming temperature is equivalent to the temperature of said heavy crude oil in said reservoir.

### Embodiment 67

The method of any one of embodiments 43-66, wherein said emulsion forming temperature is at least 70° C.

### Embodiment 68

The method of any one of embodiments 43-67, wherein said emulsion forming temperature is about 100° C.

### Embodiment 69

The method of any one of embodiments 43-68, wherein said transport temperature is less than 70° C.

### Embodiment 70

The method of any one of embodiments 43-69, wherein said transport temperature is about 25° C.

### Embodiment 71

The method of any one of embodiments 43-70, wherein said heavy crude oil has a viscosity of at least 100,000 cP.

### Embodiment 72

The method of any one of embodiments 43-71, wherein said heavy crude oil has a viscosity of at least 200,000 cP.

### Embodiment 73

The method of any one of embodiments 43-72, wherein said heavy crude oil has a viscosity of at least 300,000 cP.

### Embodiment 74

The method of any one of embodiments 43-73, wherein said heavy crude oil has a viscosity of at least 1,000,000 cP.

### Embodiment 75

The method of any one of embodiments 43-74, wherein the viscosity of said heavy crude oil emulsion is 1,000 times lower than the viscosity of said heavy crude oil.

### Embodiment 76

The method of any one of embodiments 43-75, wherein the viscosity of said heavy crude oil emulsion is 10,000 times lower than the viscosity of said heavy crude oil.

### Embodiment 77

The method of any one of embodiments 43-76, wherein the viscosity of said heavy crude oil emulsion is 100,000 times lower than the viscosity of said heavy crude oil.

### Embodiment 78

The method of any one of embodiments 43-77, wherein said heavy crude oil emulsion is stable at said transport temperature for at least a week.

### Embodiment 79

The method of any one of embodiments 43-78, wherein said heavy crude oil emulsion is stable at said transport temperature for at least a month.

### Embodiment 80

A method of optimizing a heavy crude oil emulsion, said method comprising: (i) contacting a plurality of heavy crude oil samples with an amount of a co-solvent, an amount of a basic agent, an amount of a salt and an amount of water at an emulsion forming temperature, wherein said amount of a co-solvent, said amount of a basic agent, said amount of a salt and said amount of water is different for each of said plurality of heavy crude oil samples, thereby forming a plurality of different high temperature heavy crude oil emulsion samples; (ii) allowing said plurality of different high temperature heavy crude oil emulsion samples to cool to an ambient temperature, thereby forming a plurality of different low temperature heavy crude oil emulsion samples; (iii) identifying a low temperature heavy crude oil emulsion sample amongst said plurality of different low temperature heavy crude oil emulsion samples having a viscosity at least 100 times lower than the viscosity of said heavy crude oil, thereby optimizing a heavy crude oil emulsion.

### Embodiment 81

The method of embodiment 80, wherein said amount of a co-solvent is from about 0.01% to about 5% (w/v).

### Embodiment 82

The method of embodiment 80 or 81, wherein said amount of a basic agent is from about 0.01% to about 3% (w/v).

### Embodiment 83

The method of any one of embodiments 80-82, wherein said amount of water is from about 1% to about 90% (w/v).

### Embodiment 84

A method of transporting a heavy crude oil, comprising:

(i) extracting a heavy crude oil from an oil reservoir, thereby forming an extracted heavy crude oil; (ii) contacting said extracted heavy crude oil with a co-solvent, a basic agent and water at an emulsion forming temperature, thereby forming a high temperature heavy crude oil emulsion; (iii) allowing said high temperature heavy crude oil emulsion to cool to a transport temperature, thereby forming a heavy crude oil emulsion; (iv) transporting said heavy crude oil emulsion from a first location to a second location, thereby transporting said heavy crude oil.

### Embodiment 85

The method of embodiment 84, further comprising contacting said extracted heavy crude oil with a surfactant.

### Embodiment 86

The method of embodiment 84 or 85, further comprising contacting said extracted heavy crude oil with a catalyst.

### Embodiment 87

The method of any one of embodiments 84-86, wherein said first location is a production well.

### Embodiment 88

The method as in one of embodiments 84-87, wherein said transporting of step (iv) is performed in a vessel.

### Embodiment 89

The method of embodiment 88, wherein said vessel is a pipeline.

### Embodiment 90

The method of embodiment 88 or 89, wherein said vessel forms part of a transportation vehicle.

### Embodiment 91

The method of embodiment 86, further comprising after said transporting of step (iv) separating said heavy crude oil from said co-solvent, said basic agent and said water, thereby forming a recovered heavy crude oil.

### Embodiment 92

A method of forming a heavy crude oil emulsion in a production well, said method comprising contacting an extracted heavy crude oil in a production well with a co-solvent, a basic agent and water, thereby forming a heavy crude oil emulsion in the production well.

### Embodiment 93

The method of embodiment 92, wherein said extracted heavy crude oil is present from about 10% to about 95% (w/v).

### Embodiment 94

The method of embodiment 92 or 93, wherein said extracted heavy crude oil has a viscosity of at least 100,000 cP.

### Embodiment 95

The method of any one of embodiments 92-94, wherein said extracted heavy crude oil has a viscosity of at least 200,000 cP.

### Embodiment 96

The method of any one of embodiments 92-95, wherein said extracted heavy crude oil has a viscosity of at least 300,000 cP.

### Embodiment 97

The method of any one of embodiments 92-96, wherein said extracted heavy crude oil has a viscosity of at least 1,000,000 cP.

### Embodiment 98

The method of any one of embodiments 92-97, wherein the viscosity of said heavy crude oil emulsion is 1,000 times lower than the viscosity of said extracted heavy crude oil.

### Embodiment 99

The method of any one of embodiments 92-98, wherein the viscosity of said heavy crude oil emulsion is 10,000 times lower than the viscosity of said extracted heavy crude oil.

### Embodiment 100

The method of any one of embodiments 92-99, wherein the viscosity of said heavy crude oil emulsion is 100,000 times lower than the viscosity of said heavy crude oil.

### Embodiment 101

The method of any one of embodiments 92-100, further comprising contacting said extracted heavy crude oil with a surfactant.

### Embodiment 102

The method of any one of embodiments 92-101, further comprising contacting said extracted heavy crude oil with a catalyst.

### Embodiment 103

The method of any one of embodiments 92-102, wherein said co-solvent is an alcohol, alkoxy alcohol, glycol ether, or glycerol.

### Embodiment 104

The method of any one of embodiments 92-103, wherein said co-solvent is a co-solvent blend.

### Embodiment 105

A method of transporting an extracted heavy crude oil from a production well, comprising: (i) contacting an extracted heavy crude oil in a production well with a co-solvent, a basic agent and water at an emulsion forming temperature, thereby forming a heavy crude oil emulsion in a production well; (ii) transporting said heavy crude oil emulsion from said production well to the surface, thereby transporting said extracted heavy crude oil from said production well.

### Embodiment 106

The method of embodiment 105, further comprising contacting said extracted heavy crude oil with a surfactant.

### Embodiment 107

The method of embodiment 105 or 106, wherein said transporting of step (ii) further comprises moving said heavy crude oil transport emulsion with a mechanical pump.

### Embodiment 108

The method of embodiment 107, wherein said mechanical pump is an electrical submersible pump.

### Embodiment 109

A heavy crude oil emulsion comprising a first phase and a second phase, wherein said first phase comprises an oil-immiscible compound and a basic agent and said second phase comprises a heavy crude oil.

### Embodiment 110

The heavy crude oil emulsion of embodiment 109, wherein said heavy crude oil emulsion does not comprise water.

### Embodiment 111

The heavy crude oil emulsion of embodiment 109 or 110, wherein said heavy crude oil emulsion further comprises heavy crude oil water.

### Embodiment 112

The heavy crude oil emulsion of embodiment 111, wherein the amount of said heavy crude oil water is less than about 20% (w/v).

### Embodiment 113

The heavy crude oil emulsion of embodiment 111, wherein the amount of said heavy crude oil water is less than about 2% (w/v).

### Embodiment 114

The heavy crude oil emulsion of embodiment 111, wherein the amount of said heavy crude oil water is less than about 1% (w/v).

### Embodiment 115

The heavy crude oil emulsion of any one of embodiments 109-114, wherein said heavy crude oil emulsion further comprises an amphiphilic co-solvent.

### Embodiment 116

The heavy crude oil emulsion of embodiment 115, wherein said amphiphilic co-solvent is present in said first phase and said second phase.

### Embodiment 117

The heavy crude oil emulsion of any one of embodiments 109-116, wherein said first phase is about 80% oil-immiscible compound.

### Embodiment 118

The heavy crude oil emulsion of any one of embodiments 109-117, wherein said first phase is about 95% oil-immiscible compound.

### Embodiment 119

The heavy crude oil emulsion of any one of embodiments 109-118, wherein said first phase is about 99% oil-immiscible compound.

### Embodiment 120

The heavy crude oil emulsion of any one of embodiments 109-119, wherein said oil-immiscible compound is ethylene glycol, di-ethylene glycol, glycerol, propylene glycol, pentaerythritol, sorbitol or methanol.

### Embodiment 121

The heavy crude oil emulsion of any one of embodiments 109-120, further comprising a surfactant.

### Embodiment 122

The heavy crude oil emulsion of any one of embodiments 109-121, wherein the viscosity of said emulsion is lower than the viscosity of said heavy crude oil.

### Embodiment 123

The heavy crude oil emulsion of any one of embodiments 109-122, wherein the emulsion is formed at an ambient temperature.

### Embodiment 124

A method of forming a heavy crude oil emulsion, said method comprising: (i) contacting a heavy crude oil extracted from an oil reservoir with an oil-immiscible compound, an amphiphilic co-solvent and a basic agent at an emulsion forming temperature, thereby forming a high temperature heavy crude oil emulsion; (ii) allowing said high temperature heavy crude oil emulsion to cool to a transport temperature, thereby forming a heavy crude oil emulsion.

### Embodiment 125

The heavy crude oil emulsion of embodiment 124, wherein said extracted heavy crude oil emulsion further comprises heavy crude oil water.

### Embodiment 126

The method of embodiment 125, wherein the amount of water in said heavy crude oil emulsion is equal to the amount of said heavy crude oil water.

### Embodiment 127

The method of embodiment 124, further comprising contacting said heavy crude oil extracted from an oil reservoir with a surfactant.

### Embodiment 128

The heavy crude oil emulsion of embodiment 124, wherein said oil-immiscible compound is ethylene glycol, di-ethylene glycol, glycerol, propylene glycol, pentaerythritol, sorbitol or methanol.

### Embodiment 129

A method of forming a heavy crude oil emulsion in a production well, said method comprising contacting an extracted heavy crude oil in a production well with an oil-immiscible compound, an amphiphilic co-solvent and a basic agent, thereby forming a heavy crude oil emulsion in a production well.

### Embodiment 130

The method of embodiment 129, wherein said heavy crude oil emulsion further comprises heavy crude oil water.

### Embodiment 131

The method of embodiment 130, wherein the amount of water in said heavy crude oil emulsion is equal to the amount of said heavy crude oil water.

### Embodiment 132

The method of any one of embodiments 129-131, further comprising contacting said extracted heavy crude oil with a surfactant.

### Embodiment 133

The method of any one of embodiments 129-132, wherein said oil-immiscible compound is ethylene glycol, di-ethylene glycol, glycerol, propylene glycol, pentaerythritol, sorbitol or methanol.

### Embodiment 134

A method of transporting an extracted heavy crude oil from a production well, comprising: (i) contacting an extracted heavy crude oil in a production well with an oil-immiscible compound, an amphiphilic co-solvent and a basic agent at an emulsion forming temperature, thereby forming a heavy crude oil emulsion in a production well; (ii) transporting said heavy crude oil emulsion from said production well to the surface, thereby transporting said extracted heavy crude oil from said production well.

### Embodiment 135

The method of embodiment 134, wherein said extracted heavy crude oil emulsion further comprises heavy crude oil water.

### Embodiment 136

The method of embodiment 135, wherein the amount of water in said heavy crude oil emulsion is equal to the amount of said heavy crude oil water.

### Embodiment 137

The method of any one of embodiments 134-136, further comprising contacting said extracted heavy crude oil with a surfactant.

### Embodiment 138

The heavy crude oil emulsion of any one of embodiments 134-137, wherein said oil-immiscible compound is ethylene glycol, di-ethylene glycol, glycerol, propylene glycol, pentaerythritol, sorbitol or methanol.

### Embodiment 139

A non-aqueous composition comprising an oil-immiscible compound, an amphiphilic co-solvent and a basic agent.

### Embodiment 140

The non-aqueous composition of embodiment 139, wherein said oil-immiscible compound is ethylene glycol, di-ethylene glycol, glycerol, propylene glycol, pentaerythritol, sorbitol or methanol.

### Embodiment 141

The non-aqueous composition of embodiment 139, further comprising a surfactant.

What is claimed is:

1. A heavy crude oil emulsion comprising a heavy crude oil, a co-solvent, a basic agent and water, wherein the viscosity of said emulsion is lower than the viscosity of said heavy crude oil.

2. The emulsion of claim 1, wherein said emulsion is at a transport temperature.

3. The emulsion of claim 2, wherein said transport temperature is less than 70° C.

4. The emulsion of claim 1, wherein said co-solvent has the formula: 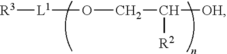
wherein
L¹ is unsubstituted C₁-C₆ alkylene, unsubstituted phenylene, unsubstituted cyclohexylene, unsubstituted cyclopentylene or methyl-substituted cyclopentylene;
R² is independently hydrogen, methyl or ethyl;
R³ is independently hydrogen or 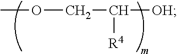
R⁴ is independently hydrogen, methyl or ethyl;
n is an integer from 0 to 30, and
m is an integer from 0 to 30.

5. The emulsion of claim 1, wherein said co-solvent has the formula: 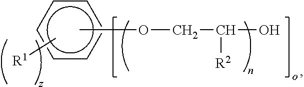
wherein
R¹ is independently hydrogen, unsubstituted C₁-C₆ alkyl or R⁵—OH;
R² is independently hydrogen or unsubstituted C₁-C₂ alkyl;
R⁵ is independently a bond or unsubstituted C₁-C₆ alkyl;
n is an integer from 1 to 30;
o is an integer from 1 to 5; and
z is an integer from 1 to 5.

6. The emulsion of claim 1, wherein said basic agent is an alkali or an organic base.

7. The emulsion of claim 1, further comprising a salt.

8. The emulsion of claim 7, wherein said salt is NaCl, or KCl.

9. The emulsion of claim 1, wherein said emulsion is within a vessel.

10. The emulsion of claim 9, wherein said vessel is a pipeline.

11. A method of forming a heavy crude oil emulsion, said method comprising:
(i) contacting a heavy crude oil extracted from an oil reservoir with a co-solvent, a basic agent and water at an emulsion forming temperature, thereby forming a high temperature heavy crude oil emulsion;
(ii) allowing said high temperature heavy crude oil emulsion to cool to a transport temperature, thereby forming a heavy crude oil emulsion.

12. The method of claim 11, wherein said basic agent is an alkali or an organic base.

13. The method of claim 11, further comprising contacting said heavy crude oil with a salt.

14. A method of transporting a heavy crude oil, comprising:
(i) extracting a heavy crude oil from an oil reservoir, thereby forming an extracted heavy crude oil;
(ii) contacting said extracted heavy crude oil with a co-solvent, a basic agent and water at an emulsion forming temperature, thereby forming a high temperature heavy crude oil emulsion;
(iii) allowing said high temperature heavy crude oil emulsion to cool to a transport temperature, thereby forming a heavy crude oil emulsion;
(iv) transporting said heavy crude oil emulsion from a first location to a second location, thereby transporting said heavy crude oil.

15. The method of claim 14, wherein said transporting of step (iv) is performed in a vessel.

16. A method of forming a heavy crude oil emulsion in a production well, said method comprising contacting an extracted heavy crude oil in a production well with a co-solvent, a basic agent and water, thereby forming a heavy crude oil emulsion in the production well.

17. A heavy crude oil emulsion comprising a first phase and a second phase, wherein said first phase comprises an oil-immiscible compound and a basic agent and said second phase comprises a heavy crude oil.

18. The heavy crude oil emulsion of claim 17, wherein said heavy crude oil emulsion further comprises an amphiphilic co-solvent.

19. The heavy crude oil emulsion of claim 18, wherein said amphiphilic co-solvent has the formula: 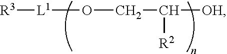
wherein
L¹ is unsubstituted C₁-C₆ alkylene, unsubstituted phenylene, unsubstituted cyclohexylene, unsubstituted cyclopentylene or methyl-substituted cyclopentylene;
R² is independently hydrogen, methyl or ethyl;
R³ is independently hydrogen or 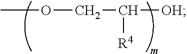
R⁴ is independently hydrogen, methyl or ethyl;
n is an integer from 0 to 30, and
m is an integer from 0 to 30.

20. The heavy crude oil emulsion of claim 18, wherein said amphiphilic co-solvent has the formula: 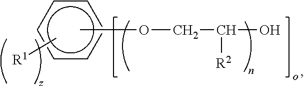
wherein
R¹ is independently hydrogen, unsubstituted C₁-C₆ alkyl or R⁵—OH;
R² is independently hydrogen or unsubstituted C₁-C₂ alkyl;
R⁵ is independently a bond or unsubstituted C₁-C₆ alkyl;
n is an integer from 1 to 30;
o is an integer from 1 to 5; and
z is an integer from 1 to 5.
